(19) United States
(12) Patent Application Publication
(10) Pub. No.: US 2011/0078458 A1
(43) Pub. Date: Mar. 31, 2011

(54) CONTENTS PROCESSING DEVICE AND CONTENTS PARTIAL INTEGRITY ASSURANCE METHOD

(75) Inventors: Kazuyoshi FURUKAWA, Kawasaki (JP); Tetsuya IZU, Kawasaki (JP); Masahiko TAKENAKA, Kawasaki (JP); Masaya YASUDA, Kawasaki (JP)

(73) Assignee: FUJITSU LIMITED, Kawasaki (JP)

(21) Appl. No.: 12/885,886

(22) Filed: Sep. 20, 2010

(30) Foreign Application Priority Data
Sep. 25, 2009 (JP) 2009-221466

(51) Int. Cl. G06F 12/14

(52) U.S. Cl. 713/189

(57) ABSTRACT

A contents processing device includes a management data storage unit to store an updater identifier and a private key, an accepting unit to accept a content which is divided into a plurality of blocks, an updating type indicating a type of an updating as to the content, an updated block to be updated of the content, and an updated position, an inserting unit to generate an updated content by inserting the updating block into the updated position of the content, a first hash value calculating unit to calculate a hash value as to the updated block, a signature unit to read out the updater identifier and the private key from the management data storage unit to generate a digital signature using the private key as to updating record information including the updater identifier, the updated position, the hash value as to the updated block, and the updating type.

### CROSS-REFERENCE TO RELATED APPLICATIONS

This application is based upon and claims the benefit of priority of the prior Japanese Patent Application No. 2009-221466, filed on Sep. 25, 2009, the entire contents of which are incorporated herein by reference.

### BACKGROUND

1. Field

Various embodiments discussed herein relate to integrity assurance including partial integrity assurance technology (PIAT) of content(s) (e.g., documents, moving images, photos, music, etc).

2. Description of the Related Art

For example, a digital signature using a public key cryptosystem such as RSA (Rivest Shamir Adleman) or the like is given to a document, whereby the document may be assured to be free of tampering, and the producer of the document may be assured. However, with this system, in the event that a document has partially been modified, a new digital signature is given to the document after modification, whereby the integrity of the whole of the document after modification may be assured, but an unmodified portion may not be assured of being a succession from the original document.

Therefore, in the event that a document has partially been modified, there is, for example, a technique called PIAT (Partial Integrity Assurance Technology) as a technique for assuring the integrity of the document after modification, and also that a portion not modified is a succession from the original document (hereafter, referred to as partial integrity assurance). With PIAT, an arrangement is made wherein a document is divided into several blocks beforehand, and integrity as to each block is assured. Thus, not only the integrity of the document after modification, but also that an unmodified block is a succession from the original document may be assured. Note that, with PIAT, such as illustrated in FIG. 1, there are divided three phases of a signature phase where a signer creates a document, a modification phase where a modifier modifies a document, and a verification phase where a verifier receives a document after modification to perform verification. Such as illustrated in FIG. 1, there may be two or more modifiers, or there may be two or more number of times of modification to be applied. Also, a signer may be a modifier. Further, any person may be a modifier.

As a typical method of PIAT according to the related art, there are two methods of a SCCS (Source Code Control System) type and a RCS (Revision Control System) type. For example, with the SCCS type, such as illustrated in FIG. 2, with the signature phase, a document M created by a signer is divided into two or more blocks (m₁ through m₅ in FIG. 2), and a hash value as to each block (h₁ through h₅ in FIG. 2) is calculated. Subsequently, a digital signature σ₀ as to a hash value list including the hash value of each block is generated. Note that the hash value list and the digital signature σ₀ are published as to a verifier.

Subsequently, with the modification phase, let us say that a modifier 1 has received a document M from a signer, and has modified, for example, a block m₃ to a block m₃′. Thus, a hash value h₃′ as to the block m₃′ is calculated, and a digital signature σ₁ as to data (hereafter, referred to as “public hash values”) including the identification number (1) of the modifier, modified position number (3), and this hash value (h₃′) is generated. Note that the public hash values (1, 3, h₃′) and the digital signature σ₁ are published as to the verifier.

Also, similarly, with the same modification phase, let us say that a modifier 2 has received a document M′ from a modifier 1, and has received, for example, a block m₄ to a block m₄′. Thus, a hash value h₄′ as to the block m₄′ is calculated, and a digital signature σ₂ as to public hash values including the identification number (2) and modified position number (4) of the modifier and this hash value (11₄′) is generated. Note that the public hash values (2, 4, h₄′) and the digital signature σ₂ are published as to the verifier.

Subsequently, such as illustrated in FIG. 3, with the SCCS type, with the verification phase, the verifier receives the hash value list, digital signature σ₀, public hash values (1, 3, h₃′), digital signature σ₁, public hash values (2, 4, h₄′), digital signature σ₂, and document M″ after modification. Subsequently, verification of the modification content performed by the modifier 2 is performed as a first verification stage. Specifically, first, hash values (h₁, h₂, h₃′, h₄′and h₅ in FIG. 3) as to each block included in the document M″ are calculated. Next, verification of the digital signature σ₂ is performed, and in the event that verification has succeeded, verification of the fourth block is performed using the public hash values (2, 4, h₄′). For example, in the event that the previously calculated hash value h₄′ is matched with the hash value h₄′ included in the public hash values, verification is determined to have succeeded. Note that the fourth hash value h₄′ is replaced with the hash value h₄ included in the hash value list.

Subsequently, verification of the content of modification performed by the modifier 1 is performed as a second verification stage. Specifically, verification of the digital signature σ₁ is performed, and in the event that verification has succeeded, verification of the third block is performed using the public hash values (1, 3, h₃′). For example, in the event that the previously calculated hash value h₃¹ is matched with the hash value h₃′ included in the public hash values, verification is determined to have succeeded. Note that the third hash value h₃′ is replaced with the hash value h₃ included in the hash value list.

Subsequently, with the third verification stage, verification of the digital signature σ₀ is performed using the hash value list in which replacement to the hash values h₃ and h₄ has been performed at the first and second verification stages. Subsequently, in the event that verification has succeeded, verification of a block is further performed using the hash value list published from a signer. Thus, the block m₄′ included in the document M″ after modification is assured to have been modified by the modifier 2, and the block m₃′ is assured to have been modified by the modifier 1. Further, an unmodified block is assured to have been a succession from the document M.

Also, for example, with the RCS type, such as illustrated in FIG. 4, in the same way as with the SCCS type, with the signature phase, the document M created by the signer is divided into two or more blocks (m₁ through m₅ in FIG. 4), and the hash value as to each block (h₁ through h₅ in FIG. 4) is calculated. Subsequently, the digital signature σ₀ as to the hash value list including the hash value of each block is generated. Note that the digital signature σ₀ is published as to the verifier. With the RCS type, the hash values (h₁ through h₅) calculated at the signature phase is not published as to the verifier.

Subsequently, with the modification phase, in the event that the modifier 1 has received the document M from the signer, the hash values (h₁ through h₅) as to each block included in the document M are calculated, and a hash value list is generated. Let us then say that the modifier 1 has modified block m₃ to block m₃′. Thus, public hash values including the identification number (1) of the modifier, the modified position number (3), and the hash value (h₃) of the block m3 before modification are generated. Subsequently, the hash value h₃′ as to the block m₃′ after modification is calculated, the hash value h₃ of the hash value list is replaced with the hash value h₃′. Subsequently, this hash value list, and the digital signature σ₁ as to the public hashed values are generated. Note that the public hash values (1, 3, h₃) and the digital signature σ₁ are published as to the verifier.

Also, similarly, with the modification phase, in the event that the modifier 2 has received the document M′ from the modifier 1, the hash values (h₁, h₂, h₃′, h₄ and h₅) as to each block included in the document M′ are calculated, and a hash value list is generated. Subsequently, for example, let us say that the modifier 2 has modified the block m₄ to the block m₄′. Thus, public hash values including the identification number (2) of the modifier, modified position number (4), and the hash value (h₄) as to the block m₄ after modification are generated. Subsequently, the hash value h₄′ as to the block m₄′ after modification is calculated, and the hash value h₄ of the hash value list is replaced with the hash value h₄′. Subsequently, this hash value list, and the digital signature σ₂ as to the public hash values are generated. Note that the public hash values (2, 4, h₄) and the digital signature σ₂ are published as to the verifier.

Subsequently, such as illustrated in FIG. 5, with the RCS type, the verifier receives the digital signature σ₀, public hash values (1, 3, h₃), digital signature σ₁, public hash values (2, 4, h₄), digital signature σ₂, and document M″ after modification at the verification phase. Subsequently, verification of the content of modification performed by the modifier 2 is performed as a first verification stage. Specifically, first, hash values (h₁, h₂, h₃′, h₄¹ and h₅ in FIG. 5) as to each block included in the document M″ are calculated, and a hash value list is generated. Subsequently, verification of the digital signature σ₂ is performed using this hash value list and the public hash values (2, 4, h₄), and in the event that verification has succeeded, the hash value h₄′ of the fourth block is replaced with the hash value h₄ included in the public hash values.

Subsequently, verification of the content of modification performed by the modifier 1 is performed as a second verification stage. Specifically, in the event that verification of the digital signature σ₁ is performed using the hash value list in which replacement to the hash value h₄ has been performed at the first verification stage, and the public hash values (1, 3, h₃), and verification has succeeded, the hash value h₃′ of the third block is replaced with the hash value h₃ included in the public hash values.

Subsequently, with the third verification stage, verification of the digital signature σ₀ is performed using the hash value list in which replacement to the hash values h₃ and h₄ has been performed at the first and second verification stages. Thus, in the same way as with the SCCS type, a modified block is assured, and also an unmodified block is assured to be a succession from the document M.

Note that, such as illustrated in FIG. 6, at the time of the document being divided into n blocks, in the event that d modifications have been performed by m modifiers, with the SCCS type according to the related art, n messages, n+d hash values, and m+1 digital signatures have to be provided at the time of verification. Also, verification of the original digital signature has to be performed at the time of performing modification again. Also, the RCS type according to the related art is the same as with the SCCS type except that the number of hash values is d.

Thus, with PIAT according to the related art, in the event that a part of blocks of a document have been modified, the integrity of the document after modification may be assured, and also an unmodified portion may be assured to be a succession from the original document.

### SUMMARY

According to an aspect of an embodiment, a contents processing device includes, a management data storage unit configured to store an updater identifier and a private key in a correlated manner, an accepting unit configured to accept a content which is divided into a plurality of blocks, and an updating type indicating a type of an updating as to the content, an updated block of the content, and an updated position. The contents processing device includes inserting unit configured to generate an updated content by inserting the updating block into the updated position of the content in an event that the updating type is insertion, a first hash value calculating unit configured to calculate a hash value as to the updated block, a signature unit configured to read out the updater identifier and the private key from the management data storage unit to generate a digital signature using the private key as to updating record information including this updater identifier, the updated position, the hash value as to the updated block, and the updating type, and an output unit configured to output the updated content, the updating record information, and the digital signature.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed. Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram illustrating each phase of PIAT;

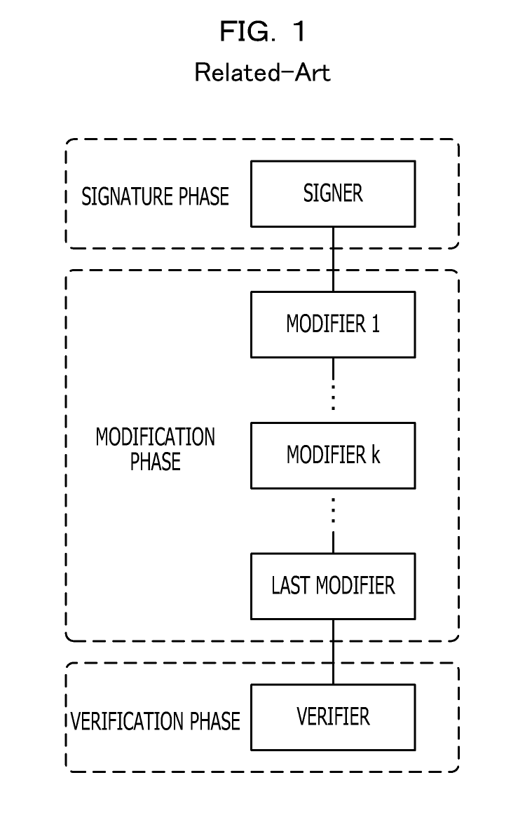

FIG. 2 is a diagram for describing operation at the signature and modification phases of SCCS-type PIAT;

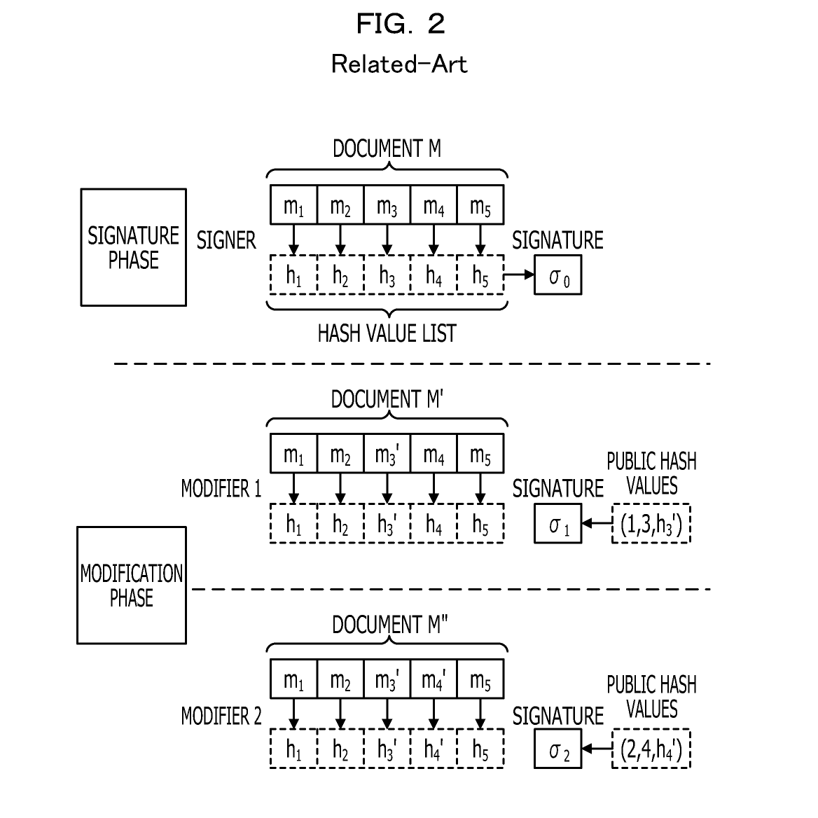

FIG. 3 is a diagram for describing operation at the verification phase of SCCS-type PIAT;

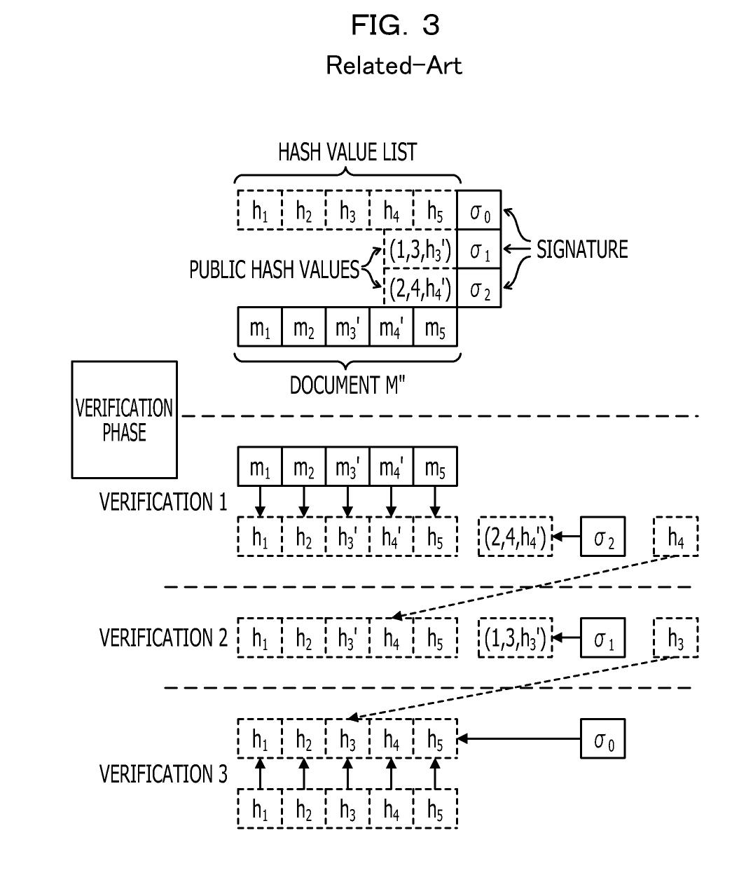

FIG. 4 is a diagram for describing operation at the signature and verification phases of the RCS-type PIAT;

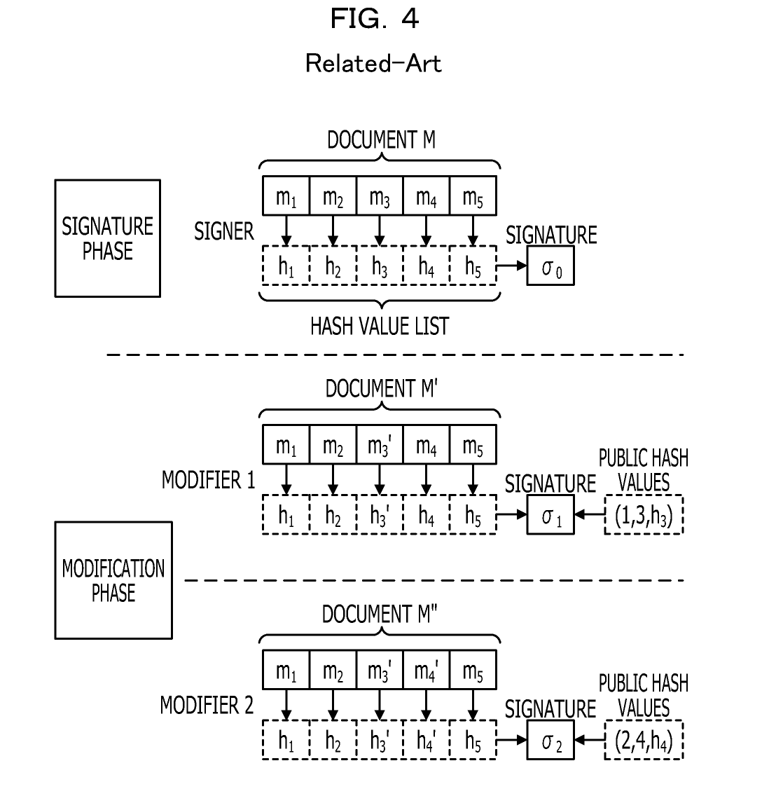

FIG. 5 is a diagram for describing operation at the verification phase of the RCS-type PIAT;

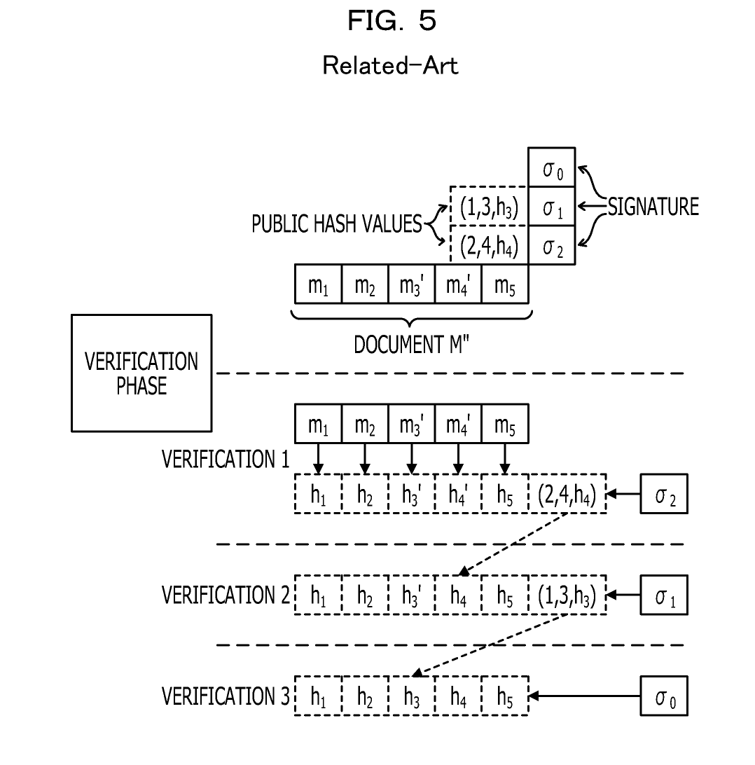

FIG. 6 is a diagram illustrating data to be used for PIAT (SCCS-type and RCS-type);

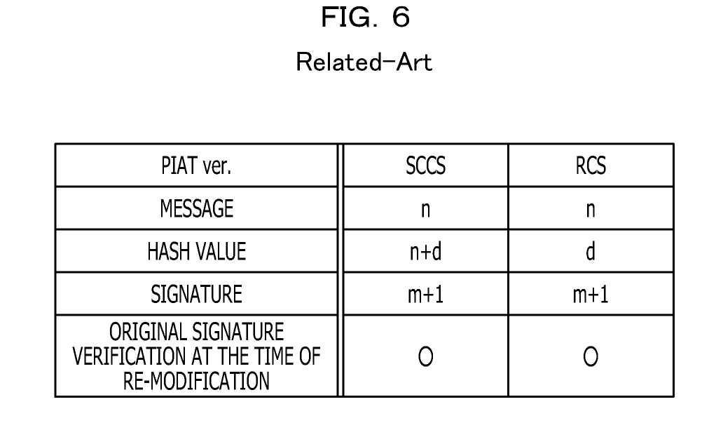

FIG. 7 is a diagram illustrating a flow at the time of adding a block with SCCS-type PIAT;

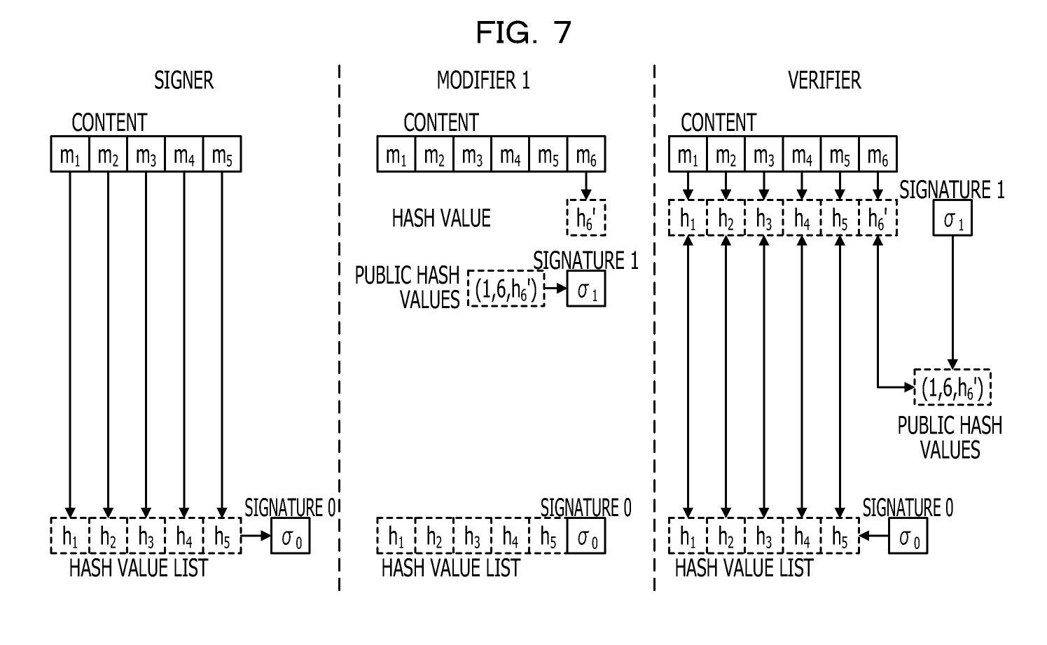

FIG. 8 is a diagram illustrating a flow at the time of block insertion with SCCS-type PIAT;

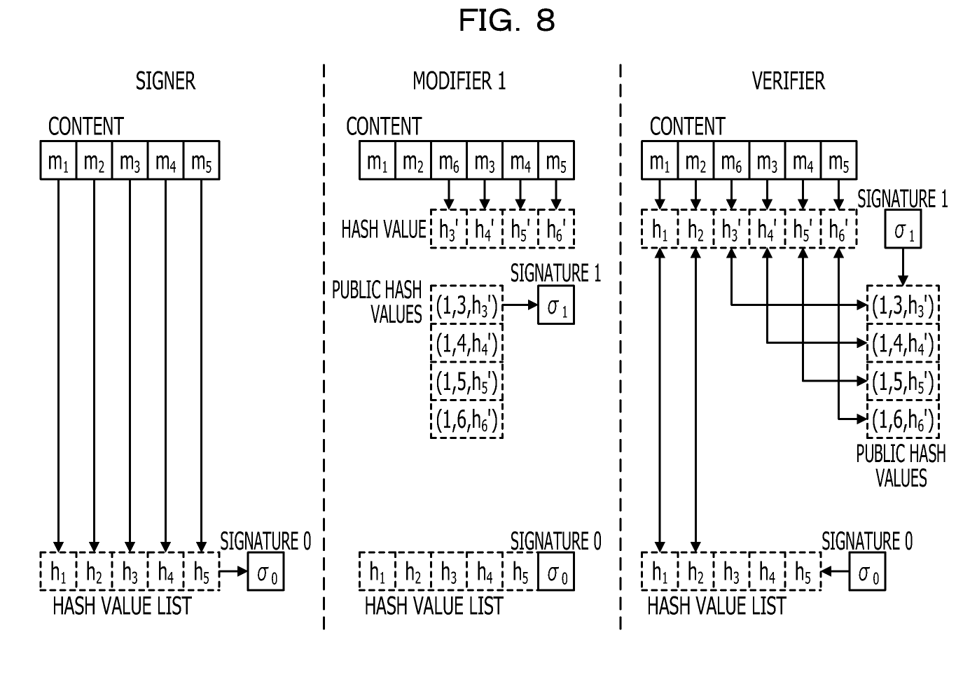

FIG. 9 is a diagram illustrating a flow at the time of block insertion according to an embodiment (SCCS-type PIAT: method 1);

FIG. 10 is a system configuration diagram according to an embodiment of the present technology;

FIG. 11 is a functional block diagram of a signer terminal according to embodiments;

FIG. 12 is a diagram illustrating various types of storage portions included in a memory unit of the signer terminal;

FIG. 13 is a functional block diagram of a modifier terminal according to embodiments;

FIG. 14 is a diagram illustrating various types of storage portions included in a memory unit of the modifier terminal according to embodiments;

FIG. 15 is a functional block diagram of a verifier terminal;

FIG. 16 is a diagram illustrating various types of storage portions included in a memory unit of the verifier terminal according to embodiments;

FIG. 17 is a diagram illustrating a processing flow of the signer terminal according to embodiments;

FIG. 18 is a diagram illustrating a processing flow of the modifier terminal according to an embodiment;

FIG. 19 is a diagram illustrating a processing flow of content modification processing 1;

FIG. 20 is a diagram illustrating a processing flow (first portion) of the verifier terminal according to an embodiment;

FIG. 21 is a diagram illustrating a processing flow (second portion) of the verifier terminal according to an embodiment;

FIG. 22 is a diagram illustrating a flow at the time of block insertion according to an embodiment (SCCS-type PIAT: method 2);

FIG. 23 is a functional block diagram of the modifier terminal according to embodiments;

FIG. 24 is a diagram illustrating various types of storage portions included in a memory unit of the modifier terminal according to embodiments;

FIG. 25 is a diagram illustrating various types of storage portions included in a memory unit of the modifier terminal according to embodiments;

FIG. 26 is a diagram illustrating a processing flow of the modifier terminal according to an embodiment;

FIG. 27 is a diagram illustrating a processing flow of content modification processing 2;

FIG. 28 is a diagram illustrating an example of an insertion table;

FIG. 29 is a diagram illustrating a processing flow (first portion) of the verifier terminal according to an embodiment;

FIG. 30 is a diagram illustrating a processing flow (second portion) of the verifier terminal according to an embodiment;

FIG. 31 is a diagram illustrating a flow at the time of block insertion according to an embodiment (SCCS-type PIAT: method 3);

FIG. 32 is a functional block diagram of the modifier terminal according to embodiments;

FIG. 33 is a diagram illustrating various types of storage portions included in a memory unit of the modifier terminal according to embodiments;

FIG. 34 is a diagram illustrating various types of storage portions included in the memory unit of the modifier terminal according to embodiments;

FIG. 35 is a diagram illustrating a processing flow of the modifier terminal according to an embodiment;

FIG. 36 is a diagram illustrating a processing flow of content modification processing 3;

FIG. 37 is a diagram illustrating a processing flow (first portion) of the verifier terminal according to an embodiment;

FIG. 38 is a diagram illustrating a processing flow (second portion) of the verifier terminal according to an embodiment;

FIG. 39 is a diagram illustrating a flow at the time of block insertion according to an embodiment (RCS-type PIAT: method 1);

FIG. 40 is a diagram illustrating a processing flow of the signer terminal according to t embodiments;

FIG. 41 is a diagram illustrating a processing flow of the modifier terminal according to an embodiment;

FIG. 42 is a diagram illustrating a processing flow of content modification processing 4;

FIG. 43 is a diagram illustrating a processing flow of the verifier terminal according to an embodiment;

FIG. 44 is a diagram illustrating a flow at the time of block insertion according to an embodiment (RCS-type PIAT: method 2);

FIG. 45 is a diagram illustrating a processing flow of the modifier terminal according to an embodiment;

FIG. 46 is a diagram illustrating a processing flow of content modification processing 5;

FIG. 47 is a diagram illustrating a processing flow of the verifier terminal according to an embodiment;

FIG. 48 is a diagram illustrating a flow at the time of block insertion according to an embodiment (RCS-type PIAT: method 3);

FIG. 49 is a diagram illustrating a processing flow of the modifier terminal according to an embodiment;

FIG. 50 is a diagram illustrating a processing flow of content modification processing 6;

FIG. 51 is a diagram illustrating a processing flow of the verifier terminal according to an embodiment;

FIG. 52 is a diagram illustrating a comparative example of public data amount according to each method;

FIG. 53 is a functional block diagram of a computer;

FIG. 54 is a functional block diagram of a contents processing device according to a first mode of the present technology;

FIG. 55 is a functional block diagram of a contents processing device according to a second mode of the present technology;

FIG. 56 is a diagram illustrating a processing flow of an information processing method according to a third mode of the present technology; and

FIG. 57 is a diagram illustrating a processing flow of an information processing method according to a fourthmode of the present technology.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

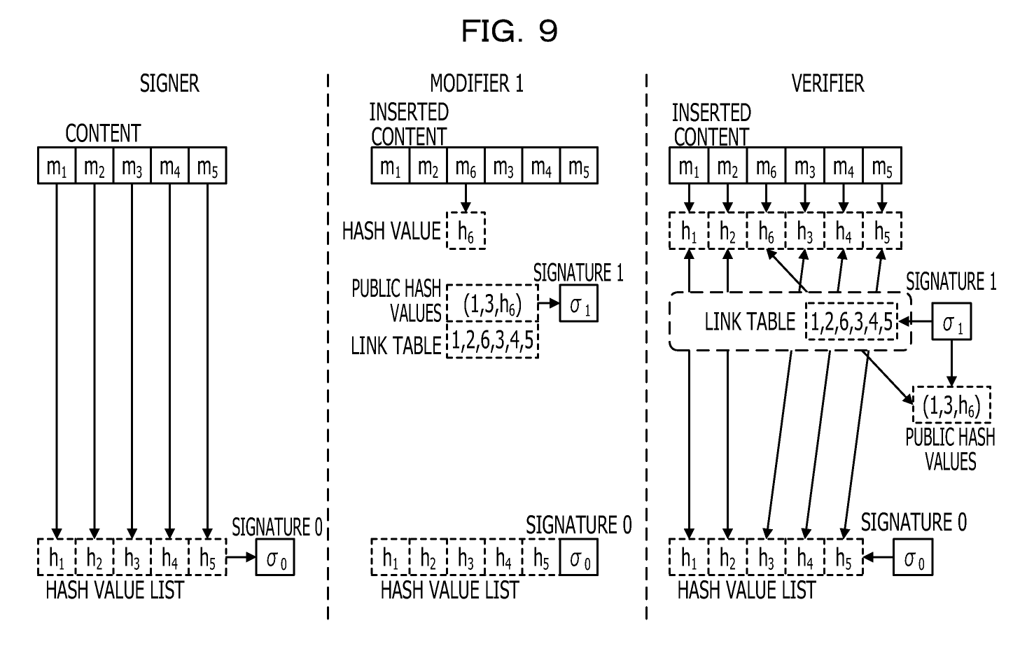

According to an embodiment, partial integrity assurance at a time of block insertion is realized with a flow such as illustrated in FIG. 9. Note that an embodiment is obtained by transforming SCCS-type PIAT. Such as illustrated in FIG. 9, with an embodiment, for example, in an event that a block m₆ has been inserted in the third position of a content, the hash value corresponding to the insertion block m₆ is calculated to generate data including the identifier of a modifier, an insertion position number, and the hash value thereof (hereafter, referred to as “public hash values”). Also, with an embodiment, a link table such as illustrated in FIG. 9 is generated at the modification phase. With the link table illustrated in FIG. 9, “6”, which is the third number from the top is a value greater than the number of blocks “5” included in the original content, and accordingly, it can be seen out that the third block of the inserted content is a block inserted by a modifier 1. Also, in FIG. 9, according to the link table, it can be seen out that the first hash value of the hash value list corresponds to the first block of the inserted content. Similarly, it can be seen out that the second hash value of the hash value list corresponds to the second block of the inserted content. Further, it can be seen out that the third hash value of the hash value list corresponds to the fourth block of the inserted content. Also, it can be seen out that the fourth hash value of the hash value list corresponds to the fifth block of the inserted content. Further, it can be seen out that the fifth hash value of the hash value list corresponds to the sixth block of the inserted content. Subsequently, a digital signature σ₁ corresponding to the public hash values and the link table is generated.

Subsequently, with the verification phase, an insertion block is verified using the public hash values and the link table, and also the digital signature σ₁ is verified. On the other hand, with regard to blocks other than the insertion block, verification is performed using the link table, and the hash value list generated at the signature phase, and also a digital signature σ₀ is verified. Thus, the insertion block is assured to be a block inserted by the modifier, and each block other than the insertion block is assured to be a block succeeded from the original content. Also, the insertion block may be determined from the link table, and accordingly, the data of the public hash values does not have to be generated regarding blocks other than the insertion block, and the data amount of the public hash values may be reduced as compared to SCCS-type PIAT according to the related art. Hereafter, description will be made in detail regarding an embodiment. While a particular type or technology of managing integrity of data is described herein, the present invention is not limited thereto.

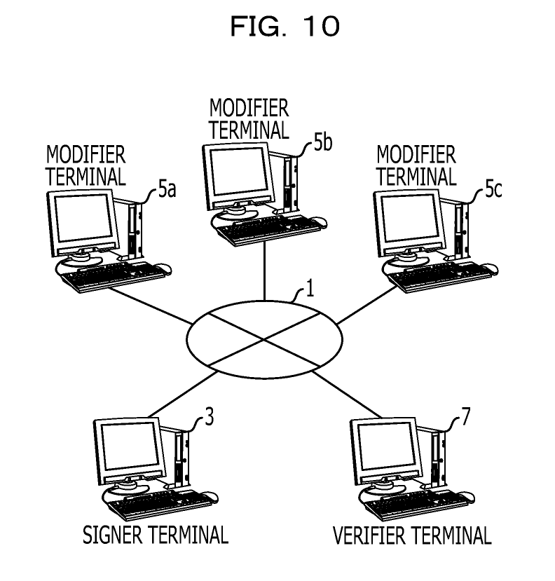

FIG. 10 illustrates a system configuration diagram according to an embodiment. A signer terminal 3 which is operated by a signer, and a modifier terminal 5 (5a through 5c in FIG. 10) which is operated by a modifier, and a verifier terminal 7 which is operated by a verifier are connected to a network 1 that is, for example, the Internet. Note that FIG. 10 illustrates an example wherein the number of signer terminals 3 is one, the number of modifier terminals 5 is three, and the number of verifier terminals 7 is one, but the number of each terminal is not restricted to this.

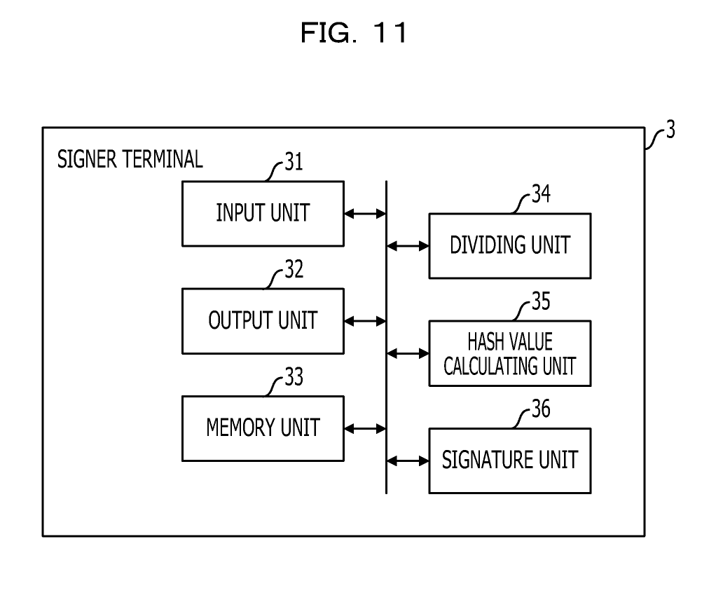

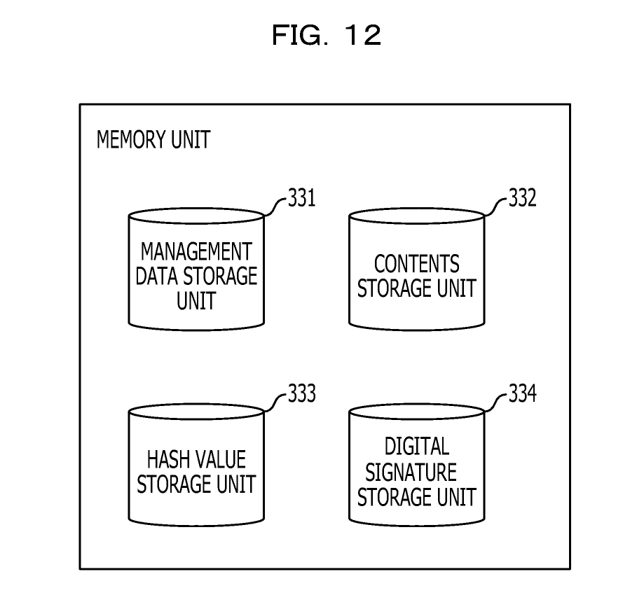

FIG. 11 illustrates a functional block diagram of the signer terminal 3 illustrated in FIG. 10. The signer terminal 3 includes an input unit 31, an output unit 32, a memory unit 33, a dividing unit 34, a hash value calculating unit 35, and a signature unit 36. Note that, such as illustrated in FIG. 12, the memory unit 33 includes a management data storage unit 331, a contents storage unit 332, a hash value storage unit 333, and a digital signature storage unit 334. The private key of a signer is stored in the management storage unit 331 beforehand.

Note that the input unit 31 accepts operations for content creation from a signer, stores a content created by the signer (e.g., document, moving image, still image, music, etc.) in the content storage unit 332, and outputs a content dividing request to the dividing unit 34. In response to the dividing request from the input unit 31, the dividing unit 34 divides a content stored in the content storage unit 332 into two or more blocks. Also, the dividing unit 34 outputs a hash value calculating request to the hash value calculating unit 35. In response to the request from the dividing unit 34, the hash value calculating unit 35 reads out a content from the content storage unit 332 to calculate a hash value as to each block included in the content. Subsequently, the hash value calculating unit 35 stores a hash value list including the calculated hash values in the hash value storage unit 333, and outputs a signature request to the signature unit 36. In response to the request from the hash value calculating unit 35, the signature unit 36 uses the data stored in the management storage unit 331 and the hash value storage unit 333 to generate a digital signature as to the hash value list, and stores this in the digital signature storage unit 334. The output unit 32 outputs the contents stored in the contents storage unit 332, the hash value list stored in the hash value storage unit 333, and a signature list including digital signatures stored in the digital signature storage unit 334 to the modifier terminal 5.

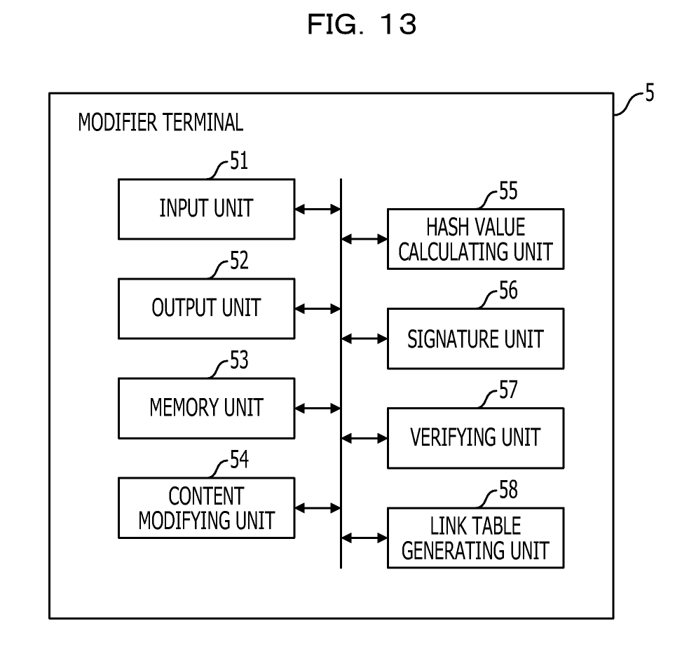

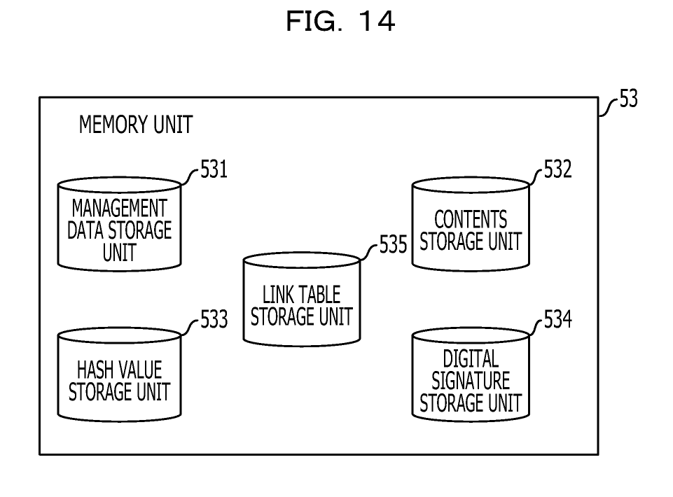

Also, FIG. 13 illustrates a functional block diagram of the modifier terminals 5 illustrated in FIG. 10. The modifier terminals 5 include an input unit 51, an output unit 52, a memory unit 53, a contents modifying unit 54, a hash value calculating unit 55, a signature unit 56, a verifying unit 57, and a link table generating unit 58. Note that, such as illustrated in FIG. 14, the memory unit 53 includes a management data storage unit 531, a contents storage unit 532, a hash value storage unit 533, a digital signature storage unit 534, and a link table storage unit 535. The identifier and private key of a modifier are stored in the management storage unit 531 beforehand. Also, the public key of a signer may be stored in the management data storage unit 531.

Note that in the event that the input unit 51 has received a content, a hash value list, and a signature list from the signer terminal 3, the input unit 51 stores the content in the contents storage unit 532, stores the hash value list in the hash value storage unit 533, and stores the signature list in the digital signature storage unit 534. Also, the input unit 51 outputs a digital signature verification request to the verifying unit 57 as necessary. Further, the input unit 51 accepts a modification, addition, or insertion operation of a block from the modifier, and outputs a content updating request to the contents modifying unit 54. In response to the request from the input unit 51, the verifying unit 57 uses the data stored in the management data storage unit 531 to execute verification processing of a digital signature included in the signature list. In response to the request from the input unit 51, the contents modifying unit 54 performs modification, addition, or insertion of a block as to the content stored in the contents storage unit 532, thereby updating the content. Also, the contents modifying unit 54 outputs a modified, added, or inserted block to the hash value calculating unit 55, or outputs an insertion position number to the link table generating unit 58 in the event of block insertion. In the event that the hash value calculating unit 55 has received the modified, added, or inserted block from the contents modifying unit 54, the hash value calculating unit 55 calculates a hash value as to the block thereof to generate public hash values, and stores these in the hash value storage unit 533. In the event of having received an insertion position number from the content modifying unit 54, the link table generating unit 58 generates a later-described link table, and stores this in the link table storage unit 535. The signature unit 56 uses data to be stored in the management data storage unit 531, hash value storage unit 533, and link table storage unit 535 to generate a digital signature as to the public hash values and the link table, and adds these to the signature list stored in the digital signature storage unit 534. The output unit 52 outputs the updated contents stored in the contents storage unit 532, the hash value list stored in the hash value storage unit 533, the signature list stored in the digital signature storage unit 534, and the link table stored in the link table storage unit 535 to another modifier terminal 5 or verifier terminal 7.

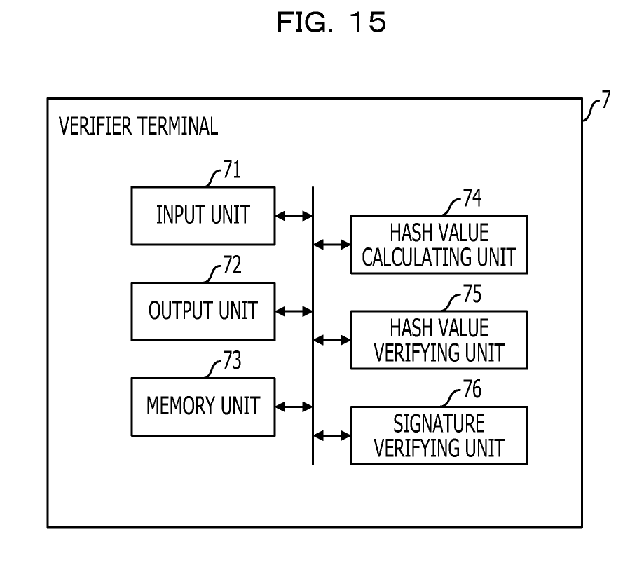

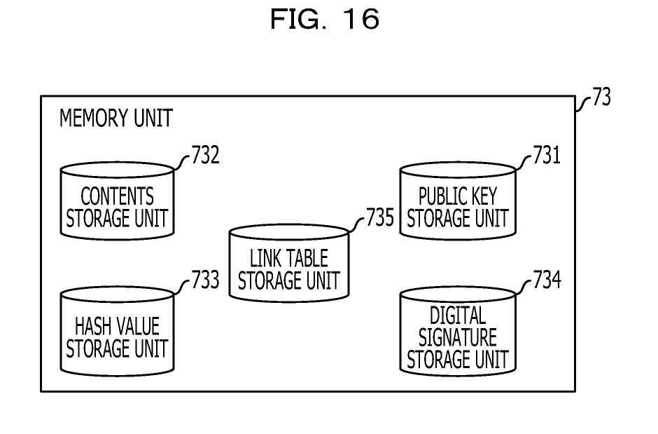

Also, FIG. 15 illustrates a functional block diagram of the verifier terminal 7 illustrated in FIG. 10. The verifier terminal 7 includes an input unit 71, an output unit 72, a memory unit 73, a hash value calculating unit 74, a hash value verifying unit 75, and a signature verifying unit 76. Note that, such as illustrated in FIG. 16, the memory unit 73 includes a public key storage unit 731, a content storage unit 732, a hash value storage unit 733, a digital signature storage unit 734, and a link table storage unit 735. Note that the public key of a signer, and the public key of a modifier are stored in the public key storage unit 731.

Note that, in the event of having received an updated content, hash value list, signature list, and public hash value list, and link table list from the modifier terminal 5, the input unit 71 stores the updated content in the content storage unit 732, stores the hash value list in the hash value storage unit 733, stores the signature list in the digital signature storage unit 734, and stores the link table list in the link table storage unit 735. The hash value calculating unit 74 reads out the updated content from the content storage unit 732, calculates a hash value as to each block included in the updated content, and stores this to the hash value storage unit 733. The hash value verifying unit 75 uses the data stored in the hash value storage unit 733 and the link table storage unit 735 to execute verification processing of each block. The signature verifying unit 76 uses the data stored in the public key storage unit 731, hash value storage unit 733, and digital signature storage unit 734 to execute verification processing of a digital signature included in the signature list. The output unit 72 outputs the verification results to a display device or the like.

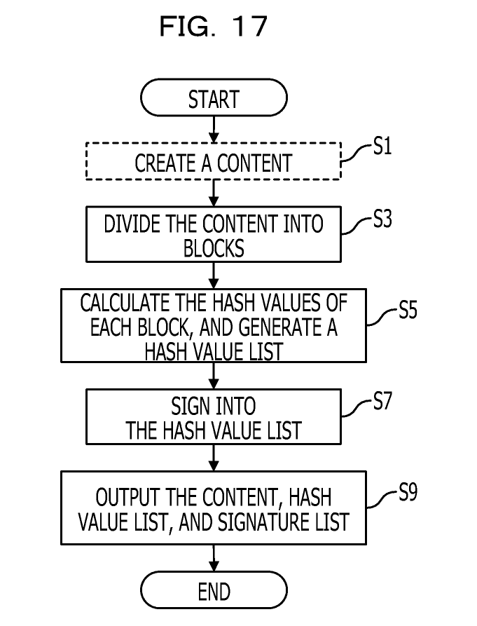

Next, description will be made regarding processing of the signer terminal 3 according to an embodiment, with reference to FIG. 17. First, a signer operates the signer terminal 3 to create a content such as a document, moving image, still image, music, or the like (S1 in FIG. 17). Note that the present processing is for operation of the signer, and is accordingly illustrated with a dotted-line block in FIG. 17. Subsequently, the input unit 31 accepts content creation operation(s) from the signer, and stores a content created by the signer in the contents storage unit 332. Subsequently, the input unit 31 outputs a content dividing request to the dividing unit 34. Note that the dividing request includes information such as a file name of the created content, and so forth.

Subsequently, upon receiving the dividing request from the input unit 31, the dividing unit 34 divides the content stored in the contents storage unit 332 into n blocks (S3). Note that assuming content is M, and the divided blocks are m, M={m₁, . . . , mₙ} holds. For example, in FIG. 9, the content is divided into five blocks from a block m₁ to a block m₅. Subsequently, the dividing unit 34 outputs a hash value calculation request to the hash value calculating unit 35. Note that the hash value calculation request includes the file name of the content, and so forth.

Subsequently, upon receiving the hash value calculation request from the diving unit 34, the hash value calculating unit 35 reads out a content according to the hash value calculation request from the contents storage unit 332. Subsequently, the hash value calculating unit 35 calculates the hash value as to each of the n blocks included in the readout content to generate a hash value list H₀ including the n calculated hash values (S5). Now, assuming that the hash value is h, H₀={h₁, . . . , hₙ} holds. Also, the hash value list H₀ is stored in the hash value storage unit 333. For example, in FIG. 9, five hash values from the hash value h₁ through hash value h₅ are calculated, and a hash value list H₀ including the five hash values is generated. Subsequently, the hash value calculating unit 35 outputs a signature request including specification of the hash value list H₀ serving as a signature object to the signature unit 36.

Subsequently, upon receiving the signature request from the hash value calculating unit 35, the signature unit 36 reads out the private key of the signer from the management data storage unit 331, and further reads out the hash value list H₀ according to the signature request from the hash value storage unit 333. Subsequently, the signature unit 36 uses the private key to generate a digital signature σ₀ as to the hash value list H₀ (S7). At this time, the signature unit 36 stores this in the digital signature storage unit 334 as a signature list Σ={σ₀}.

Subsequently, the output unit 32 reads out the content stored in the contents storage unit 332, the hash value list H₀ stored in the hash value storage unit 333, and the signature list Σ stored in the digital signature storage unit 334, and outputs these to the modifier terminal 5 (S9). Subsequently, the processing ends.

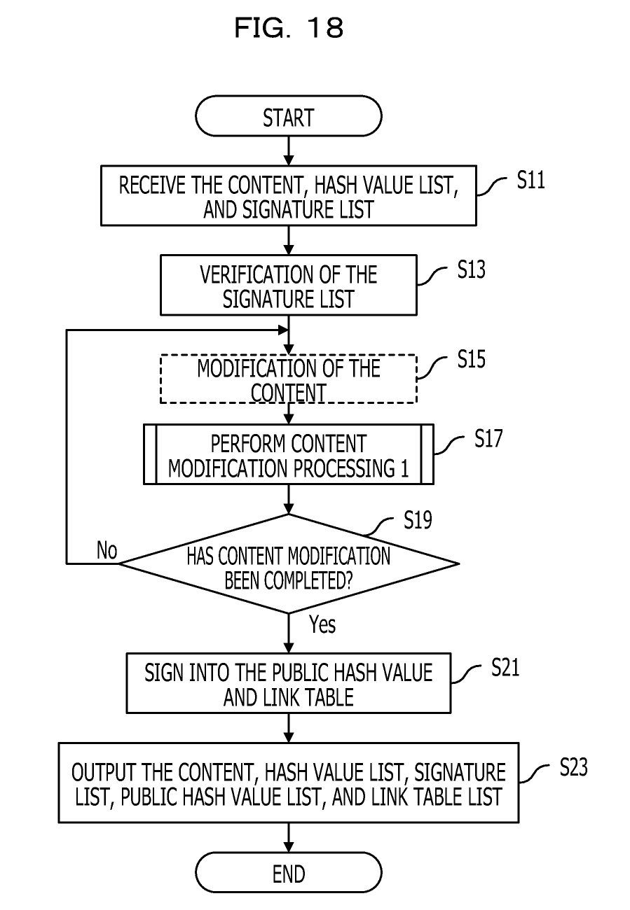

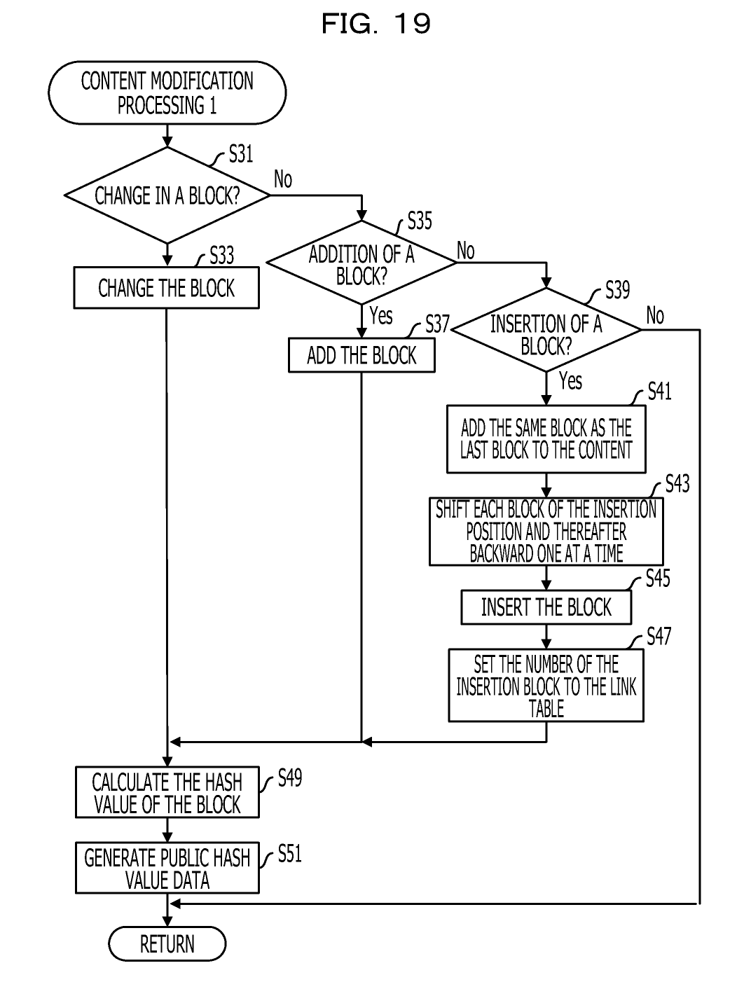

Next, description will be made regarding the processing of the modifier terminal 5 according to an embodiment with reference to FIGS. 18 and 19. Here, description will be made regarding a case of the first modifier. First, the input unit 51 receives the content, hash value list H₀, and signature list Σ from the signer terminal 3 (S11 in FIG. 18). Subsequently, the input unit 51 stores the received content in the contents storage unit 532, stores the hash value list H₀, and stores the signature list Σ in the digital signature storage unit 534. Subsequently, the input unit 51 outputs a digital signature verification request to the verifying unit 57.

Subsequently, upon receiving the verification request from the input unit 51, the verifying unit 57 reads out the signature list E from the digital signature storage unit 534 to execute verification processing of the digital signature σ₀ of a signer included in the signature list Σ (S13). For example, the verifying unit 57 calculates a hash value as to each block included in a content, and verifies the digital signature σ₀ using these hash values, and the public key of a signer. Note that the processing itself for verifying the signature is the same with the related art, and accordingly, description thereof will be omitted.

Subsequently, the modifier operates the modifier terminal 5 to modify the content by, for example, performing change, addition, or insertion of a block (S15). Note that the present processing is the operation of a modifier, and accordingly, which is illustrated with a dotted line block in FIG. 18. Subsequently, the input unit 51 accepts input of a change block, additional block, or insertion block, and outputs a content updating request to the contents modifying unit 54. Note that the content updating request includes the data of an input block, operation type, block number, and so forth.

Subsequently, upon receiving the content updating request from the input unit 51, the contents modifying unit 54 executes content modification processing 1 in cooperation with the memory unit 53, the hash value calculating unit 55, and the link table generating unit 58 (S17). The content modification processing 1 will be described with reference to FIG. 19.

First, the contents modifying unit 54 determines whether or not the operation type is change in a block (S31 in FIG. 19). In the event that the operation type is change in a block (Yes route in S31), the contents modifying unit 54 updates the content stored in the contents storage unit 532 by changing a block (S33). Specifically, the contents modifying unit 54 changes the block of a block number included in the content updating request to the content of the change block. Subsequently, the flow proceeds to processing in S49.

On the other hand, in the event that the operation type is not change in a block (No route in S31), the contents modifying unit 54 determines whether or not the operation type is addition of a block (S35). In the event that the operation type is addition of a block (Yes route in S35), the contents modifying unit 54 updates the content stored in the contents storage unit 532 by adding an additional block to the end of the content (S37). Subsequently, the flow proceeds to processing in S49.

On the other hand, in the event that the operation type is not addition of a block (No route in S35), the contents modifying unit 54 determines whether or not the operation type is insertion of a block (S39). In the event that the operation type is insertion of a block (Yes route in S39), the contents modifying unit 54 adds the same block as the final block to the end of the content (S41). For example, in the event of attempting to insert a new block m₆ into the third of a content M={m₁, m₂, m₃, m₄, m₅}, if the present processing is executed, the content M is changed to {m₁, m₂, m₃, m₄, m₅, m₆, }.

Subsequently, the contents modifying unit 54 shifts each block of the insertion position and thereafter backward one at a time (S43). However, the final block of the content before insertion is excluded from this shift. For example, with the above example, the block m₄ is moved to the fifth position, and the block m₃ is moved to the fourth position. Accordingly, the content M is changed to {m₁, m₂, m₃, m₄, m₅, }.

Subsequently, the contents modifying unit 54 inserts the block into the insertion position (S45). For example, with the above example, the block m₆ is inserted into the third. Accordingly, the content M is changed to {m₁, m₂, m₃, m₄, m₅}, and becomes an inserted content such as illustrated in FIG. 9. Also, the contents modifying unit 54 notifies the link table generating unit 58 of the insertion position number of the block.

Subsequently, upon receiving the insertion position number from the contents modifying unit 54, the link table generating unit 58 sets the number of the insertion block to a link table Lₖ of the link table storage unit 535 (S47). Specifically, the link table generating unit 58 executes processing such as the following. First, the link table generating unit 58 determines whether or not the link table Lₖ is stored in the link table storage unit 535, and in the event that the link table Lₖ is not stored, determines that the present processing is the first processing, and generates a link table Lₖ. For example, in the event that the number of blocks before insertion is n, the link table generating unit 58 generates a link table Lk={1, 2, . . . n}. Subsequently, after generating the link table Lₖ, or in the event of the second processing and thereafter, the link table generating unit 58 determines the greatest number of the link table Lₖ at the current point (n at the time of the first processing), and sets the number next to the number thereof (n+1 at the time of the first processing) to the link table Lₖ as the number of the insertion block. For example, such as illustrated in FIG. 9, in the event that the insertion position is 3, the link table generating unit 58 sets the number of the insertion block to the third of the link table Lₖ. Accordingly, the link table Lₖ becomes Lₖ={1, 2, 6, 3, 4, 5}. Subsequently, the flow proceeds to processing in S49.

On the other hand, in the event that determination is made in S39 that the operation type is not insertion of a block (No route in S39), the link table generating unit 58 skips the subsequent processing to end the present processing. Subsequently, the flow returns to the original processing.

Subsequently, the hash value calculating unit 55 calculates the hash value of the changed, added, or inserted block (S49). Note that the position of a block serving as a calculation object is notified from the contents modifying unit 54. For example, in FIG. 9, a hash value h₆ corresponding to the block m₆ inserted into the third position from the top is calculated.

Determination as to whether an operation type causes at least one of a change, addition or insertion relative to a block may be made based on various criteria including but not limited to identifier of a block, information of content, etc.

Subsequently, the hash value calculating unit 55 generates public hash values v including the identifier of the modifier stored in the management data storage unit 531, block number, and the calculated hash value, and stores these in the hash value storage unit 533 (S51). With an embodiment, assume that the identifier of the modifier is k, the block number is i, the hash value is hₙ₊₁, and the number of blocks before insertion is n, the public hash values v are represented with v={k, i, hₙ₊₁}. Note that there may be a case where two or more blocks are inserted by one modifier, and in this case, the public hash values v are generated regarding each of the insertion blocks. With an embodiment, assume that a number of insertion blocks is p, the public hash values Vₖ are represented with {v₁, . . . , vₚ}. For example, in FIG. 9, the number of blocks inserted by the modifier 1 is one, and accordingly, the public hash values V₁={v} holds, and v={1, 3, h₆} holds. Subsequently, the present processing ends, and the flow returns to the original processing.

Description will return to FIG. 18, after the content modification processing 1 (S17) is executed, the input unit 51 determines whether or not modification of the content has been completed (S19). For example, in the event of having accepted the next operation (change, addition, or insertion of a block) from the modifier, determination is made that modification of the content has not been completed (No route in S19) to return to the processing in S15, where the above described processing is repeated.

On the other hand, in the event that modification completion has been specified from a modifier, determination is made that modification of the content has been completed (Yes route in S19) to proceed to the processing in S21. At this time, the input unit 51 outputs a signature request including specification of the public hash values Vₖ and link table Lₖ serving as a signature object to the signature unit 56.

Subsequently, upon receiving the signature request from the input unit 51, the signature unit 56 reads out the private key of the modifier k from the management data storage unit 531, reads out the public hash values Vₖ from the hash value storage unit 533, and reads out the link table Lₖ from the link table storage unit 535. Subsequently, the signature unit 56 uses the private key of the modifier k to generate a digital signature σₖ as to the readout public hash values Vₖ and link table Lₖ (S21). Subsequently, the signature unit 56 adds the generated digital signature σₖ to the signature list Σ of the digital signature storage unit 534. For example, in FIG. 9, a digital signature σ₁ is generated, the signature list E becomes {σ₀, σ₁}.

Subsequently, the output unit 52 reads out the inserted content from the contents storage unit 532, reads out the hash value list H₀ and the public hash values Vₖ from the hash value storage unit 533, reads out the signature list Σ from the digital signature storage unit 534, and reads out the link table Lₖ from the link table storage unit 535. Subsequently, the output unit 52 adds the public hash values Vₖ to the public hash value list V, and adds the link table Lₖ to the link table list L. In the event of the first modifier, the public hash value list V becomes {Vₖ}, and the link table list L becomes {Lₖ}. Subsequently, the output unit 52 outputs the inserted content, hash value list H₀, signature list Σ, public hash value list V, and link table list L to another modifier terminal 5 or the modifier terminal 7 (S23). Subsequently, the present processing ends.

Note that description has been made above regarding a case of the first modifier, but basic processing is the same regarding a case of the second modifier and thereafter. However, in the case of the second modifier and thereafter, in S11 the input unit 51 receives the inserted content, hash value list H₀, signature list Σ, public hash value list V, and link table list L from the modifier terminal 5 which the former modifier operates. In this case, an arrangement should be made wherein the input unit 51 stores the inserted content in the contents storage unit 532, stores the hash value list H₀ and the public hash value list V in the hash value storage unit 533, stores the signature list Σ in the digital signature storage unit 534, and stores the link table list L in the link table storage unit 535.

Also, in S23, the output unit 52 should add the public hash values Vₖ to the received public hash value list V. That is to say, the public hash value list V becomes { . . . , Vₖ}. Further, the output unit 52 should add the link table Lₖ to the received table list L. That is to say, the table list L becomes { . . . , Lₖ}.

According to processing such as described above being executed, a link table for determining the insertion block may be generated. Note that each block more backward than the insertion block is prevented from generating public hash values, and accordingly, even in the event of inserting a block into a moving image file, the data amount of the public hash values is prevented from increasing.

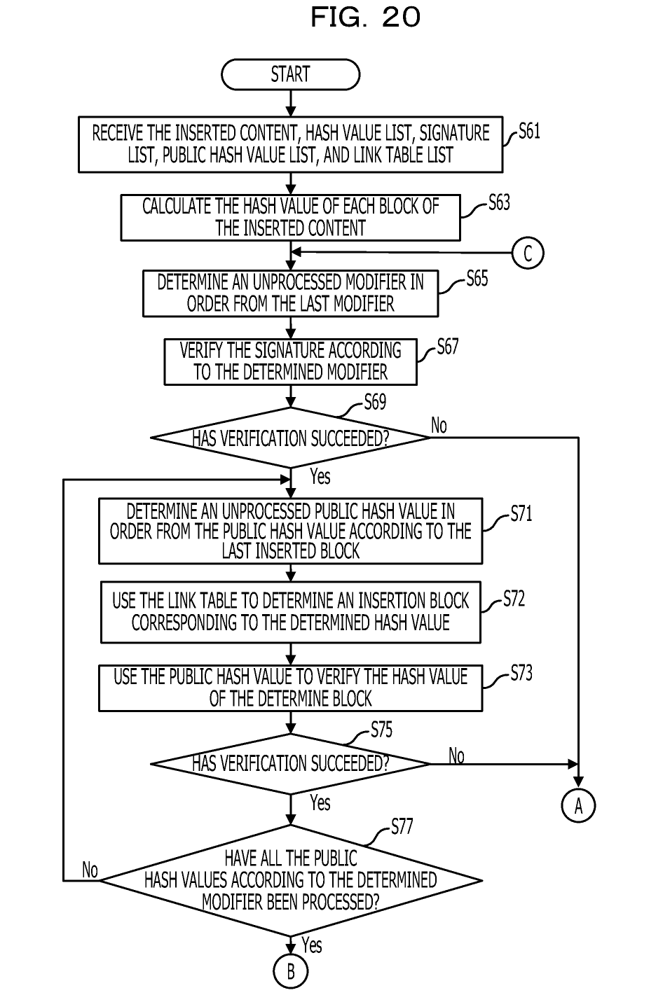

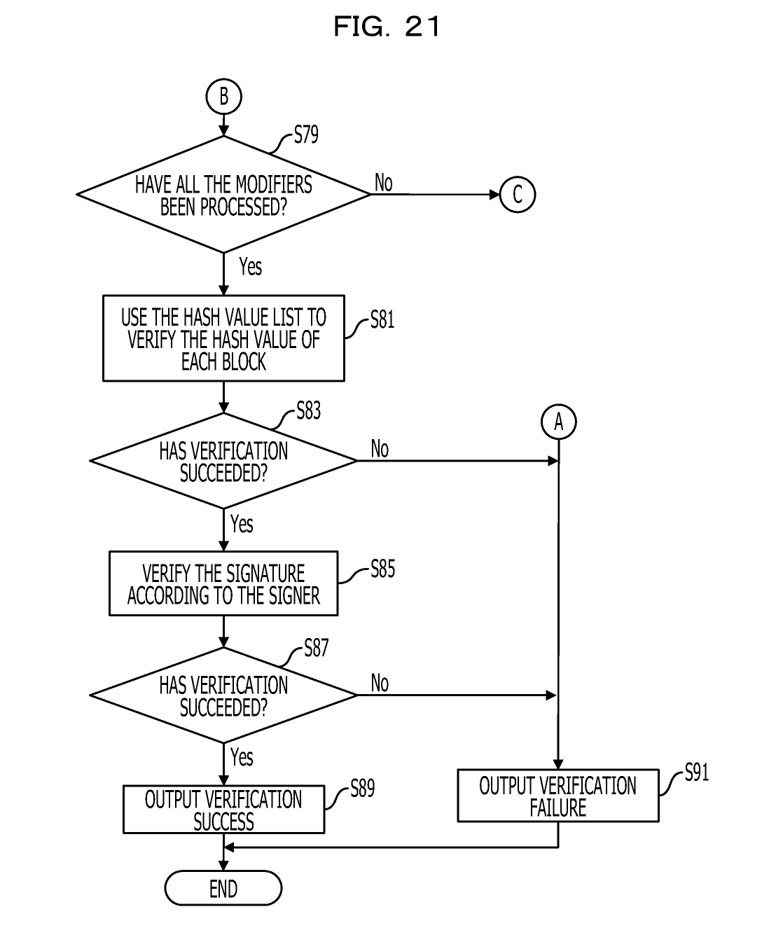

Next, processing of the verifier terminal 7 according to an embodiment will be described with reference to FIGS. 20 and 21. Here, description will be made regarding processing in the event of verifying the inserted content. First, the input unit 71 receives the inserted content, hash value list H₀, signature list Σ, public hash value list V, and link table list L from the modifier terminal 5 (S61 in FIG. 20). Subsequently, the input unit 71 stores the received inserted content in the contents storage unit 732, stores the hash value list H₀ and the public hash value list V in the hash value storage unit 733, stores the signature list Σ in the digital signature storage unit 734, and stores the link table list L in the link table storage unit 735. Subsequently, the input unit 71 outputs a hash value calculation request to the hash value calculating unit 74. Note that the hash value calculation request includes the file name of the inserted content, and so forth.

Subsequently, upon receiving the hash value calculation request from the input unit 71, the hash value calculating unit 74 reads out the inserted content according to the hash value calculation request from the contents storage unit 732. Subsequently, the hash value calculating unit 74 calculates a hash value as to each block included in the readout inserted content, and stores this in the hash value storage unit 733 (S63). For example, in FIG. 9, hash values h₁, h₂, h₃, h₄, and h₅ are calculated. Also, the hash value calculating unit 74 outputs a verification request to the signature verifying unit 76.

Subsequently, upon receiving the verification request from the hash value calculating unit 74, the signature verifying unit 76 determines an unprocessed modifier k in order from the last modifier (S65). For example, with the modification phase, the public hash values Vₖ are added to the public hash value list V in the order which modifications have been performed. Accordingly, the public hash values Vₖ included in the public hash value list V are traced in reverse, whereby a modifier k may be determined in the order from the final modifier.

Subsequently, the signature verifying unit 76 reads out data according to the determined modifier k from the public key storage unit 731, hash value storage unit 733, digital signature storage unit 734, and link table storage unit 735. That is to say, the signature verifying unit 76 reads out the public key of the modifier k from the public key storage unit 731, reads out the public hash values Vₖ from the hash value storage unit 733, reads out the digital signature σₖ from the digital signature storage unit 734, and reads out the link table Lₖ from the link table storage unit 735. Subsequently, the signature verifying unit 76 uses the public key, public hash values Vₖ, and link table Lₖ to execute verification processing of the digital signature σₖ (S67). Note that the verification processing of the digital signature is the same as with the related art, and accordingly, description thereof will be omitted.

Subsequently, in the event that the signature verifying unit 76 has failed in verification in S67 (No route in S69), the flow proceeds to processing in S91 (FIG. 21) through a terminal A.

On the other hand, in the event that the signature verifying unit 76 has succeeded in verification in S67 (Yes route in S69), the signature verifying unit 76 instructs the hash value verifying unit 75 to verify the public hash values. At this time, the signature verifying unit 76 notifies the hash value verifying unit 75 of the public hash values Vₖ and the link table Lₖ along with the instruction. Note that success in verification in S67 means that the public hash values Vₖ and the link table Lₖ are proved wherein the modifier k is a creator, and further neither falsification nor tampering has been subjected thereto.

Subsequently, the hash value verifying unit 75 receives the public hash values Vₖ and the link table Lₖ along with the instruction from the signature verifying unit 76. Subsequently, the hash value verifying unit 75 determines unprocessed public hash values v in the order from the public hash values v of the last inserted block of the public hash values Vₖ (S71). Note that, such as described at the time of description regarding the modifier terminal 5, the public hash values Vₖ include public hash values v equivalent to the number of blocks inserted by the modifier k. The public hash values v are arrayed in the insertion order, and accordingly, with the present processing, the public hash values v are determined in the backward order.

Subsequently, the hash value verifying unit 75 uses the link table Lₖ to determine an insertion block corresponding to the determined public hash values (S72). Note that in S71 the public hash values v are determined in the opposite order of the insertion order, and accordingly, with the present processing as well, an insertion block is determined from the link table Lₖ in the opposite order of the insertion order. For example, in the event that the link table Lₖ at the time of two blocks being inserted into a content including five blocks by the modifier k is {1, 2, 6, 3, 4, 7, 5}, with the first processing, the sixth number “7” from the top is determined, and the sixth block of the inserted content is determined. Further, with the second processing, the third number “6” from the top is determined, and the third block of the inserted content is determined. Thus, blocks are traced in the order from a block having the greatest number.

Subsequently, the hash value verifying unit 75 uses the determined hash value to execute the verification processing of a hash value as to the determined insertion block (S73). Here, the validity of the insertion block thereof is confirmed by verifying the hash value as to the insertion block. Specifically, the hash value calculated in S63 as to this insertion block, and a hash value included in the public hash values v are compared, and in the event that the hash values are matched, success in verification is determined. For example, with the example in FIG. 9, the third block is determined in S72, and the hash value h₆ corresponding to the third block m₆, and the hash value h₆ included in the public hash values are compared.

Subsequently, in the event that the hash value verifying unit 75 has failed in verification in S73 (No route in S75), i.e., in the event that the hash values are unmatched, the flow proceeds to processing in S91 (FIG. 21) through the terminal A.

On the other hand, in the event that the hash value verifying unit 75 has succeeded in verification in S73 (Yes route in S75), the flow proceeds to processing in S77. Note that success in verification in S73 means that the validity of the insertion block has been confirmed.

Subsequently, the hash value verifying unit 75 determines whether or not the processing has been completed regarding all of the public hash values v according to the insertion block inserted by the determined modifier k (S77). In the event that the processing has not been completed regarding all of the public hash values v according to the insertion block inserted by the determined modifier k (No route in S77), the flow returns to the processing in S71 to repeat the above processing.

On the other hand, in the event that the processing has been completed regarding all of the public hash values v according to the insertion block inserted by the determined modifier k (Yes route in S77), the hash value verifying unit 75 notifies the signature verifying unit 76 of that the processing regarding the determined modifier k has been completed. Subsequently, the processing proceeds to S79 (FIG. 21) through a terminal B.

Description will proceed to FIG. 21, where after the terminal B, upon receiving a completion notice from the hash value verifying unit 75, the signature verifying unit 76 determines whether or not the processing has been completed regarding all of the modifiers (S79 in FIG. 21). In the event that the processing has not been completed regarding all of the modifiers (No route in S79), the processing returns to S65 through a terminal C, where the above processing is repeated. That is to say, processing such as described above us repeated in order from the final modifier to the modifier which has first modified the content.

On the other hand, in the event that the processing has been completed regarding all of the modifiers (Yes route in S79), the signature verifying unit 76 instructs the hash value verifying unit 75 to verify each block other than the insertion block.

Subsequently, upon receiving the instruction from the signature verifying unit 76, the hash value verifying unit 75 uses the hash value list H₀ stored in the hash value storage unit 733 to execute the verification processing of the hash value as to each block other than the insertion block (S81). Here, the validity of each block other than the insertion block is confirmed by performing verification of the hash value as to each block other than the insertion block. Specifically, of the hash values calculated in S63, the hash value as to each block other the insertion block, and a hash value included in the hash value list H₀ are compared. At this time, which value is matched with which value is determined from the link table L. For example, with the example in FIG. 9, it has been found that the first block m₁ of an inserted content is the first block of the original content. Accordingly, the hash value h₁ as to the block m₁, and the first hash value h₁ included in the hash value list H₀ are compared. Also, it has been found that the second block m₂ of the inserted content is the second block of the original content. Accordingly, the hash value h₂ as to the block m₂, and the second hash value h₂ included in the hash value list H₀ are compared. Further, it has been found that the third block m₆ of the inserted content is the insertion block. That is to say, the block m₆ becomes other than an object of the present processing. Also, it has been found that the fourth block m₃ of the inserted content is the third block of the original content. Accordingly, the hash value h₃ as to the block m₃, and the third hash value h₃ included in the hash value list H₀ are compared. Further, it has been found that the fifth block m₄ of the inserted content is the fourth block of the original content. Accordingly, the hash value h₄ as to the block m₄, and the fourth hash value h₄ included in the hash value list H₀ are compared. Also, it has been found that the sixth block m₅ of the inserted content is the fifth block of the original content. Accordingly, the hash value h₅ as to the block m₅, and the fifth hash value h₅ included in the hash value list H₀ are compared. Subsequently, as a result of comparison, in the event that the hash values are matched regarding all of the blocks other than the insertion block, determination is made that the verification has succeeded.

Subsequently, in the event that verification in S81 has succeeded (Yes route in S83), the hash value verifying unit 75 notifies the signature verifying unit 76 of that the verification has been completed. Note that success in verification in S81 means that the validity of each block other than the insertion block has been confirmed. Subsequently, the processing proceeds to S85.

Subsequently, upon receiving completion notice from the hash value verifying unit 75, the signature verifying unit 76 reads out the public key of the signer from the public key storage unit 731, reads out the hash value list H₀ from the hash value storage unit 733, and reads out the signature list Σ from the digital signature storage unit 734. Subsequently, the signature verifying unit 76 uses the public key of the signer, and the hash value list H₀ to carry out verification processing of the digital signature σ₀ according to the signer included in the signature list Σ (S85). Note that the verification processing of the digital signature is the same as with the related art, and accordingly, description thereof will be omitted.

Subsequently, in the event that the verification in S85 has succeeded (Yes route in S87), success in verification is notified to the output unit 72. Subsequently, the output unit 72 outputs success in verification to the display device or the like (S89). Subsequently, the processing ends.

On the other hand, in the event that the verification in S81 has failed (No route in S83), in the event that the verification in S85 has failed (No route in S87), or after the terminal A, the output unit 72 outputs failure in verification to the display device or the like (S91). Note that which verification has failed may be displayed together. Subsequently, the processing ends.

Such as described above, SCCS-type PIAT is transshaped, whereby partial integrity assurance of a content may be realized even at the time of block insertion. That is to say, in the event that the verification has succeeded, the integrity of the inserted content is proved, and also it is assured that blocks other than the insertion block are blocks succeeded from the original content.

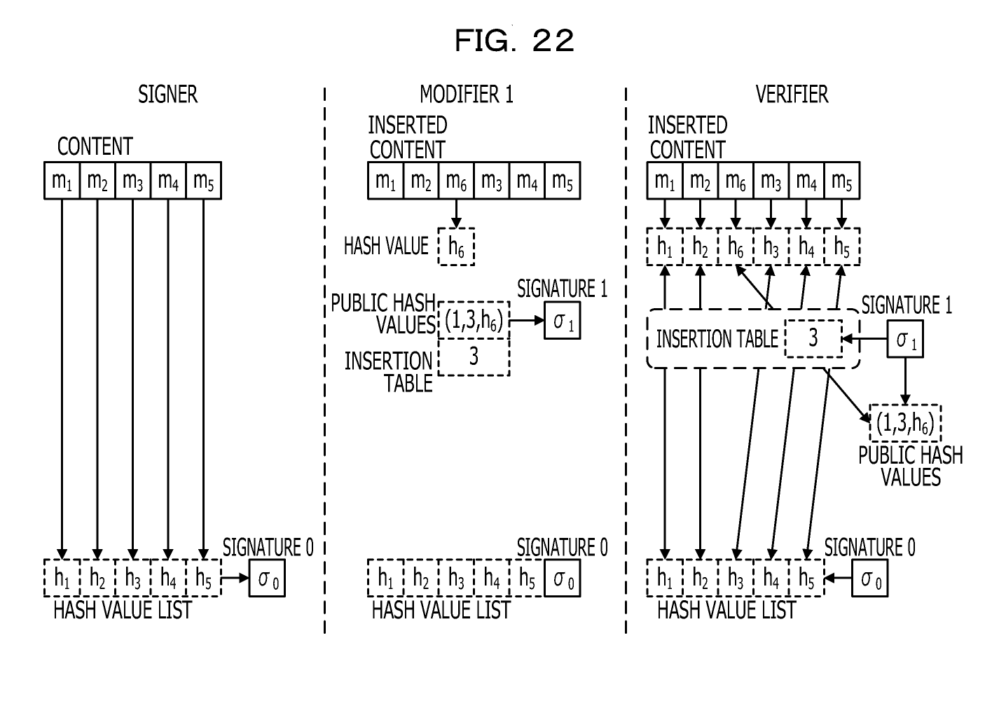

Next, an embodiment will be described. Withan embodiment, partial integrity assurance at the time of block insertion is realized with a flow such as illustrated in FIG. 22. Note that an embodiment is obtained by transforming the above-described embodiment, and a rough flow is the same as that of the above-described embodiment. With an embodiment, an insertion table is employed instead of the link table.

Such as illustrated in FIG. 22, with an embodiment, for example, in the event that a block m₆ has been inserted in the third position of a content, the hash value corresponding to the insertion block m₆ is calculated to generate public hash values including the identifier of a modifier, an insertion position number, and the hash value thereof. Subsequently, with an embodiment, an insertion table such as illustrated in FIG. 22 is generated at the modification phase. The insertion table includes an insertion position number. Subsequently, and digital signature σ₁ as to the public hash values and the insertion table is generated.

Subsequently, with the verification phase, an insertion block is verified using the public hash values and the insertion table, and also the digital signature σ₁ is verified. Subsequently, in the event that the verification has succeeded, with an embodiment, the hash value h₆ as to the insertion block is removed. Subsequently, the hash values from which the hash value as to the insertion block has been removed, and the hash values generated at the signature phase are used to verify blocks other than the insertion block, and also the digital signature σ₀ is verified. Thus, the insertion block is assured to have been inserted by the modifier, and each block other than the insertion block is assured to have been processed from the original content. Also, the insertion table is data smaller than the link table, and accordingly, the data amount may be reduced as compared to the case of the above described embodiment. Hereafter, another embodiment will be described in detail.

The system configuration according to an embodiment is the same as the system configuration illustrated in FIG. 10. Also, the configuration of a signer terminal 3 according to an embodiment is the same as the block diagram illustrated in FIG. 11 and FIG. 12.

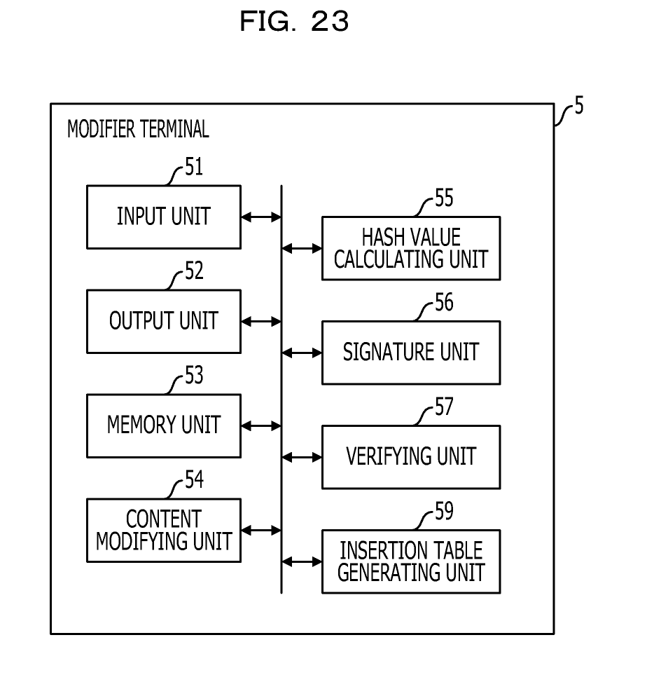

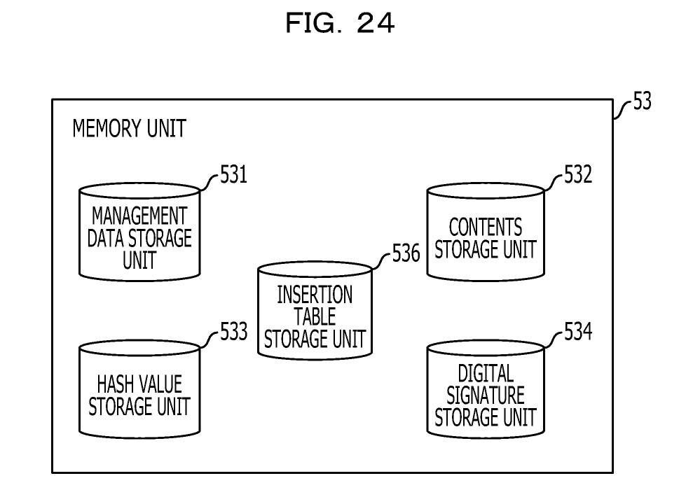

FIG. 23 illustrates a functional block diagram of a modifier terminal 5 according to an embodiment. The modifier terminal 5 according to an embodiment includes an input unit 51, an output unit 52, a memory unit 53, a content modifying unit 54, a hash value calculating unit 55, a signature unit 56, a verifying unit 57, and an insertion table generating unit 59. Note that the input unit 51, output unit 52, memory unit 53, content modifying unit 54, hash value calculating unit 55, signature unit 56, and verifying unit 57 are basically the same as those of the above-described embodiment, but with another embodiment, the memory unit 53 includes various types of storage units such as illustrated in FIG. 24. Specifically, the memory unit 53 includes a management data storage unit 531, a contents storage unit 532, a hash value storage unit 533, a digital signature storage unit 534, and an insertion table storage unit 536. Note that the management data storage unit 531, contents storage unit 532, hash value storage unit 533, digital signature storage unit 534, and insertion table storage unit 536 are basically the same as those of the above-described embodiment.

With an embodiment, the contents modifying unit 54 outputs an insertion position number to the insertion table generating unit 59. Subsequently, upon receiving the insertion position number from the contents modifying unit 54, the insertion table generating unit 59 generates an insertion table, and stores this in the insertion table storage unit 536.

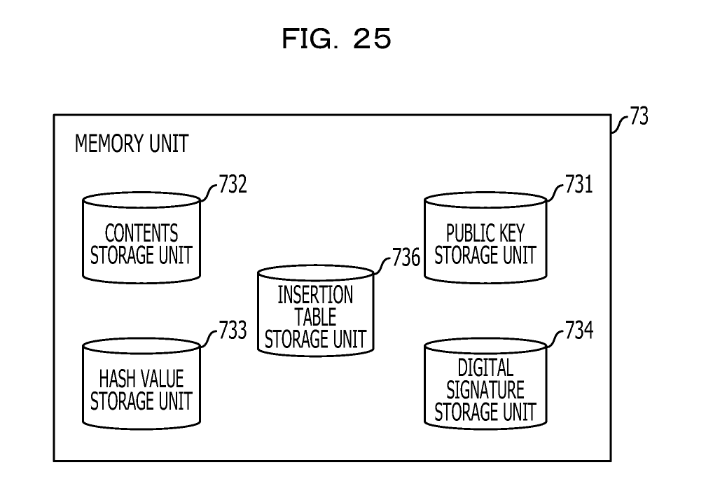

Also, the configuration of the verifier terminal 7 according to an embodiment is basically the same as that illustrated in FIG. 15, but with an embodiment, the memory unit 73 includes various types of storage units such as illustrated in FIG. 25. Specifically, the memory unit 73 includes a public key storage unit 731, a contents storage unit 732, a hash value storage unit 733, a digital signature storage unit 734, and an insertion table storage unit 736. Note that the public key storage unit 731, contents storage unit 732, hash value storage unit 733, and digital signature storage unit 734 are the same as those of the above-described embodiment.

With an embodiment, the input unit 71 receives a later-described insertion table instead of the link table list, and stores this in the insertion table storage unit 736. Subsequently, the hash value verifying unit 75 uses the insertion table list stored in the insertion table storage unit 736 to execute the verification processing of a hash value as to the insertion block.

Next, description will be made regarding the processing of the modifier terminal 5 and verifier terminal 7 according to an embodiment. Note that the processing of the signer terminal 3 is the same as that of the above described embodiment, and accordingly, description thereof will be omitted.

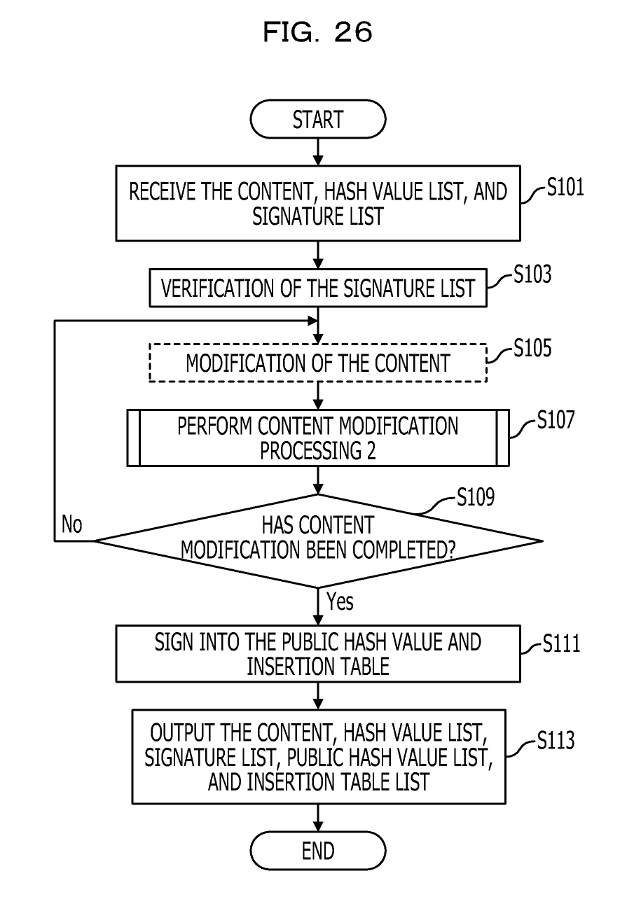

First, the processing of the modifier terminal 5 according to an embodiment will be described with reference to FIG. 26 through FIG. 28. Here, description will be made regarding a case of the first modifier. First, the input unit 51 receives a content, hash value list H₀, and signature list Σ from the signer terminal 3 (S101 in FIG. 26). Subsequently, the input unit 51 stores the received content in the contents storage unit 532, stores the hash value list H₀ in the hash value storage unit 533, and stores the signature list Σ in the digital signature storage unit 534. Subsequently, the input unit 51 outputs a digital signature verification request to the verifying unit 57.

Subsequently, upon receiving the verification request from the input unit 51, the verifying unit 57 reads out the signature list Σ from the digital signature storage unit 534, and executes the verification processing of the digital signature σ₀ of a signer included in the signature list Σ (S103). For example, the verifying unit 57 calculates a hash value as to each block included in the content, and uses these hash values and the public key of a signer to verify the digital signature σ₀. Note that the processing itself for verifying the signature is the same with the related art, and accordingly, description thereof will be omitted.

Subsequently, the modifier operates the modifier terminal 5 to modify the content by performing change, addition, or insertion of a block (S105). Note that the present processing is the operation of a modifier, and accordingly, which is illustrated with a dotted line block in FIG. 26. Subsequently, the input unit 51 accepts input of a change block, additional block, or insertion block, and outputs a content updating request to the contents modifying unit 54. Note that the content updating request includes the data of an input block, operation type, block number, and so forth.

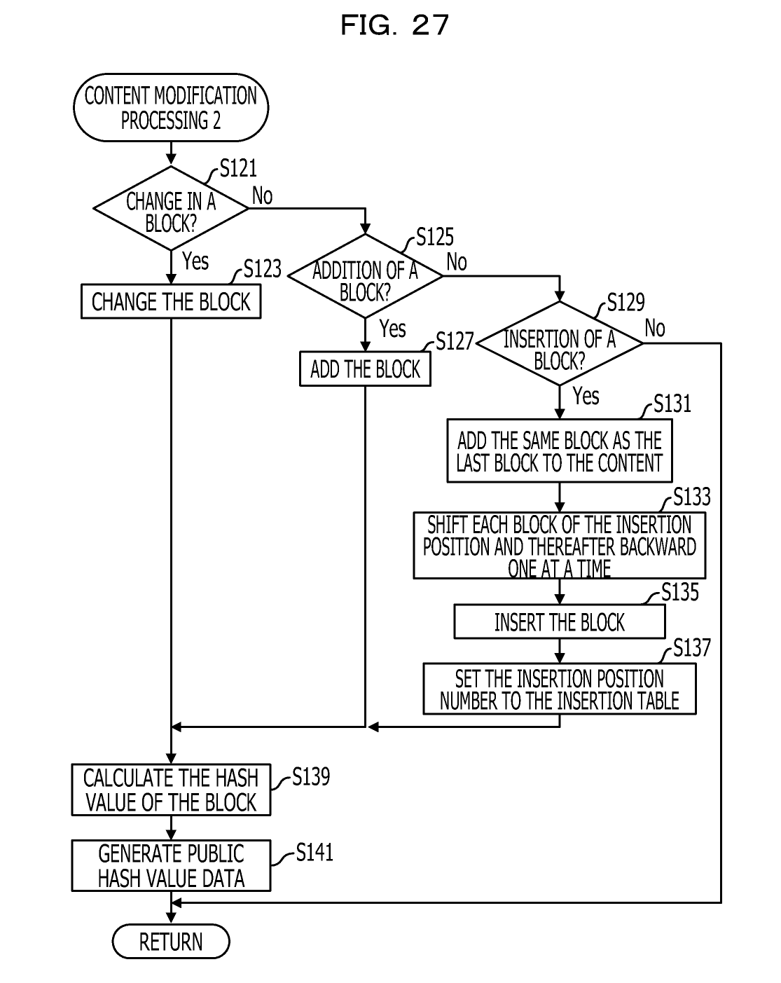

Subsequently, upon receiving the content updating request from the input unit 51, the contents modifying unit 54 executes content modification processing 2 in cooperation with the memory unit 53, hash value calculating unit 55, and insertion table generating unit 59 (S107). The content modification processing 2 will be described with reference to FIG. 27.

First, the contents modifying unit 54 determines whether or not the operation type is change in a block (S121 in FIG. 27). In the event that the operation type is change in a block (Yes route in S121), the contents modifying unit 54 updates the content stored in the contents storage unit 532 by changing a block (S123). Specifically, the contents modifying unit 54 changes the block of a block number included in the content updating request to the content of the change block. Subsequently, the flow proceeds to processing in S139.

On the other hand, in the event that the operation type is not change in a block (No route in S121), the contents modifying unit 54 determines whether or not the operation type is addition of a block (S125). In the event that the operation type is addition of a block (Yes route in S125), the contents modifying unit 54 updates the content stored in the contents storage unit 532 by adding an additional block to the end of the content (S127). Subsequently, the flow proceeds to processing in S139.

On the other hand, in the event that the operation type is not addition of a block (No route in S125), the contents modifying unit 54 determines whether or not the operation type is insertion of a block (S129). In the event that the operation type is insertion of a block (Yes route in S129), the contents modifying unit 54 adds the same block as the final block to the end of the content (S131). Subsequently, the contents modifying unit 54 shifts each block of the insertion position and thereafter backward one at a time (S133). Subsequently, the contents modifying unit 54 inserts the block into the insertion position (S135). Note that the processing in S131 through S135 is the same processing as that of the above-described embodiment, and accordingly, detailed description will be omitted. Subsequently, the content modifying unit 54 notifies the insertion table generating unit 59 of the insertion position number of the block.

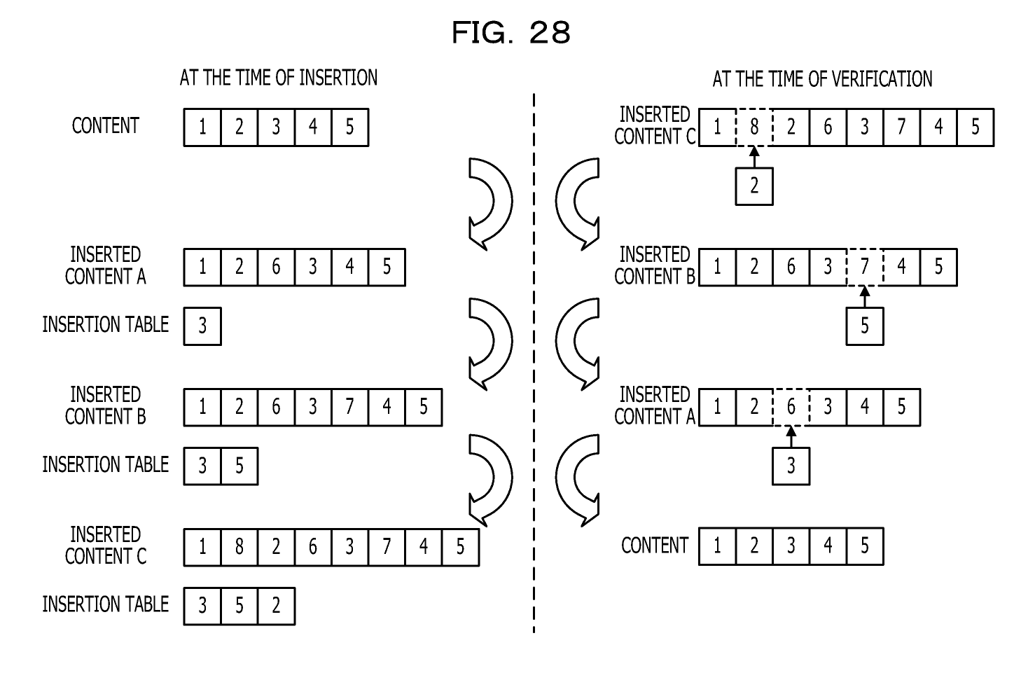

Subsequently, upon receiving the insertion position number from the contents modifying unit 54, the insertion table generating unit 59 sets the insertion position number to an insertion table Iₖ of the insertion table storage unit 536 (S137). Note that, in the event that the insertion table Iₖ is not stored in the insertion table storage unit 536, the insertion table generating unit 59 determines that the present processing is the first processing, and generates an insertion table Iₖ including the insertion position number, and stores this in the insertion table storage unit 536. Also, in the event that the present processing is the second and thereafter, the insertion table generating unit 59 adds the insertion position number received this time to the insertion table Iₖ. For example, FIG. 28 illustrates a setting example of the insertion table Iₖ. Note that FIG. 28 illustrates a setting example in a case where three blocks are sequentially inserted into a content including five blocks. First, the first insertion block (block having a number 6 in FIG. 28) is inserted into the position of the third position of the content, the insertion table Iₖ={3} is generated. Next, the second insertion block (block having a number 7 in FIG. 28) is inserted into the fifth position of the inserted content A, and “5” is added to the insertion table Iₖ. That is to say, the insertion table Iₖ becomes the insertion table Iₖ={3, 5}. Subsequently, the third insertion block is inserted into the second position of the inserted content B, and “2” is added to the insertion table Iₖ. That is to say, the insertion table Iₖ becomes the insertion table Iₖ={3, 5, 2}. Note that the details will be described, but verification of the insertion blocks is performed in the opposite order of the insertion order. Subsequently, the flow proceeds to processing in S139.

On the other hand, in the event that determination is made in S129 that the operation type is not insertion of a block (No route in S129), the flow skips the subsequent processing to end the present processing. Subsequently, the flow returns to the original processing.

Subsequently, the hash value calculating unit 55 calculates the hash value of the changed, added, or inserted block (S139). Note that the position of a block serving as a calculation object is notified from the contents modifying unit 54. Subsequently, the hash value calculating unit 55 generates public hash values v including the identifier of the modifier stored in the management data storage unit 531, block number, and the calculated hash value, and stores these in the hash value storage unit 533 (S141). Note that the processing in S139 and S141 is the same processing as that of the above-described embodiment, and accordingly, detailed description will be omitted. Subsequently, the present processing ends, and the flow returns to the original processing.

Description will return to FIG. 20, after the content modification processing 2 (S107) is executed, the input unit 51 determines whether or not modification of the content has been completed (S109). For example, in the event of having accepted the next operation (change, addition, or insertion of a block) from the modifier, determination is made that modification of the content has not been completed (No route in S109), the flow returns to the processing in S105, where the above described processing is repeated.

On the other hand, in the event that modification completion has been specified from a modifier, determination is made that modification of the content has been completed (Yes route in S109), and the flow proceeds to processing in S111. At this time, the input unit 51 outputs a signature request including specification of the public hash values Vₖ and insertion table Iₖ serving as a signature object to the signature unit 56.

Subsequently, upon receiving the signature request from the input unit 51, the signature unit 56 reads out the private key of the modifier k from the management data storage unit 531, reads out the public hash values Vₖ from the hash value storage unit 533, and reads out the insertion table Iₖ from the insertion table storage unit 536. Subsequently, the signature unit 56 uses the private key of the modifier k to generate a digital signature σₖ as to the readout public hash values Vₖ and insertion table Iₖ (S111). Subsequently, the signature unit 56 adds the generated digital signature σₖ to the signature list Σ of the digital signature storage unit 534. For example, in FIG. 22, a digital signature σ₁ is generated, resulting in the signature list Σ {σ₀, σ₁}.

Subsequently, the output unit 52 reads out the inserted content from the contents storage unit 532, reads out the hash value list H₀ and the public hash values Vₖ from the hash value storage unit 533, reads out the signature list Σ from the digital signature storage unit 534, and reads out the insertion table Iₖ from the insertion table storage unit 536. Subsequently, the output unit 52 adds the public hash values Vₖ to the public hash value list V, and adds the insertion table Iₖ to the insertion table list I. In the event of the first modifier, the public hash value list V becomes V={Vₖ}, and the insertion table list I becomes I={Iₖ}. Subsequently, the output unit 52 outputs the inserted content, hash value list H₀, signature list Σ, public hash value list V, and insertion table list I to another modifier terminal 5 or the modifier terminal 7 (S113). Subsequently, the present processing ends.

Note that description has been made above regarding a case of the first modifier, but basic processing is the same regarding a case of the second modifier and thereafter. However, in the case of the second modifier and thereafter, in S101 the input unit 51 receives the inserted content, hash value list H₀, signature list Σ, public hash value list V, and insertion table list I from the modifier terminal 5 which the former modifier operates. In this case, an arrangement should be made wherein the input unit 51 stores the inserted content in the contents storage unit 532, stores the hash value list H₀ and the public hash value list V in the hash value storage unit 533, stores the signature list Σ in the digital signature storage unit 534, and stores the insertion table list I in the insertion table storage unit 536.

Also, in S113, the output unit 52 should add the insertion table Iₖ to the received insertion table list I. That is to say, the insertion table list I becomes I={ . . . , Lₖ}.

According to processing such as described above being executed, an insertion table for determining an insertion block may be generated. Note that the insertion table is data smaller than the link table, and accordingly, data amount may be reduced as compared to the above-described embodiment.

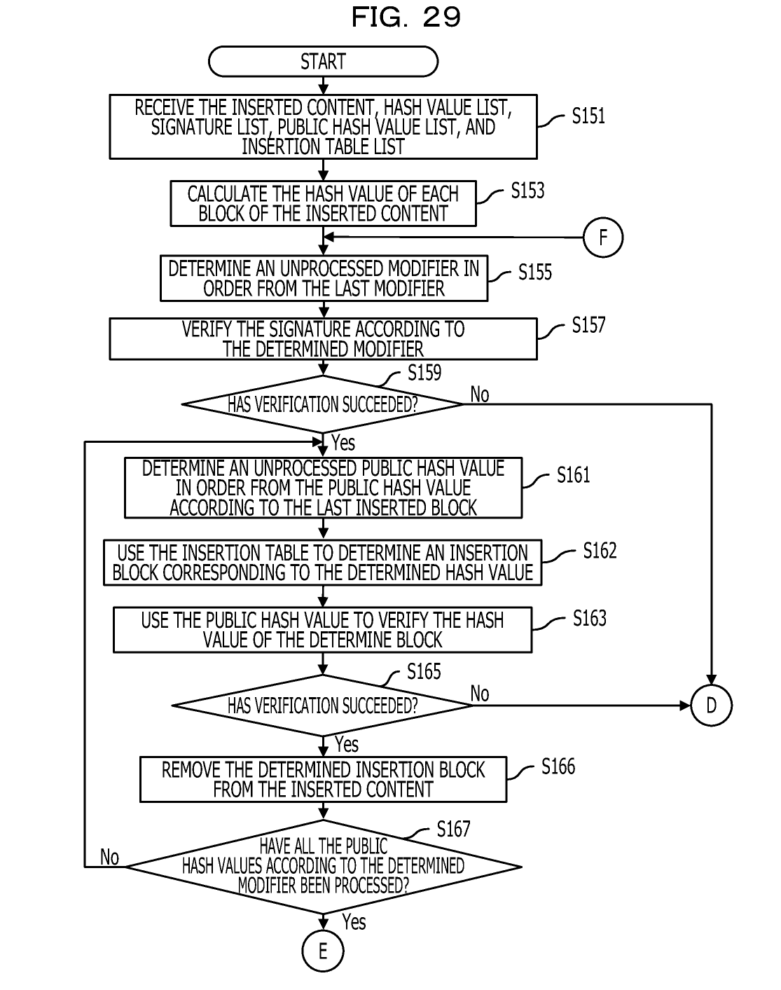

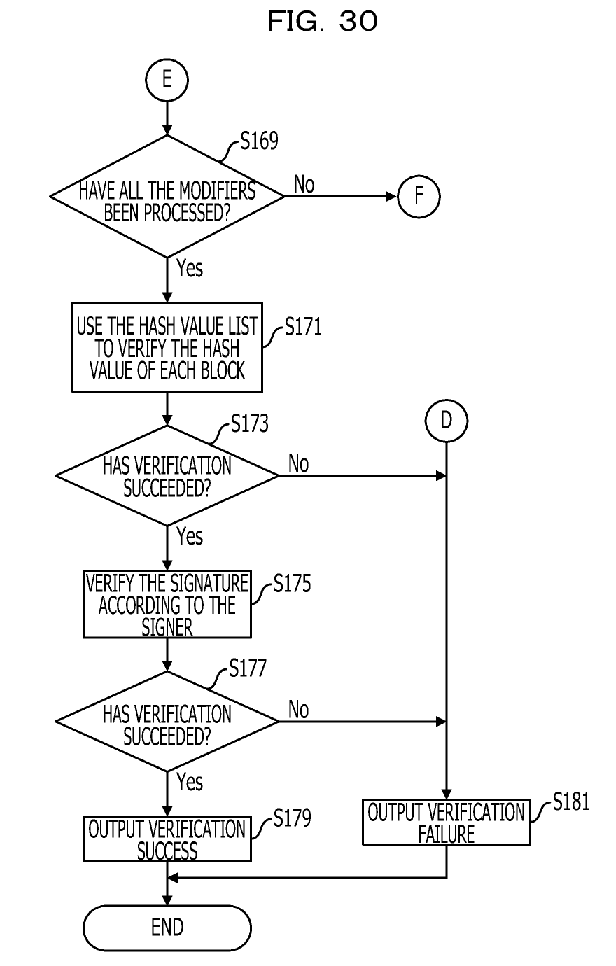

Next, processing of the verifier terminal 7 according to an embodiment will be described with reference to FIG. 29 and FIG. 30. Here, description will be made regarding processing in the event of verifying the inserted content. First, the input unit 71 receives the inserted content, hash value list H₀, signature list Σ, public hash value list V, and insertion table list I from the modifier terminal 5 (S151 in FIG. 29). Subsequently, the input unit 71 stores the received inserted content in the contents storage unit 732, stores the hash value list H₀ and the public hash value list V in the hash value storage unit 733, stores the signature list Σ in the digital signature storage unit 734, and stores the insertion table list I in the insertion table storage unit 736. Subsequently, the input unit 71 outputs a hash value calculation request to the hash value calculating unit 74. Note that the hash value calculation request includes the file name of the inserted content, and so forth.

Subsequently, upon receiving the hash value calculation request from the input unit 71, the hash value calculating unit 74 reads out the inserted content according to the hash value calculation request from the contents storage unit 732. Subsequently, the hash value calculating unit 74 calculates a hash value as to each block included in the readout inserted content, and stores this in the hash value storage unit 733 (S153). For example, in FIG. 22, hash values h₁, h₂, h₆, h₃, h₄, and h₅ are calculated. Also, the hash value calculating unit 74 outputs a verification request to the signature verifying unit 76.

Subsequently, upon receiving the verification request from the hash value calculating unit 74, the signature verifying unit 76 determines an unprocessed modifier k in order from the last modifier (S155). Subsequently, the signature verifying unit 76 reads out data according to the determined modifier k from the public key storage unit 731, hash value storage unit 733, digital signature storage unit 734, and insertion table storage unit 736. That is to say, the signature verifying unit 76 reads out the public key of the modifier k from the public key storage unit 731, reads out the public hash values Vₖ from the hash value storage unit 733, reads out the digital signature σₖ from the digital signature storage unit 734, and reads out the insertion table Iₖ from the insertion table storage unit 736. Subsequently, the signature verifying unit 76 uses the public key, public hash values Vₖ, and insertion table Iₖ to execute verification processing of the digital signature σₖ (S157). Note that the verification processing of the digital signature is the same as with the related art, and accordingly, description thereof will be omitted.

Subsequently, in the event that the signature verifying unit 76 has failed in verification in S157 (No route in S159), the flow proceeds to processing in S181 (FIG. 30) through a terminal D.

On the other hand, in the event that the signature verifying unit 76 has succeeded in verification in S157 (Yes route in S159), the signature verifying unit 76 instructs the hash value verifying unit 75 to verify the public hash values. At this time, the signature verifying unit 76 notifies the hash value verifying unit 75 of the public hash values Vₖ and the insertion table Iₖ along with the instruction. Note that success in verification in S157 means that the public hash values Vₖ and the insertion table Iₖ are proved wherein the modifier k is a creator, and further neither falsification nor tampering has been subjected thereto.

Subsequently, the hash value verifying unit 75 receives the public hash values Vₖ and the insertion table Iₖ along with the instruction from the signature verifying unit 76. Subsequently, the hash value verifying unit 75 determines unprocessed public hash values v in the order from the public hash values v of the last inserted block of the public hash values Vₖ (S161). Note that the public hash values Vₖ include public hash values v equivalent to the number of blocks inserted by the modifier k. The public hash values v are arrayed in the insertion order, and accordingly, with the present processing, the public hash values v are determined in the backward order.

Subsequently, the hash value verifying unit 75 uses the insertion table Iₖ to determine an insertion block corresponding to the determined public hash values (S162). Note that in S161 the public hash values v are determined in the opposite order of the insertion order, and accordingly, with the present processing as well, an insertion block is determined from the insertion table Iₖ in the opposite order of the insertion order. For example, in FIG. 28, the insertion table Iₖ={3, 5, 2}, and accordingly, the second block of the inserted content C is determined as an insertion block. Note that details will be described later, this insertion block is removed. Next, the fifth block of the inserted content B is determined as an insertion block. Similarly, this insertion block is removed. Subsequently, the third block of the inserted content A is determined as an insertion block.

Subsequently, the hash value verifying unit 75 uses the determined public hash values to execute the verification processing of a hash value as to the determined insertion block (S163). Here, a validity of the insertion block thereof is confirmed by verifying the hash value as to the insertion block. Note that the present processing is the same processing as the above-described embodiment, and accordingly, detailed description will be omitted.

Subsequently, in the event that the hash value verifying unit 75 has failed in verification in S163 (No route in S165), i.e., in the event that the hash values are unmatched, the flow proceeds to processing in S181 (FIG. 30) through the terminal D.

On the other hand, in the event that the hash value verifying unit 75 has succeeded in verification in S163 (Yes route in S165), the flow proceeds to processing in S166. Note that success in verification in S163 means that the validity of the insertion block has been confirmed.

Subsequently, the hash value verifying unit 75 removes the determined insertion block from the inserted content (S166). Thus, the inserted content returns to a state before the determined insertion block is inserted. Note that the inserted content received from the modifier terminal 5 is duplicated to generate data for verification, and processing is performed using the data for verification.

Subsequently, the hash value verifying unit 75 determines whether or not the processing has been completed regarding all of the public hash values v according to the insertion block inserted by the determined modifier k (S167). In the event that the processing has not been completed regarding all of the public hash values v according to the insertion block inserted by the determined modifier k (No route in S167), the flow returns to the processing in S161 to repeat the above processing.

On the other hand, in the event that the processing has been completed regarding all of the public hash values v according to the insertion block inserted by the determined modifier k (Yes route in S167), the hash value verifying unit 75 notifies the signature verifying unit 76 of that the processing regarding the determined modifier k has been completed. Subsequently, the processing proceeds to S169 (FIG. 30) through a terminal E.

Description will proceed to FIG. 30, where after the terminal E, upon receiving a completion notice from the hash value verifying unit 75, the signature verifying unit 76 determines whether or not the processing has been completed regarding all of the modifiers (S169 in FIG. 30). In the event that the processing has not been completed regarding all of the modifiers (No route in S169), the processing returns to S155 through a terminal F, where the above processing is repeated. That is to say, processing such as described above is repeated in order from the last modifier to the modifier who has performed content modification first.

On the other hand, in the event that the processing has been completed regarding all of the modifiers (Yes route in S169), the signature verifying unit 76 instructs the hash value verifying unit 75 to verify each block other than the insertion block.

Subsequently, upon receiving the instruction from the signature verifying unit 76, the hash value verifying unit 75 uses the hash value list H₀ stored in the hash value storage unit 733 to execute the verification processing of the hash value as to each block other than the insertion block (S171). Here, the validity of each block other than the insertion block is confirmed by performing verification of the hash value as to each block other than the insertion block. Note that the insertion block is removed in S166, and accordingly, completion of the processing regarding all of the modifiers assumes that all of the insertion blocks have been removed, and the inserted content has returned to the original content state. Accordingly, a hash value corresponding to a remaining block, and a hash value included in the hash value list H₀ are compared, and in the event that the hash values are matched, determination is made that the verification has succeeded.

Subsequently, in the event that verification in S171 has succeeded (Yes route in S173), the hash value verifying unit 75 notifies the signature verifying unit 76 of that the verification has been completed. Note that success in verification in S171 means that the validity of each block other than the insertion block has been confirmed. Subsequently, the processing proceeds to S175.

Subsequently, upon receiving completion notice from the hash value verifying unit 75, the signature verifying unit 76 reads out the public key of the signer from the public key storage unit 731, reads out the hash value list H₀ from the hash value storage unit 733, and reads out the signature list Σ from the digital signature storage unit 734. Subsequently, the signature verifying unit 76 uses the public key of the signer, and the hash value list H₀ to carry out verification processing of the digital signature σ₀ according to the signer included in the signature list Σ (S175). Note that the verification processing of the digital signature is the same as with the related art, and accordingly, description thereof will be omitted.

Subsequently, in the event that the verification in S175 has succeeded (Yes route in S177), success in verification is notified to the output unit 72. Subsequently, the output unit 72 outputs success in verification to the display device or the like (S179). Subsequently, the processing ends.

On the other hand, in the event that the verification in S171 has failed (No route in S173), in the event that the verification in S175 has failed (No route in S177), or after the terminal D, the output unit 72 outputs failure in verification to the display device or the like (S181). Note that which verification has failed may be displayed together. Subsequently, the processing ends.

Such as described above, SCCS-type PIAT is transshaped, whereby partial integrity assurance at the time of block insertion may be realized with data amount smaller than that of the above described embodiment.

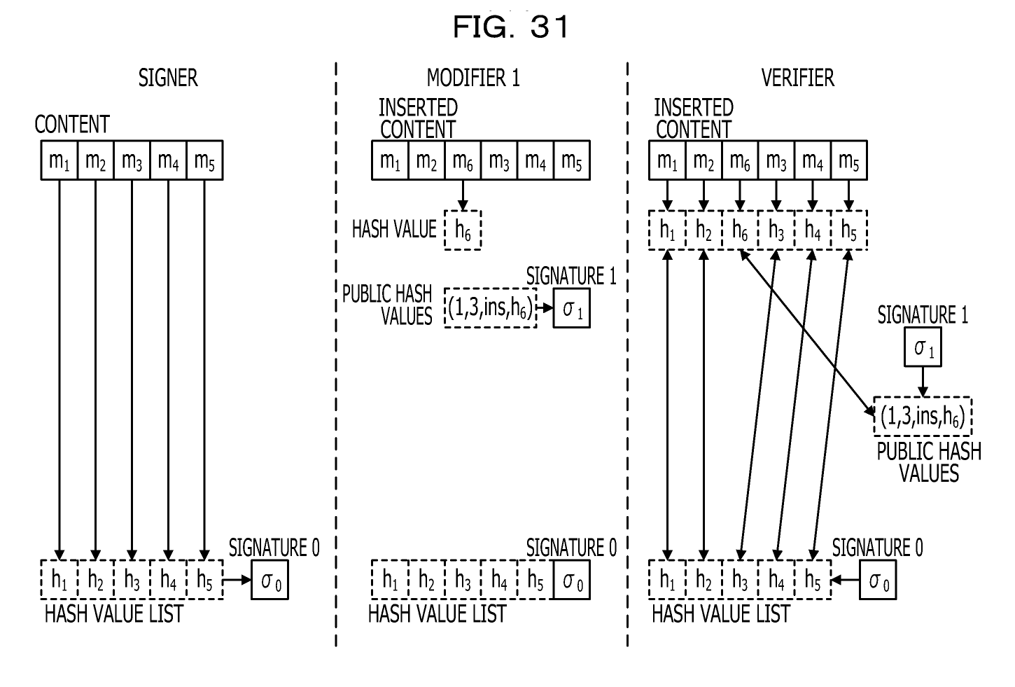

Next, another embodiment will be described. With an embodiment, partial integrity assurance at the time of block insertion is realized with a flow such as illustrated in FIG. 31. Note that another embodiment is obtained by transforming the above-described embodiment, and a rough flow is the same as that of the above described embodiment. With an embodiment, a link table and an insertion table such as described above are not employed, and a tag representing change, addition, or insertion is added to the public hash values.

Such as illustrated in FIG. 31, with an embodiment, for example, in the event that a block m₆ has been inserted in the third position of a content, the hash value corresponding to the insertion block m₆ is calculated to generate public hash values including the identifier of a modifier, an insertion position number, a tag “insert” representing insertion (hereafter, also abbreviated as ins), and the hash value thereof. Subsequently, a digital signature σ₁ as to the public hash values is generated.

Subsequently, with the verification phase, an insertion block is verified using the public hash values, and also the digital signature σ₁ is verified. Subsequently, in the event that the verification has succeeded, the hash value h₆ as to the insertion block is removed. Subsequently, the hash values from which the hash value as to the insertion block has been removed, and the hash values generated at the signature phase are used to verify blocks other than the insertion block, and also the digital signature σ₀ is verified. Thus, the insertion block is assured to have been inserted by the modifier, and each block other than the insertion block is assured to have been processed from the original content. Also, a tag representing insertion is included in the public hash values, and thus, no link table has to be generated, and accordingly, the data amount may be reduced as compared to the case of an embodiment. Hereafter, another embodiment will be described in detail.

The system configuration according to an embodiment is the same as the system configuration illustrated in FIG. 10. Also, the configuration of a signer terminal 3 according to an embodiment is the same as the block diagram illustrated in FIG. 11 and FIG. 12.

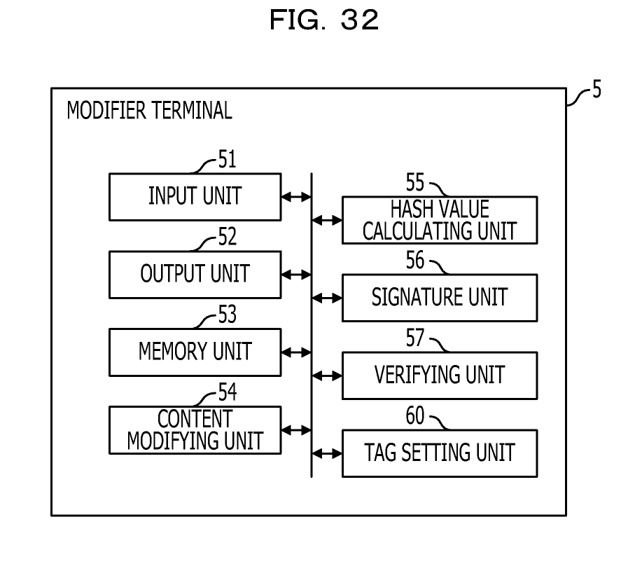

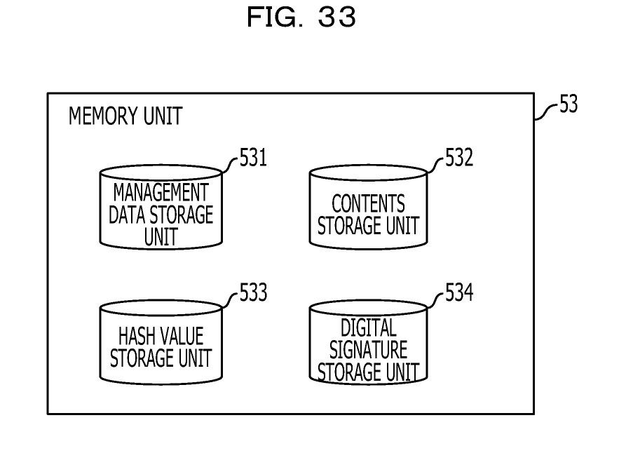

FIG. 32 illustrates a functional block diagram of a modifier terminal 5 according to an embodiment. The modifier terminal 5 according to an embodiment includes an input unit 51, an output unit 52, a memory unit 53, a content modifying unit 54, a hash value calculating unit 55, a signature unit 56, a verifying unit 57, and a tag setting unit 60. Note that the input unit 51, output unit 52, memory unit 53, content modifying unit 54, hash value calculating unit 55, signature unit 56, and verifying unit 57 are basically the same as those of the above described embodiment, but with another embodiment, the memory unit 53 includes various types of storage units such as illustrated in FIG. 33. Specifically, the memory unit 53 includes a management data storage unit 531, a contents storage unit 532, a hash value storage unit 533, and a digital signature storage unit 534. Note that the management data storage unit 531, contents storage unit 532, hash value storage unit 533, and digital signature storage unit 534 are basically the same as those of the above described embodiment.

With an embodiment, the tag setting unit 60 selects a tag according to an operation type, and outputs this to the hash value calculating unit 55. Subsequently, the hash value calculating unit 55 generates public hash values including the tag from the tag setting unit 60, and stores this in the hash value storage unit 533.

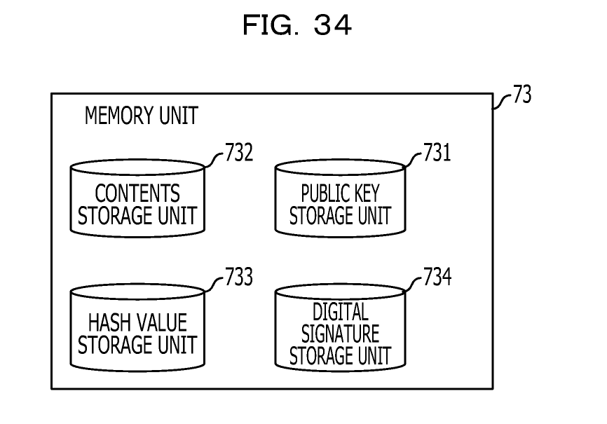

Also, the configuration of the verifier terminal 7 according to an embodiment is basically the same as that illustrated in FIG. 15, but with another embodiment, the memory unit 73 includes various types of storage units such as illustrated in FIG. 34. Specifically, the memory unit 73 includes a public key storage unit 731, a contents storage unit 732, a hash value storage unit 733, and a digital signature storage unit 734. Note that the public key storage unit 731, contents storage unit 732, hash value storage unit 733, and digital signature storage unit 734 are the same as those of the above-described embodiment.

Next, description will be made regarding the processing of the modifier terminal 5 and verifier terminal 7 according to an embodiment. Note that the processing of the signer terminal 3 is the same as that of the above described embodiment, and accordingly, description thereof will be omitted.

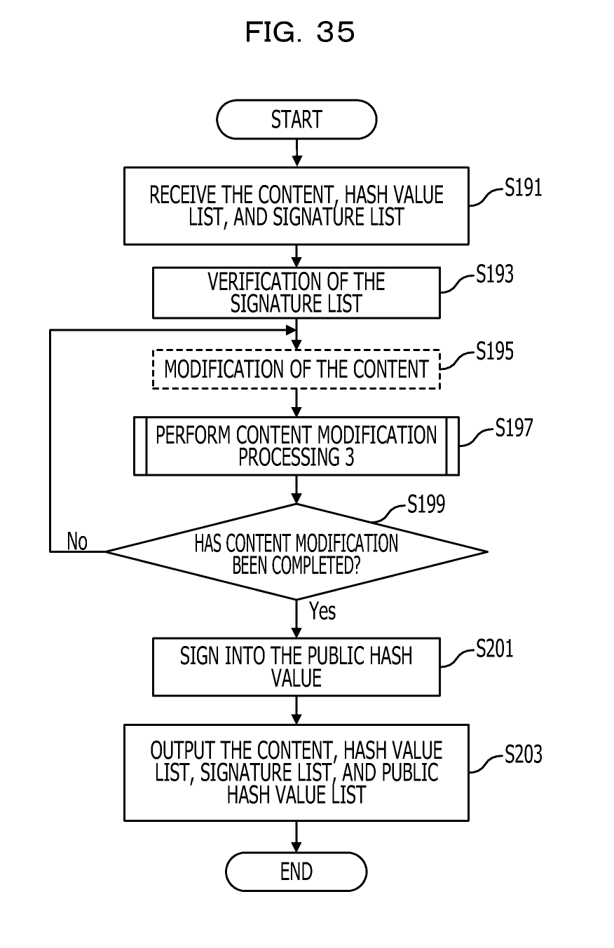

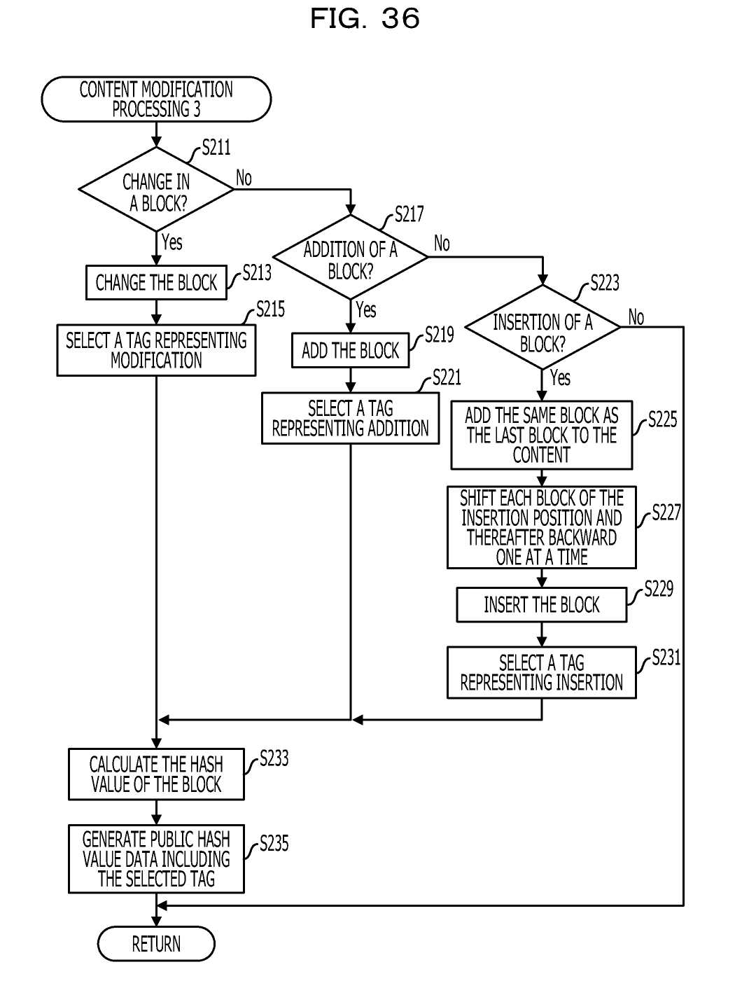

First, the processing of the modifier terminal 5 according to an embodiment will be described with reference to FIG. 35 and FIG. 36. Here, description will be made regarding a case of the first modifier. First, the input unit 51 receives a content, hash value list H₀, and signature list Σ from the signer terminal 3 (S191 in FIG. 35). Subsequently, the input unit 51 stores the received content in the contents storage unit 532, stores the hash value list H₀ in the hash value storage unit 533, and stores the signature list Σ in the digital signature storage unit 534. Subsequently, the input unit 51 outputs a digital signature verification request to the verifying unit 57.

Subsequently, upon receiving the verification request from the input unit 51, the verifying unit 57 reads out the signature list Σ from the digital signature storage unit 534, and executes the verification processing of the digital signature σ₀ of the signer included in the signature list Σ (S193). For example, the verifying unit 57 calculates a hash value as to each block included in the content, and uses these hash values and the public key of a signer to verify the digital signature σ₀. Note that the processing itself for verifying the signature is the same with the related art, and accordingly, description thereof will be omitted.

Subsequently, the modifier operates the modifier terminal 5 to modify the content by performing change, addition, or insertion of a block (S195). Note that the present processing is the operation of the modifier, and accordingly, which is illustrated with a dotted line block in FIG. 35. Subsequently, the input unit 51 accepts input of a change block, additional block, or insertion block, and outputs a content updating request to the contents modifying unit 54. Note that the content updating request includes the data of an input block, operation type, block number, and so forth.

Subsequently, upon receiving the content updating request from the input unit 51, the contents modifying unit 54 executes content modification processing 3 in cooperation with the memory unit 53, hash value calculating unit 55, and tag setting unit 60 (S197). The content modification processing 3 will be described with reference to FIG. 36.

First, the contents modifying unit 54 determines whether or not the operation type is change in a block (S211 in FIG. 36). In the event that the operation type is change in a block (Yes route in S211), the contents modifying unit 54 updates the content stored in the contents storage unit 532 by changing a block (S213). Specifically, the contents modifying unit 54 changes the block of a block number included in the content updating request to the content of the change block.

Subsequently, the tag setting unit 60 selects a tag “change” representing change in a block (S215), and outputs the selected tag information to the hash value calculating unit 55. Subsequently, the flow proceeds to processing in S233.

On the other hand, in the event that the operation type is not change in a block (No route in S211), the contents modifying unit 54 determines whether or not the operation type is addition of a block (S217). In the event that the operation type is addition of a block (Yes route in S217), the contents modifying unit 54 updates the content stored in the contents storage unit 532 by adding an additional block to the end of the content (S219).

Subsequently, the tag setting unit 60 selects a tag “append” representing addition of a block (S221), and outputs the selected tag information to the hash value calculating unit 55. Subsequently, the flow proceeds to processing in S233.

On the other hand, in the event that the operation type is not addition of a block (No route in S217), the contents modifying unit 54 determines whether or not the operation type is insertion of a block (S223). In the event that the operation type is insertion of a block (Yes route in S223), the contents modifying unit 54 adds the same block as the final block to the end of the content (S225). Subsequently, the contents modifying unit 54 shifts each block of the insertion position and thereafter backward one at a time (S227). Subsequently, the contents modifying unit 54 inserts the block into the insertion position (S229). Note that the processing in S225 through S229 is the same processing as that of the above described embodiment, and accordingly, detailed description will be omitted.

Subsequently, the tag setting unit 60 selects a tag “insert” representing insertion of a block (S231), and outputs the selected tag information to the hash value calculating unit 55. Subsequently, the flow proceeds to processing in S233.

On the other hand, in the event that determination is made in S223 that the operation type is not insertion of a block (No route in S223), the flow skips the subsequent processing to end the present processing. Subsequently, the flow returns to the original processing.

Subsequently, upon receiving the tag information from the tag setting unit 60, the hash value calculating unit 55 calculates the hash value of the changed, added, or inserted block (S233). Subsequently, the hash value calculating unit 55 generates public hash values v including the identifier of the modifier stored in the management data storage unit 531, block number, and the calculated hash value, and stores these in the hash value storage unit 533 (S235). Now, with an embodiment, let us say that the identifier of the modifier is k, the block number is i, the hash value is hₙ₊₁, and the number of blocks before insertion is n, which are represented with v=(k, i, TAG, hₙ₊₁). TAG indicates one of change, append, and insert. Subsequently, the present processing ends, the flow returns to the original processing.

Description will return to FIG. 35, after the content modification processing 3 (S197) is executed, the input unit 51 determines whether or not modification of the content has been completed (S199). For example, in the event of having accepted the next operation (change, addition, or insertion of a block) from the modifier, determination is made that modification of the content has not been completed (No route in S199), the flow returns to the processing in S195, where the above described processing is repeated.

On the other hand, in the event that modification completion has been instructed from the modifier, determination is made that modification of the content has been completed (Yes route in S199), and the flow proceeds to processing in S201. At this time, the input unit 51 outputs a signature request including specification of the public hash values Vₖ serving as a signature object to the signature unit 56.

Subsequently, upon receiving the signature request from the input unit 51, the signature unit 56 reads out the private key of the modifier k from the management data storage unit 531, and reads out the public hash values Vₖ from the hash value storage unit 533. Subsequently, the signature unit 56 uses the private key of the modifier k to generate a digital signature σₖ as to the readout public hash values Vₖ (S201). Subsequently, the signature unit 56 adds the generated digital signature σₖ to the signature list Σ of the digital signature storage unit 534. For example, in FIG. 31, a digital signature σ₁ is generated, and the signature list Σ is updated to the digital signature list Σ={σ₀, σ₁}.

Subsequently, the output unit 52 reads out the inserted content from the contents storage unit 532, reads out the hash value list H₀ and the public hash values Vₖ from the hash value storage unit 533, and reads out the signature list Σ from the digital signature storage unit 534. Subsequently, the output unit 52 adds the public hash values Vₖ to the public hash value list V. In the event of the first modifier, the public hash value list V becomes V={Vₖ}. Subsequently, the output unit 52 outputs the inserted content, hash value list H₀, signature list Σ, and public hash value list V to another modifier terminal 5 or the modifier terminal 7 (S203). Subsequently, the present processing ends.

Note that description has been made above regarding a case of the first modifier, but basic processing is the same regarding a case of the second modifier and thereafter. However, in the case of the second modifier and thereafter, in S191 the input unit 51 receives the inserted content, hash value list H₀, signature list Σ, and public hash value list V from the modifier terminal 5 which the former modifier operates. In this case, an arrangement should be made wherein the input unit 51 stores the inserted content in the contents storage unit 532, stores the hash value list H₀ and the public hash value list V in the hash value storage unit 533, and stores the signature list Σ in the digital signature storage unit 534.

According to execution of the above processing, public hash values including a tag representing change, addition, or insertion of a block may be generated.

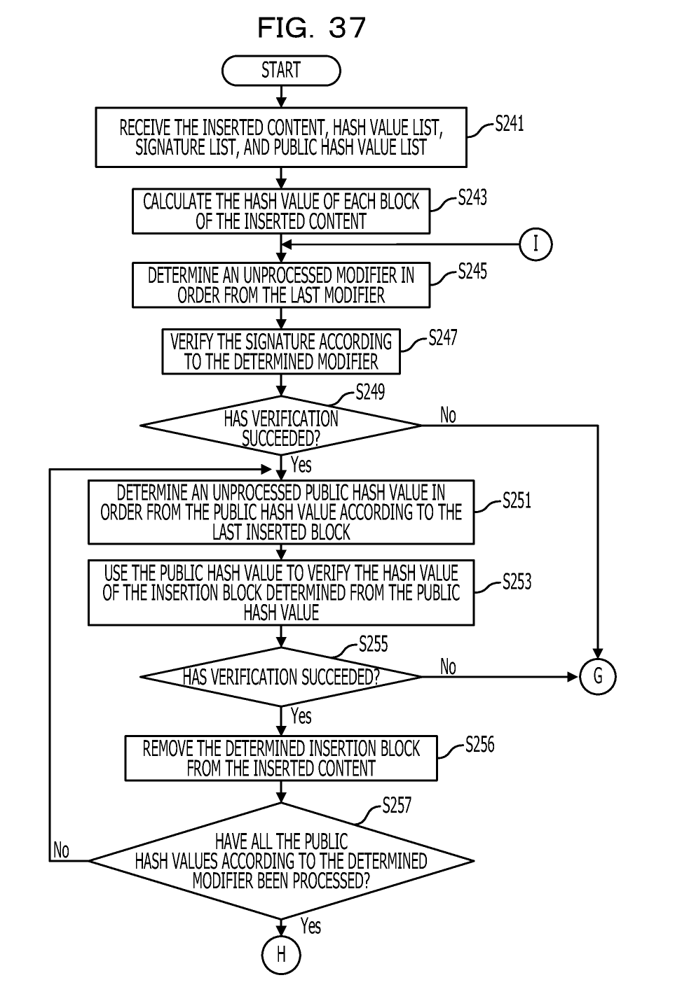

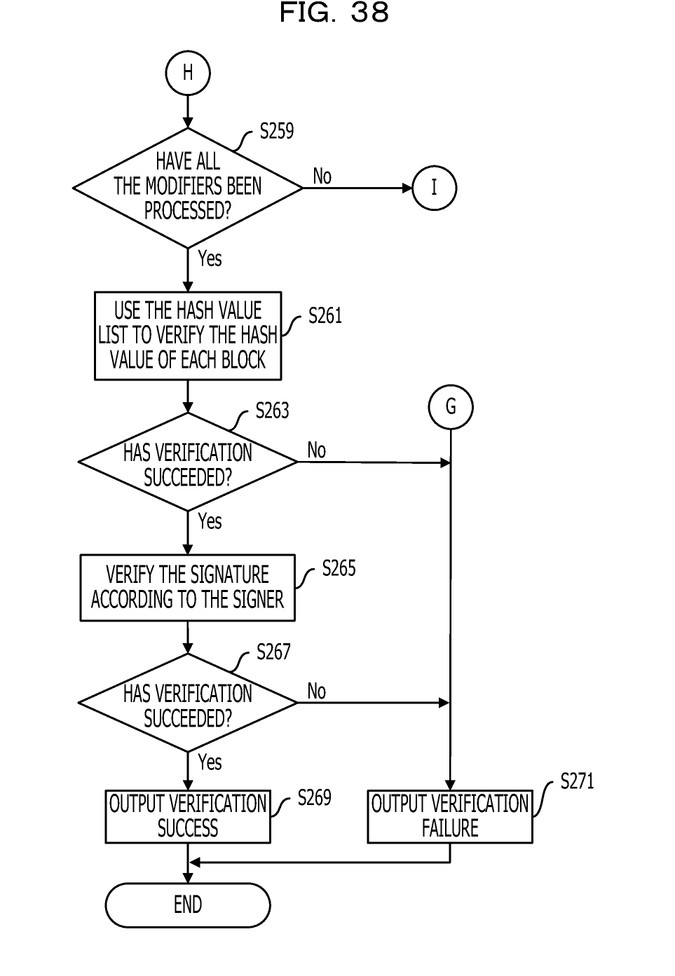

Next, processing of the verifier terminal 7 according to an embodiment will be described with reference to FIG. 37 and FIG. 38. Here, description will be made regarding processing in the event of verifying the inserted content. First, the input unit 71 receives the inserted content, hash value list H₀, signature list Σ, and public hash value list V from the modifier terminal 5 (S241 in FIG. 37). Subsequently, the input unit 71 stores the received inserted content in the contents storage unit 732, stores the hash value list H₀ and the public hash value list V in the hash value storage unit 733, and stores the signature list Σ in the digital signature storage unit 734. Subsequently, the input unit 71 outputs a hash value calculation request to the hash value calculating unit 74. Note that the hash value calculation request includes the file name of the inserted content, and so forth.

Subsequently, upon receiving the hash value calculation request from the input unit 71, the hash value calculating unit 74 reads out the inserted content according to the hash value calculation request from the contents storage unit 732. Subsequently, the hash value calculating unit 74 calculates a hash value as to each block included in the readout inserted content, and stores this in the hash value storage unit 733 (S243). For example, in FIG. 31, the hash values h₁, h₂, h₆, h₃, h₄, and h₅ are calculated. Also, the hash value calculating unit 74 outputs a verification request to the signature verifying unit 76.

Subsequently, upon receiving the verification request from the hash value calculating unit 74, the signature verifying unit 76 determines an unprocessed modifier k in order from the last modifier (S245). Subsequently, the signature verifying unit 76 reads out data according to the determined modifier k from the public key storage unit 731, hash value storage unit 733, and digital signature storage unit 734. That is to say, the signature verifying unit 76 reads out the public key of the modifier k from the public key storage unit 731, reads out the public hash values Vₖ from the hash value storage unit 733, and reads out the digital signature σₖ from the digital signature storage unit 734. Subsequently, the signature verifying unit 76 uses the public key and public hash values Vₖ to execute verification processing of the digital signature σₖ (S247). Note that the verification processing of the digital signature is the same as with the related art, and accordingly, description thereof will be omitted.

Subsequently, in the event that the signature verifying unit 76 has failed in verification in S247 (No route in S249), the flow proceeds to processing in S271 (FIG. 38) through a terminal G.

On the other hand, in the event that the signature verifying unit 76 has succeeded in verification in S247 (Yes route in S249), the signature verifying unit 76 instructs the hash value verifying unit 75 to verify the public hash values. At this time, the signature verifying unit 76 notifies the hash value verifying unit 75 of the public hash values Vₖ along with the instruction. Note that success in verification in S247 means that the public hash values Vₖ are proved wherein the modifier k is a creator, and further neither falsification nor tampering has been subjected thereto.

Subsequently, the hash value verifying unit 75 receives the public hash values Vₖ along with the instruction from the signature verifying unit 76. Subsequently, the hash value verifying unit 75 determines unprocessed public hash values v in the order from the public hash values v of the last inserted block of the public hash values Vₖ (S251). Note that the public hash values Vₖ include the public hash values v of which the number is equivalent to the number of blocks inserted by the modifier k. The public hash values v are arrayed in the insertion order, and accordingly, with the present processing, the public hash values v including the tag “insert” representing insertion are determined in the backward order.

Subsequently, the hash value verifying unit 75 uses the determined public hash values to execute the verification processing of a hash value as to the determined insertion block (S253). Here, the validity of the insertion block thereof is confirmed by verifying the hash value as to the insertion block. Note that the present processing is the same processing as the above described embodiment.

Subsequently, in the event that the hash value verifying unit 75 has failed in verification in S253 (No route in S255), i.e., in the event that the hash values are unmatched, the flow proceeds to processing in S271 (FIG. 38) through the terminal G.

On the other hand, in the event that the hash value verifying unit 75 has succeeded in verification in S253 (Yes route in S255), the flow proceeds to processing in S256. Note that success in verification in S253 means that the validity of the insertion block has been confirmed.

Subsequently, the hash value verifying unit 75 removes the insertion block from the inserted content (S256). Note that the present processing is the same as the processing of an embodiment.

Subsequently, the hash value verifying unit 75 determines whether or not the processing has been completed regarding all of the public hash values v according to the insertion block inserted by the determined modifier k (S257). In the event that the processing has not been completed regarding all of the public hash values v according to the insertion block inserted by the determined modifier k (No route in S257), the flow returns to the processing in S251 to repeat the above processing.

On the other hand, in the event that the processing has been completed regarding all of the public hash values v according to the insertion block inserted by the determined modifier k (Yes route in S257), the hash value verifying unit 75 notifies the signature verifying unit 76 of that the processing regarding the determined modifier k has been completed. Subsequently, the processing proceeds to S250 (FIG. 38) through a terminal H.

Description will proceed to FIG. 38, where after the terminal H, upon receiving a completion notice from the hash value verifying unit 75, the signature verifying unit 76 determines whether or not the processing has been completed regarding all of the modifiers (S259 in FIG. 38). In the event that the processing has not been completed regarding all of the modifiers (No route in S259), the processing returns to S245 through a terminal I, where the above processing is repeated. That is to say, processing such as described above is repeated in order from the last modifier to the modifier who has performed content modification first.

On the other hand, in the event that the processing has been completed regarding all of the modifiers (Yes route in S259), the signature verifying unit 76 instructs the hash value verifying unit 75 to verify each block other than the insertion block.

Subsequently, upon receiving the instruction from the signature verifying unit 76, the hash value verifying unit 75 uses the hash value list H₀ stored in the hash value storage unit 733 to execute the verification processing of the hash value as to each block other than the insertion block (S261). Here, the validity of each block other than the insertion block is confirmed by performing verification of the hash value as to each block other than the insertion block. Note that the insertion block is removed in S256, and accordingly, completion of the processing regarding all of the modifiers assumes that all of the insertion blocks have been removed, and the inserted content has returned to the original content state. Accordingly, a hash value corresponding to a remaining block, and a hash value included in the hash value list H₀ are compared, and in the event that the hash values are matched, determination is made that the verification has succeeded.

Subsequently, in the event that verification in S261 has succeeded (Yes route in S263), the hash value verifying unit 75 notifies the signature verifying unit 76 of that the verification has been completed. Note that success in verification in S261 means that the validity of each block other than the insertion block has been confirmed. Subsequently, the processing proceeds to S265.

Subsequently, upon receiving completion notice from the hash value verifying unit 75, the signature verifying unit 76 reads out the public key of the signer from the public key storage unit 731, reads out the hash value list H₀ from the hash value storage unit 733, and reads out the signature list Σ from the digital signature storage unit 734. Subsequently, the signature verifying unit 76 uses the public key of the signer, and the hash value list H₀ to carry out verification processing of the digital signature σ₀ according to the signer included in the signature list Σ (S265). Note that the verification processing of the digital signature is the same as with the related art, and accordingly, description thereof will be omitted.

Subsequently, in the event that the verification in S265 has succeeded (Yes route in S267), success in verification is notified to the output unit 72. Subsequently, the output unit 72 outputs success in verification to the display device or the like (S269). Subsequently, the processing ends.

On the other hand, in the event that the verification in S261 has failed (No route in S263), in the event that the verification in S265 has failed (No route in S267), or after the terminal G, the output unit 72 outputs failure in verification to the display device or the like (S271). Note that which verification has failed may be displayed together. Subsequently, the processing ends.

Such as described above, SCCS-type PIAT is transshaped, whereby partial integrity assurance at the time of block insertion may be realized with data amount smaller than that of the above described embodiment.

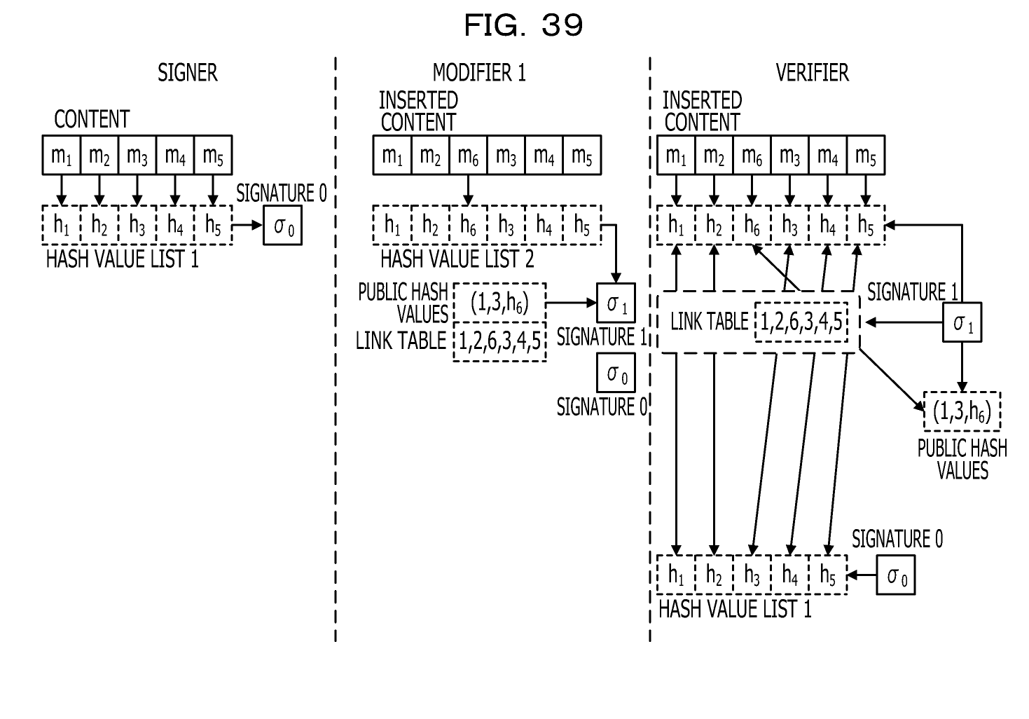

Next, another embodiment will be described. The above-described embodiments relate to SCCS-type PIAT, but the RCS-type PIAT may be transformed in the same way. An embodiment is obtained by changing the RCS-type PIAT to a method employing the link table described in the above described embodiment. With an embodiment, partial integrity assurance at the time of block insertion is realized with a flow such as illustrated in FIG. 39.

Such as illustrated in FIG. 39, with the above-described embodiment, at the modification phase, a hash value as to each block included in a content is calculated to generate a hash value list 1. Subsequently, for example, in the event that a block m₆ has been inserted in the third position of the content, the hash value corresponding to the insertion block m₆ is calculated, and the hash value thereof is inserted into the hash value list thereof to generate a hash value list 2. Also, the public hash values including the identifier of a modifier, an insertion position number, and the hash value thereof are generated, and further a link table is generated. Subsequently, a digital signature σ₁ as to the hash value list 2, public hash values, and link table is generated.

Subsequently, with the verification phase, first, a hash value as to each block included in the inserted content is calculated. Subsequently, the calculated hash values, public hash values, and link table are used to verify the insertion block, and also the digital signature σ₁ is verified. Also, of the calculated hash values, hash values as to blocks other than the insertion block (h₁ through h₅ in FIG. 39) are used to verify the digital signature σ₀. Thus, the insertion block is assured to have been inserted by the modifier, and each block other than the insertion block is assured to have been succeeded from the original content. Note that the insertion block may be determined from the link table, and accordingly, the data of the public hash values does not have to be generated regarding blocks other than the insertion block, the data amount of the public hash values may be reduced as compared to the conventional RCS-type PIAT. Hereafter, an embodiment will be described in detail.

The system configuration according to an embodiment is the same as the system configuration illustrated in FIG. 10. Also, the configurations of a signer terminal 3, modifier terminals 5, and verifier terminal 7 according to an embodiment are basically the same as those of the above-described embodiment.

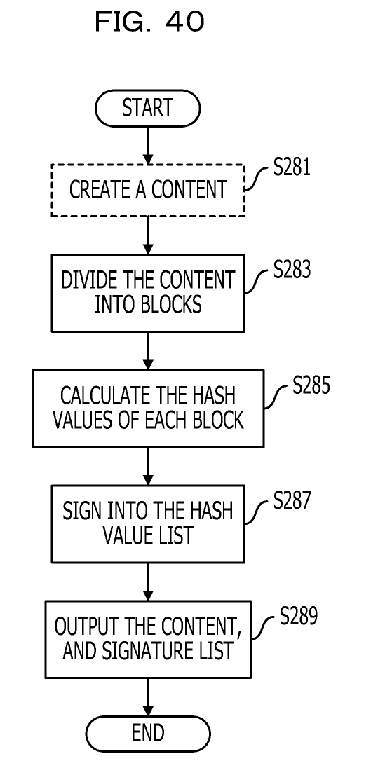

First, the processing of the signer terminal 3 according to an embodiment will be described with reference to FIG. 40. First, a signer operates the signer terminal 3 to create a content such as a document, moving image, still image, music, or the like (S281 in FIG. 40). Note that the present processing, which is the operation of the signer, is illustrated with a dotted-line block in FIG. 40. Subsequently, the input unit 31 accepts an operation for content creation from the signer, and stores the content created by the signer in the contents storage unit 332. Subsequently, the input unit 31 outputs a content dividing request to the dividing unit 34. Note that the dividing request includes the file name of the created content, and so forth.

Subsequently, upon receiving the dividing request from the input unit 31, the dividing unit 34 divides the content stored in the contents storage unit 332 into n blocks (S283). For example, in FIG. 39, the content is divided into five blocks from a block m₁ to a block m₅. Subsequently, the dividing unit 34 outputs a hash value calculation request to the hash value calculating unit 35. Note that the hash value calculation request includes the file name of the content, and so forth.

Subsequently, upon receiving the hash value calculation request from the dividing unit 34, the hash value calculating unit 35 reads out a content relating to the hash value calculation request from the contents storage unit 332. Subsequently, the hash value calculating unit 35 calculates a hash value as to each of the n blocks included in the read content to generate a hash value list H₀ including the n calculated hash values (S285). Note that the hash value list H₀ is stored in the hash value storage unit 333. For example, in FIG. 39, five hash values from a hash value h₁ to a hash value h₅ are calculated, and the hash value list H₀ including these five hash values is generated. Subsequently, the hash value calculating unit 35 outputs a signature request including specification of the hash value list H₀ serving as a signature object to the signature unit 36.

Subsequently, upon receiving the signature request from the hash value calculating unit 35, the signature unit 36 reads out the private key of the signature from the management data storage unit 331, and further reads out the hash value list H₀ relating to the signature request from the hash value storage unit 333. Subsequently, the signature unit 36 uses the private key to generate a digital signature σ₀ as to the hash value list H₀ (S287). At this time, the signature unit 36 stores the digital signature σ₀ in the digital signature storage unit 334 as the signature list Σ={σ₀}.

Subsequently, the output unit 32 reads out the content stored in the contents storage unit 332, and the signature list Σ stored in the digital signature storage unit 334, and outputs these to the modifier terminal 5 (S289). Subsequently, the processing ends.

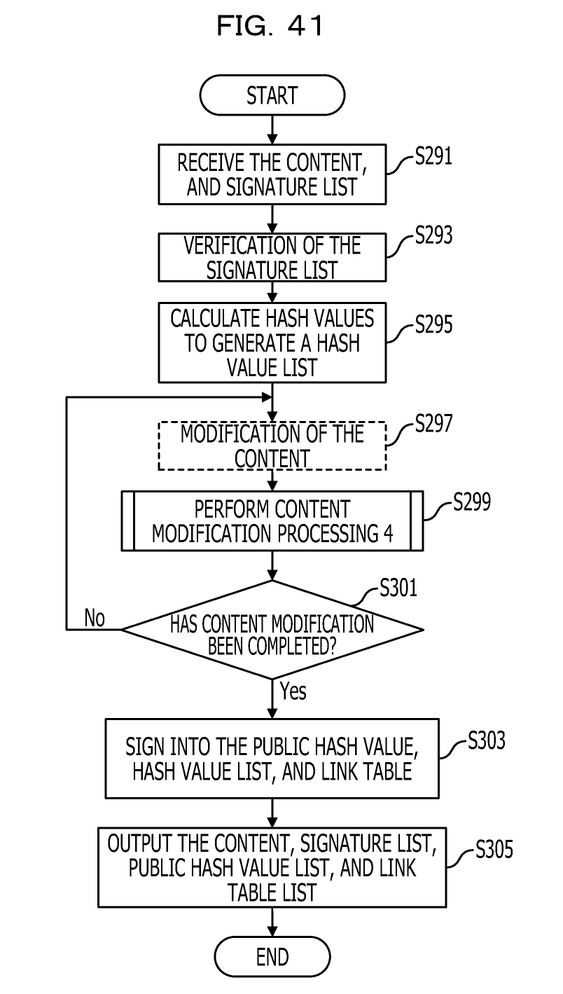

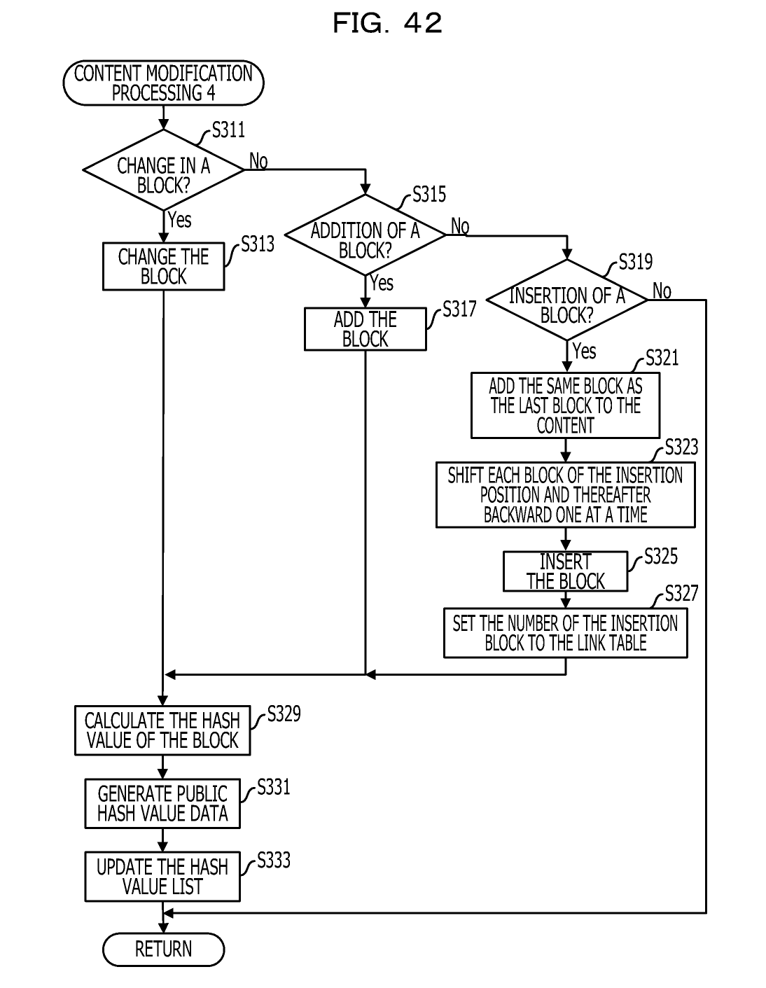

Next, the processing of the modifier terminal 5 according to an embodiment will be described with reference to FIG. 41 and FIG. 42. Here, description will be made regarding a case of the first modifier. First, the input unit 51 receives the content and the signature list Σ from the signer terminal 3 (S291 in FIG. 41). Subsequently, the input unit 51 stores the received content in the contents storage unit 532, and stores the signature list Σ in the digital signature storage unit 534. Subsequently, the input unit 51 outputs a digital signature verification request to the verifying unit 57, and outputs a hash value calculation request to the hash value calculating unit 55.

Subsequently, upon receiving the verification request from the input unit 51, the verifying unit 57 reads out the signature list Σ from the digital signature storage unit 534, and executes the verification processing of the digital signature σ₀ of the signer included in the signature list Σ (S293). Note that the processing itself for verifying the signature is the same with the related art, and accordingly, description thereof will be omitted.

Also, upon receiving the hash value calculation request from the input unit 51, the hash value calculating unit 55 reads the contents out from the contents storage unit 532. The hash value calculating unit 55 then calculates a hash value as to each block included in the content to generate a hash value list Hₖ including the calculated hash values (S295). Note that the hash value list Hₖ is stored in the hash value storage unit 533.

Subsequently, the modifier operates the modifier terminal 5 to modify the content by performing change, addition, or insertion of a block (S297). Note that the present processing is the operation of the modifier, and accordingly, which is illustrated with a dotted line block in FIG. 41. Subsequently, the input unit 51 accepts input of a change block, additional block, or insertion block, and outputs a content updating request to the contents modifying unit 54. Note that the content updating request includes the data of an input block, operation type, block number, and so forth.

Subsequently, upon receiving the content updating request from the input unit 51, the contents modifying unit 54 executes content modification processing 4 in cooperation with the memory unit 53, hash value calculating unit 55, and link table generating unit 58 (S299). The content modification processing 4 will be described with reference to FIG. 42.

First, the contents modifying unit 54 determines whether or not the operation type is change in a block (S311 in FIG. 42). In the event that the operation type is change in a block (Yes route in S311), the contents modifying unit 54 updates the content stored in the contents storage unit 532 by changing a block (S313). Specifically, the contents modifying unit 54 changes the block of a block number included in the content updating request to the content of the change block. Subsequently, the flow proceeds to processing in S329.

On the other hand, in the event that the operation type is not change in a block (No route in S311), the contents modifying unit 54 determines whether or not the operation type is addition of a block (S315). In the event that the operation type is addition of a block (Yes route in S315), the contents modifying unit 54 updates the content stored in the contents storage unit 532 by adding an additional block to the end of the content (S317). Subsequently, the flow proceeds to processing in S329.

On the other hand, in the event that the operation type is not addition of a block (No route in S315), the contents modifying unit 54 determines whether or not the operation type is insertion of a block (S319). In the event that the operation type is insertion of a block (Yes route in S319), the contents modifying unit 54 adds the same block as the final block to the end of the content (S321). Subsequently, the contents modifying unit 54 shifts each block of the insertion position and thereafter backward one at a time (S323). Subsequently, the contents modifying unit 54 inserts the block into the insertion position (S325). Note that the processing in S321 through S325 is the same processing as that of an embodiment, and accordingly, detailed description will be omitted. Subsequently, the contents modifying unit 54 notifies the link table generating unit 58 of the insertion position number of the block.

Subsequently, upon receiving the insertion position number from the contents modifying unit 54, the link table generating unit 58 sets the number of the insertion block to the link table Lₖ of the link table storage unit 535 (S327). Note that the present processing is the same processing as an embodiment, and accordingly, detailed description will be omitted. Subsequently, the flow proceeds to processing in S329.

On the other hand, in the event that determination is made in S319 that the operation type is not insertion of a block (No route in S319), the flow skips the subsequent processing to end the present processing. Subsequently, the flow returns to the original processing.

Subsequently, the hash value calculating unit 55 calculates the hash value of the block changed, added, or inserted (S329). Note that the position of the block serving as a calculation object is notified to the contents modifying unit 54. For example, in FIG. 39, the hash value h₆ as to the block m₆ inserted into the third position from the top is calculated.

Subsequently, the hash value calculating unit 55 generates the public hash values v including the identifier of the modifier stored in the management data storage unit 531, block number, and calculated hash value, and stores these in the hash value storage unit 533 (S331).

Also, the hash value calculating unit 55 uses the hash value calculated in S329 to update the hash value list Hₖ stored in the hash value storage unit 533 (S333). For example, in the event that the operation type is insertion of a block, the hash value calculating unit 55 inserts the hash value into the hash value list Hₖ. For example, in FIG. 39, the hash value h₆ is inserted into the third position, the hash value list Hₖ becomes the hash value list Hₖ={h₁, h₂, h₆, h₃, h₄, h₅}. Subsequently, the present processing ends, and the flow returns to the original processing.

Description will return to FIG. 41, after the content modification processing 4 (S299) is executed, the input unit 51 determines whether or not modification of the content has been completed (S301). For example, in the event of having accepted the next operation (change, addition, or insertion of a block) from the modifier, determination is made that modification of the content has not been completed (No route in S301), the flow returns to the processing in S297, where the above described processing is repeated.

On the other hand, in the event that modification completion has been instructed from the modifier, determination is made that modification of the content has been completed (Yes route in S301), and the flow proceeds to processing in S303. At this time, the input unit 51 outputs a signature request including specification of the hash value list Hₖ, public hash values Vₖ, and link table Lₖ, serving as a signature object to the signature unit 56.

Subsequently, upon receiving the signature request from the input unit 51, the signature unit 56 reads out the private key of the modifier k from the management data storage unit 531, reads out hash value list Hₖ and public hash values Vₖ from the hash value storage unit 533, and reads out link table Lₖ from the link table storage unit 535. Subsequently, the signature unit 56 uses the private key of the modifier k to generate a digital signature σₖ as to the readout hash value list Hₖ, public hash values Vₖ, and link table Lₖ (S303). Subsequently, the signature unit 56 adds the generated digital signature σₖ to the signature list Σ of the digital signature storage unit 534. For example, in FIG. 39, a digital signature σ₁ is generated, and the signature list Σ is updated to the digital signature list Σ={σ₀, σ₁}.

Subsequently, the output unit 52 reads out the inserted content from the contents storage unit 532, reads out the public hash values Vₖ from the hash value storage unit 533, reads out the signature list Σ from the digital signature storage unit 534, and reads out the link table Lₖ from the link table storage unit 535. Subsequently, the output unit 52 adds the public hash values Vₖ to the public hash value list V, and adds the link table Lₖ to the link table list L. Subsequently, the output unit 52 outputs the inserted content, signature list Σ, public hash value list V, and link table list L to another modifier terminal 5 or the modifier terminal 7 (S305). Subsequently, the present processing ends.

Note that description has been made above regarding a case of the first modifier, but basic processing is the same regarding a case of the second modifier and thereafter. However, in the case of the second modifier and thereafter, in S291 the input unit 51 receives the inserted content, signature list Σ, public hash value list V, and link table L from the modifier terminal 5 which the former modifier operates. In this case, an arrangement should be made wherein the input unit 51 stores the inserted content in the contents storage unit 532, stores the public hash value list V in the hash value storage unit 533, stores the signature list Σ in the digital signature storage unit 534, and stores the link table list L in the link table storage unit 535.

Also, in S305 the output unit 52 should add the public hash values Vₖ to the received public hash value list V. Further, the output unit 52 should add the link table Lₖ to the received link table list L.

According to execution of the above processing, even in the case of the RCS-type PIAT, a link table may be generated.

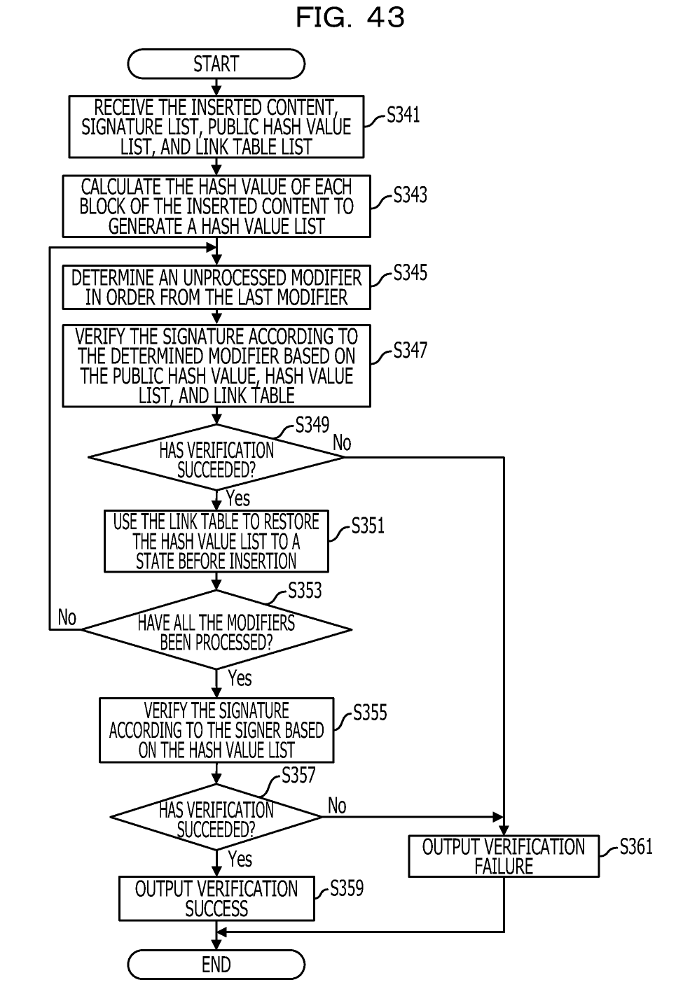

Next, processing of the verifier terminal 7 according to an embodiment will be described with reference to FIG. 43. Here, description will be made regarding processing in the event of verifying the inserted content. First, the input unit 71 receives the inserted content, signature list Σ, public hash value list V, and link table list L from the modifier terminal 5 (S341 in FIG. 43). Subsequently, the input unit 71 stores the received inserted content in the contents storage unit 732, stores the public hash value list V in the hash value storage unit 733, stores the signature list Σ in the digital signature storage unit 734, and stores the link table list L in the link table storage unit 735. Subsequently, the input unit 71 outputs a hash value calculation request to the hash value calculating unit 74. Note that the hash value calculation request includes the file name of the inserted content, and so forth.

Subsequently, upon receiving the hash value calculation request from the input unit 71, the hash value calculating unit 74 reads out the inserted content according to the hash value calculation request from the contents storage unit 732. Subsequently, the hash value calculating unit 74 calculates a hash value as to each block included in the readout inserted content to generate a hash value list H (S343). Note that the hash value list H is stored in the hash value storage unit 733. For example, in FIG. 39, the hash value list H={h₁, h₂, h₆, h₃, h₄, h₅} is generated. Subsequently, the hash value calculating unit 74 outputs a verification request to the signature verifying unit 76.

Subsequently, upon receiving the verification request from the hash value calculating unit 74, the signature verifying unit 76 determines an unprocessed modifier k in order from the last modifier (S345). Subsequently, the signature verifying unit 76 reads out data according to the determined modifier k from the public key storage unit 731, hash value storage unit 733, digital signature storage unit 734, and link table storage unit 735. That is to say, the signature verifying unit 76 reads out the public key of the modifier k from the public key storage unit 731, reads out the public hash values Vₖ from the hash value storage unit 733, reads out the digital signature σₖ according to the modifier k from the digital signature storage unit 734, and reads out the link table Lₖ from the link table storage unit 735. Also, the signature verifying unit 76 reads out the hash value list H generated in S343 from the hash value storage unit 533. Subsequently, the signature verifying unit 76 executes verification processing of the digital signature σₖ according to the modifier k based on the public key, hash value list H, public hash values Vₖ, and link table Lₖ (S347). Note that the verification processing of the digital signature is the same as with the related art, and accordingly, description thereof will be omitted.

Subsequently, in the event that the signature verifying unit 76 has succeeded in verification in S347 (Yes route in S349), the signature verifying unit 76 instructs the hash value verifying unit 75 to verify the hash value list H. At this time, the signature verifying unit 76 notifies the hash value verifying unit 75 of the public hash values Vₖ and link table Lₖ along with the instruction. Note that success in verification in S347 means that the validity of the insertion block inserted by the modifier k has been confirmed.

Subsequently, the hash value verifying unit 75 receives the public hash values Vₖ and link table Lₖ along with the instruction from the signature verifying unit 76. Subsequently, the hash value verifying unit 75 determines the number of insertion blocks inserted by the modifier k from the public hash values Vₖ. Subsequently, the hash value verifying unit 75 restores the hash value list H to a state before insertion by removing the hash values as to the insertion blocks from the hash value list H based on the link table Lₖ (S351). Note that, such as described in an embodiment, the hash value verifying unit 75 traces the numbers included in the link table Lₖ in the descending order of the numbers to determine insertion blocks. For example, in FIG. 39, the third hash value h₆ is removed, and the hash value list H becomes the hash value list H={h₁, h₂, h₃, h₄, h₅}. Subsequently, the hash value verifying unit 75 notifies the signature verifying unit 76 of that the processing regarding the determined modifier k has been completed.

Subsequently, upon receiving the completion notice from the hash value verifying unit 75, the signature verifying unit 76 determines whether or not the processing regarding all of the modifiers has been completed (S353). In the event that the processing regarding all of the modifiers has not been completed (No route in S353), the flow returns to S345, where the above processing is repeated. That is to say, processing such as described above is repeated in order from the last modifier to the modifier who has performed content modification first. Note that processing such as described above is executed regarding all of the modifiers, and thus, the hash values corresponding to all of the insertion blocks are removed from the hash value list H, and the hash value list H returns to the state of the original content.

On the other hand, in the event that the processing regarding all of the modifiers has been completed (Yes route in S353), the signature verifying unit 76 reads out the public key of the signer from the public key storage unit 731, and reads out a digital signature σ₀ according to the signer from the digital signature storage unit 734. Subsequently, the signature verifying unit 76 executes the verification processing of the digital signature σ₀ according to the signer based on the public key of the signer, and the restored hash value list H (S355). Note that the verification processing of the digital signature is the same as with the related art, and accordingly, description thereof will be omitted.

Subsequently, in the event that the signature verifying unit 76 has succeeded verification in S355 (Yes route in S357), the signature verifying unit 76 notifies the output unit 72 of that the verification has succeeded. Subsequently, the output unit 72 outputs success in verification to the display device or the like (S359). Subsequently, the processing ends.

Subsequently, in the event that the signature verifying unit 76 has failed in verification in S347 (No route in S349), or has failed in verification in S355 (No route in S357), the output unit 72 outputs failure in verification to the display device or the like (S361). Note that which verification has failed may be displayed together. Subsequently, the processing ends.

Such as described above, the RCS-type PIAT is transshaped, whereby partial integrity assurance even at the time of block insertion may be realized. That is to say, in the event that the verification has succeeded, the integrity of a content after insertion is proved, and also blocks other than the insertion block are assured to have been succeeded from the original content.

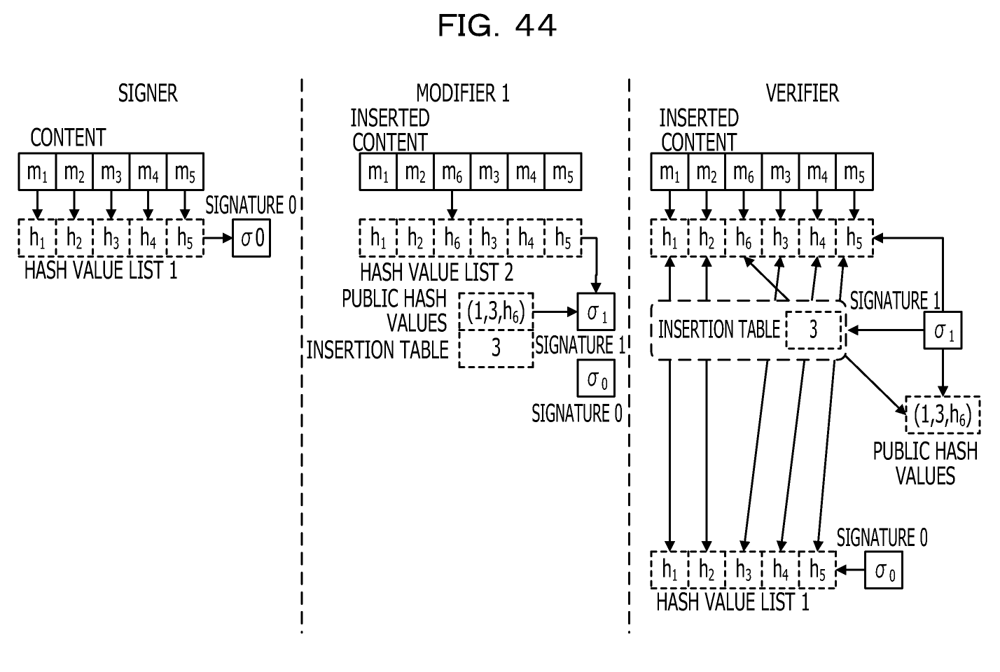

Next, another embodiment will be described. With an embodiment, partial integrity assurance at the time of block insertion is realized with a flow such as illustrated in FIG. 44. Note that another embodiment is an embodiment transshaped from an above described embodiment, and rough flow thereof is the same. With an embodiment, instead of the link table, the insertion table described in the above described embodiment is employed.

Such as illustrated in FIG. 44, with an embodiment, at the modification phase, a hash value as to each block included in a content is calculated to generate a hash value list 1. Subsequently, for example, in the event that a block m₆ has been inserted in the third position of the content, the hash value corresponding to the insertion block m₆ is calculated, and the hash value thereof is inserted into the hash value list thereof to generate a hash value list 2. Also, the public hash values including the identifier of a modifier, an insertion position number, and the hash value thereof are generated, and further an insertion table is generated. Subsequently, a digital signature σ₁ as to the hash value list 2, public hash values, and insertion table is generated.

Subsequently, with the verification phase, first, a hash value as to each block included in the inserted content is calculated. Subsequently, the calculated hash values, public hash values, and insertion table are used to verify the insertion block, and also the digital signature σ₁ is verified. Also, of the calculated hash values, hash values as to blocks other than the insertion block (h₁ through h₅ in FIG. 44) are used to verify the digital signature σ₀. Thus, the insertion block is assured to have been inserted by the modifier, and each block other than the insertion block is assured to have been succeeded from the original content. Also, the insertion table is data smaller than the link table, and accordingly, the data amount may be reduced as compared to the above described embodiment. Hereafter, an embodiment will be described in detail.

The system configuration according to an embodiment is the same as the system configuration illustrated in FIG. 10. Also, the configurations of a signer terminal 3, modifier terminals 5, and verifier terminal 7 according to an embodiment are basically the same as those of an embodiment.

The processing of the modifier terminal 5 and the verifier terminal 7 according to an embodiment will be described. Note that the processing of the signer terminal 3 is the same as that of the above described embodiment, and accordingly, description thereof will be omitted.

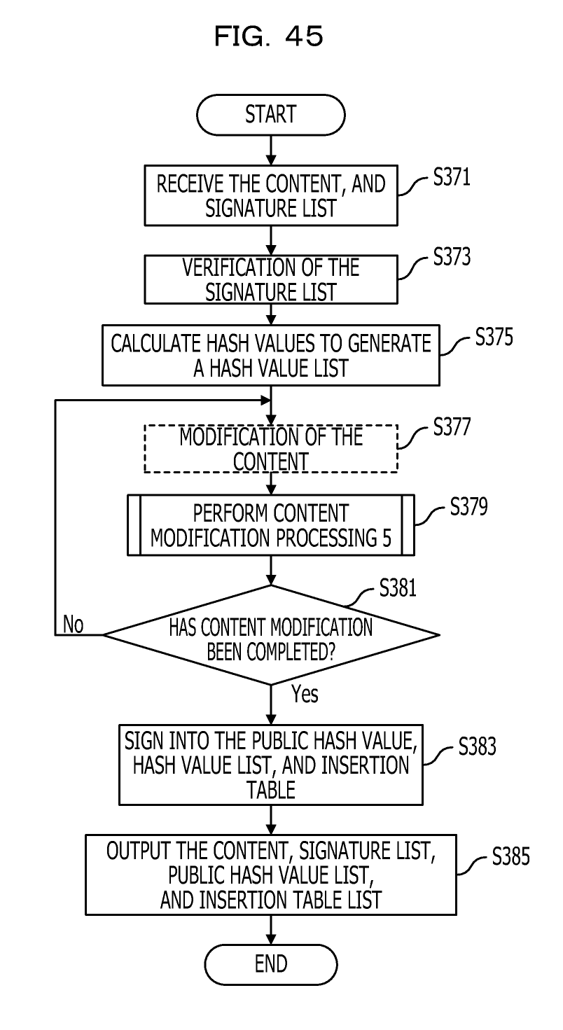

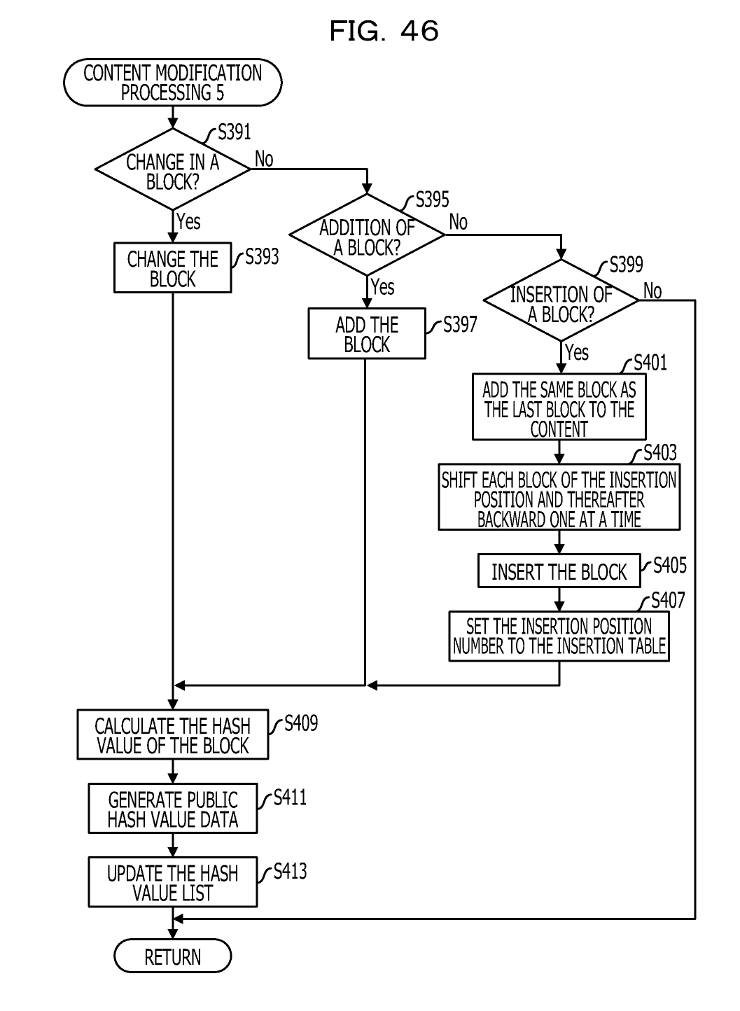

First, the processing of the modifier terminal 5 according to an embodiment will be described with reference to FIG. 45 and FIG. 46. Here, description will be made regarding a case of the first modifier. First, the input unit 51 receives a content and the signature list Σ from the signer terminal 3 (S371 in FIG. 45). Subsequently, the input unit 51 stores the received content in the contents storage unit 532, and stores the signature list Σ in the digital signature storage unit 534. Subsequently, the input unit 51 outputs a digital signature verification request to the verifying unit 57, and outputs a hash value calculation request to the hash value calculating unit 55.

Subsequently, upon receiving the verification request from the input unit 51, the verifying unit 57 reads out the signature list Σ from the digital signature storage unit 534, and executes the verification processing of the digital signature σ₀ of a signer included in the signature list Σ (S373). Note that the processing itself for verifying the signature is the same with the related art, and accordingly, description thereof will be omitted.

Also, upon receiving the hash value calculation request from the input unit 51, the hash value calculating unit 55 reads out the content from the contents storage unit 532. Subsequently, the hash value calculating unit 55 calculates a hash value as to each block included in the content to generate a hash value list Hₖ including the calculated hash values (S375). Note that the hash value list Hₖ is stored in the hash value storage unit 533.

Subsequently, the modifier operates the modifier terminal 5 to modify the content by performing change, addition, or insertion of a block (S377). Note that the present processing is the operation of the modifier, and accordingly, which is illustrated with a dotted line block in FIG. 45. Subsequently, the input unit 51 accepts input of a change block, additional block, or insertion block, and outputs a content updating request to the contents modifying unit 54. Note that the content updating request includes the data of an input block, operation type, block number, and so forth.

Subsequently, upon receiving the content updating request from the input unit 51, the contents modifying unit 54 executes content modification processing 5 in cooperation with the memory unit 53, hash value calculating unit 55, and insertion table generating unit 59 (S379). The content modification processing 5 will be described with reference to FIG. 46.

First, the contents modifying unit 54 determines whether or not the operation type is change in a block (S391 in FIG. 46). In the event that the operation type is change in a block (Yes route in S391), the contents modifying unit 54 updates the content stored in the contents storage unit 532 by changing a block (S393). Specifically, the contents modifying unit 54 changes the block of a block number included in the content updating request to the content of the change block. Subsequently, the flow proceeds to processing in S409.

On the other hand, in the event that the operation type is not change in a block (No route in S391), the contents modifying unit 54 determines whether or not the operation type is addition of a block (S395). In the event that the operation type is addition of a block (Yes route in S395), the contents modifying unit 54 updates the content stored in the contents storage unit 532 by adding an additional block to the end of the content (S397). Subsequently, the flow proceeds to processing in S409.

On the other hand, in the event that the operation type is not addition of a block (No route in S395), the contents modifying unit 54 determines whether or not the operation type is insertion of a block (S399). In the event that the operation type is insertion of a block (Yes route in S399), the contents modifying unit 54 adds the same block as the final block to the end of the content (S401). Subsequently, the contents modifying unit 54 shifts each block of the insertion position and thereafter backward one at a time (S403). Subsequently, the contents modifying unit 54 inserts the block into the insertion position (S405). Subsequently, the contents modifying unit 54 notifies the insertion table generating unit 59 of the insertion position number of the block.

Subsequently, upon receiving the insertion position number from the contents modifying unit 54, the insertion table generating unit 59 sets the insertion position number to the insertion table Iₖ of the insertion table storage unit 536 (S407). Note that the present processing is the same processing as an embodiment, and accordingly, detailed description will be omitted. Subsequently, the flow proceeds to processing in S409.

On the other hand, in the event that determination is made in S399 that the operation type is not insertion of a block (No route in S399), the flow skips the subsequent processing to end the present processing. Subsequently, the flow returns to the original processing.

Subsequently, the hash value calculating unit 55 calculates the hash value of the block changed, added, or inserted (S409). Note that the position of the block serving as a calculation object is notified to the contents modifying unit 54. Subsequently, the hash value calculating unit 55 generates the public hash values v including the identifier of the modifier stored in the management data storage unit 531, block number, and calculated hash value, and stores these in the hash value storage unit 533 (S411). Also, the hash value calculating unit 55 uses the hash value calculated in S409 to update the hash value list Hₖ stored in the hash value storage unit 533 (S413). Note that the processing in S409 through S413 is the same processing as with the above described embodiment, and accordingly, detailed description will be omitted. Subsequently, the present processing ends, and the flow returns to the original processing.

Description will return to FIG. 45, after the content modification processing 5 (S379) is executed, the input unit 51 determines whether or not modification of the content has been completed (S381). For example, in the event of having accepted the next operation (change, addition, or insertion of a block) from the modifier, determination is made that modification of the content has not been completed (No route in S381), the flow returns to the processing in S377, where the above described processing is repeated.

On the other hand, in the event that modification completion has been instructed from the modifier, determination is made that modification of the content has been completed (Yes route in S381), and the flow proceeds to processing in S383. At this time, the input unit 51 outputs a signature request including specification of the hash value list Hₖ, public hash values Vₖ, and insertion table Iₖ, serving as a signature object to the signature unit 56.

Subsequently, upon receiving the signature request from the input unit 51, the signature unit 56 reads out the private key of the modifier k from the management data storage unit 531, reads out hash value list Hₖ and public hash values Vₖ from the hash value storage unit 533, and reads out insertion table Iₖ from the insertion table storage unit 536. Subsequently, the signature unit 56 uses the private key of the modifier k to generate a digital signature σₖ as to the readout hash value list Hₖ, public hash values Vₖ, and insertion table Iₖ, (S383). Subsequently, the signature unit 56 adds the generated digital signature σₖ to the signature list Σ of the digital signature storage unit 534. For example, in FIG. 44, a digital signature σ₁ is generated, and the signature list Σ is updated to the digital signature list Σ={σ₀, σ₁}.

Subsequently, the output unit 52 reads out the inserted content from the contents storage unit 532, reads out the public hash values Vₖ from the hash value storage unit 533, reads out the signature list Σ from the digital signature storage unit 534, and reads out the insertion table Iₖ from the insertion table storage unit 536. Subsequently, the output unit 52 adds the public hash values Vₖ to the public hash value list V, and adds the insertion table Iₖ to the insertion table list I. Subsequently, the output unit 52 outputs the inserted content, signature list Σ, public hash value list V, and insertion table list I to another modifier terminal 5 or the modifier terminal 7 (S385). Subsequently, the present processing ends.

Note that description has been made above regarding a case of the first modifier, but basic processing is the same regarding a case of the second modifier and thereafter. However, in the case of the second modifier and thereafter, in S371 the input unit 51 receives the inserted content, signature list Σ, public hash value list V, and insertion table I from the modifier terminal 5 which the former modifier operates. In this case, an arrangement should be made wherein the input unit 51 stores the inserted content in the contents storage unit 532, stores the public hash value list V in the hash value storage unit 533, stores the signature list Σ in the digital signature storage unit 534, and stores the insertion table list I in the insertion table storage unit 536.

Also, in S385 the output unit 52 should add the public hash values Vₖ to the received public hash value list V. Further, the output unit 52 should add the insertion table Iₖ to the received insertion table list L.

According to execution of the above processing, even in the case of the RCS-type PIAT, an insertion table may be generated.

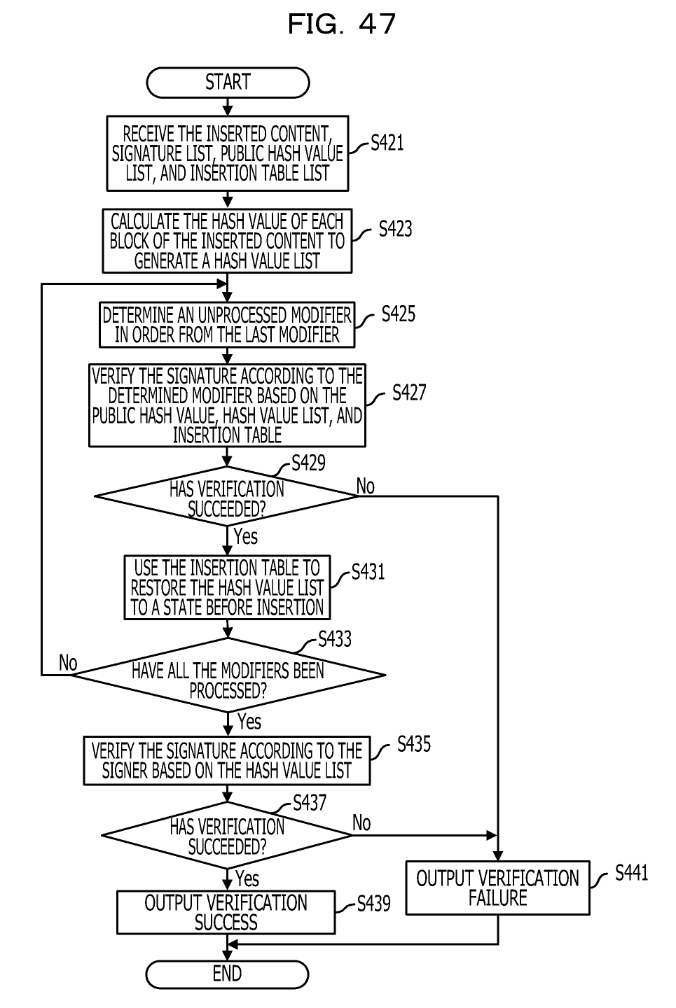

Next, processing of the verifier terminal 7 according to an embodiment will be described with reference to FIG. 47. Here, description will be made regarding processing in the event of verifying the inserted content. First, the input unit 71 receives the inserted content, signature list Σ, public hash value list V, and insertion table list I from the modifier terminal 5 (S421 in FIG. 47). Subsequently, the input unit 71 stores the received inserted content in the contents storage unit 732, stores the public hash value list V in the hash value storage unit 733, stores the signature list Σ in the digital signature storage unit 734, and stores the insertion table list I in the insertion table storage unit 736. Subsequently, the input unit 71 outputs a hash value calculation request to the hash value calculating unit 74. Note that the hash value calculation request includes the file name of the inserted content, and so forth.

Subsequently, upon receiving the hash value calculation request from the input unit 71, the hash value calculating unit 74 reads out the inserted content according to the hash value calculation request from the contents storage unit 732. Subsequently, the hash value calculating unit 74 calculates a hash value as to each block included in the readout inserted content to generate a hash value list H (S423). Note that the hash value list H is stored in the hash value storage unit 733. Subsequently, the hash value calculating unit 74 outputs a verification request to the signature verifying unit 76.

Subsequently, upon receiving the verification request from the hash value calculating unit 74, the signature verifying unit 76 determines an unprocessed modifier k in order from the last modifier (S425). Subsequently, the signature verifying unit 76 reads out data according to the determined modifier k from the public key storage unit 731, hash value storage unit 733, digital signature storage unit 734, and insertion table storage unit 736. That is to say, the signature verifying unit 76 reads out the public key of the modifier k from the public key storage unit 731, reads out the public hash values Vₖ from the hash value storage unit 733, reads out the digital signature σₖ according to the modifier k from the digital signature storage unit 734, and reads out the insertion table Iₖ from the insertion table storage unit 736. Also, the signature verifying unit 76 reads out the hash value list H generated in S423 from the hash value storage unit 533. Subsequently, the signature verifying unit 76 executes verification processing of the digital signature σₖ based on the public key, hash value list H, public hash values Vₖ, and insertion table Iₖ (S427). Note that the verification processing of the digital signature is the same as with the related art, and accordingly, description thereof will be omitted.

Subsequently, in the event that the signature verifying unit 76 has succeeded in verification in S427 (Yes route in S429), the signature verifying unit 76 instructs the hash value verifying unit 75 to verify the hash value list H. At this time, the signature verifying unit 76 notifies the hash value verifying unit 75 of the insertion table Iₖ along with the instruction. Note that success in verification in S427 means that the validity of the insertion block inserted by the modifier k has been confirmed.

Subsequently, the hash value verifying unit 75 receives the insertion table Iₖ along with the instruction from the signature verifying unit 76. Subsequently, the hash value verifying unit 75 restores the hash value list H to a state before insertion by removing the hash values as to the insertion blocks from the hash value list H based on the insertion table Iₖ (S431). Note that, such as illustrated in FIG. 28, insertion position numbers are set to the insertion table Iₖ in insertion order, and accordingly, the hash value verifying unit 75 determines an insertion position number in order from back to remove the insertion block of the insertion position number thereof. For example, in FIG. 44, the third hash value h₆ is removed, and the hash value list H becomes the hash value list H={h₁, h₂, h₃, h₄, h₅}. Subsequently, the hash value verifying unit 75 notifies the signature verifying unit 76 of that the processing regarding the determined modifier k has been completed.

Subsequently, upon receiving the completion notice from the hash value verifying unit 75, the signature verifying unit 76 determines whether or not the processing regarding all of the modifiers has been completed (S433). In the event that the processing regarding all of the modifiers has not been completed (No route in S433), the flow returns to S425, where the above processing is repeated. That is to say, processing such as described above is repeated in order from the last modifier to the modifier who has performed content modification first. Note that processing such as described above is executed regarding all of the modifiers, and thus, the hash values corresponding to all of the insertion blocks are removed from the hash value list H, and the hash value list H returns to the state of the original content.

On the other hand, in the event that the processing regarding all of the modifiers has been completed (Yes route in S433), the signature verifying unit 76 reads out the public key of the signer from the public key storage unit 731, and reads out a digital signature σ₀ according to the signer from the digital signature storage unit 734. Subsequently, the signature verifying unit 76 executes the verification processing of the digital signature σ₀ according to the signer based on the public key of the signer, and the restored hash value list H (S435). Note that the verification processing of the digital signature is the same as with the related art, and accordingly, description thereof will be omitted.

Subsequently, in the event that the signature verifying unit 76 has succeeded verification in S435 (Yes route in S437), the signature verifying unit 76 notifies the output unit 72 of that the verification has succeeded. Subsequently, the output unit 72 outputs success in verification to the display device or the like (S439). Subsequently, the processing ends.

On the other hand, in the event that the signature verifying unit 76 has failed in verification in S427 (No route in S429), or has failed in verification in S435 (No route in S437), the output unit 72 outputs failure in verification to the display device or the like (S441). Note that which verification has failed may be displayed together. Subsequently, the processing ends.

Such as described above, the RCS-type PIAT is transshaped, whereby partial integrity assurance at the time of block insertion may be realized with smaller data amount than that of the above described embodiment.

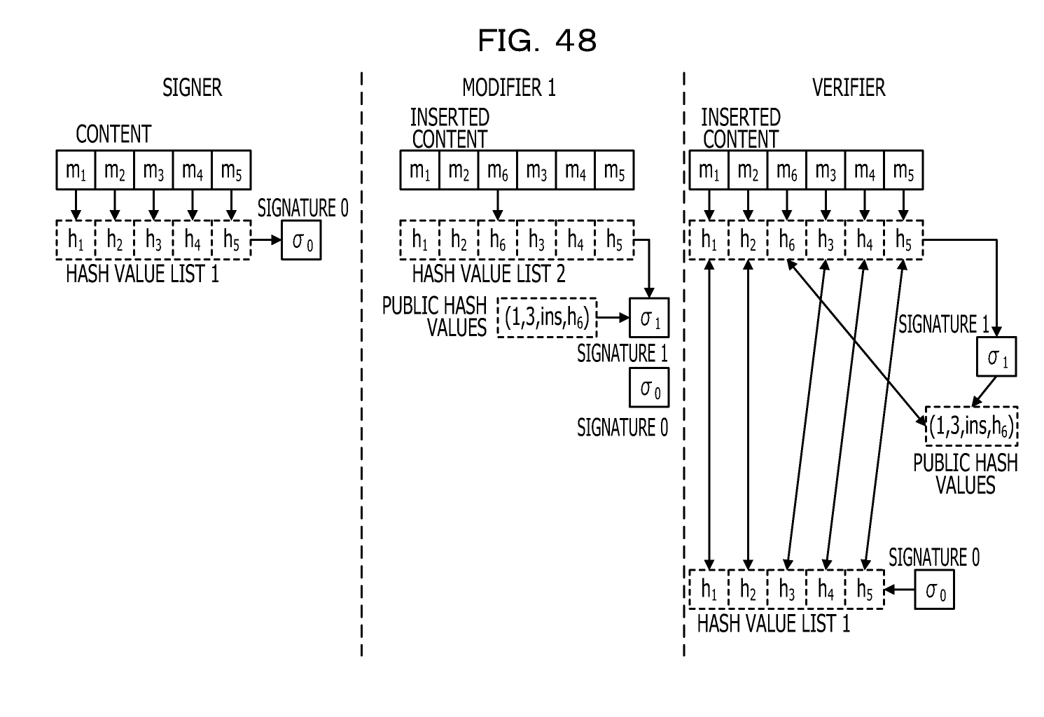

Next, another embodiment will be described. With an embodiment, partial integrity assurance at a time of block insertion is realized with a flow such as illustrated in FIG. 48. Note that an embodiment transshaped from the above described embodiment, and rough flow thereof is the same. Withan embodiment, the tag described in an embodiment is added to the public hash values.

Such as illustrated in FIG. 48, with an embodiment, at the modification phase, a hash value as to each block included in a content is calculated to generate a hash value list 1. Subsequently, for example, in the event that a block m₆ has been inserted in the third position of the content, the hash value corresponding to the insertion block m₆ is calculated, and the hash value thereof is inserted into the hash value list thereof to generate a hash value list 2. Also, the public hash values including the identifier of a modifier, an insertion position number, a tag “insert” representing insertion, and the hash value thereof are generated. Subsequently, a digital signature σ₁ as to the hash value list 2 and public hash values is generated.

Subsequently, with the verification phase, first, a hash value as to each block included in the inserted content is calculated. Subsequently, the calculated hash values, and public hash values are used to verify the insertion block, and also the digital signature σ₁ is verified. Also, of the calculated hash values, hash values as to blocks other than the insertion block (h₁ through h₅ in FIG. 48) are used to verify the digital signature σ₀. Thus, the insertion block is assured to have been inserted by the modifier, and each block other than the insertion block is assured to have been succeeded from the original content. Also, a tag representing insertion is included in the public hash values, and thus, no link table has to be generated, and accordingly, the data amount may be reduced as compared to the case of the above described embodiment. Hereafter, another embodiment will be described in detail.

The system configuration according to an embodiment is the same as the system configuration illustrated in FIG. 10. Also, the configurations of a signer terminal 3, modifier terminals 5, and verifier terminal 7 according to an embodiment are basically the same as those of another embodiment above described.

The processing of the modifier terminal 5 and the verifier terminal 7 according to an embodiment will be described. Note that the processing of the signer terminal 3 is the same as that of the above described embodiment, and accordingly, description thereof will be omitted.

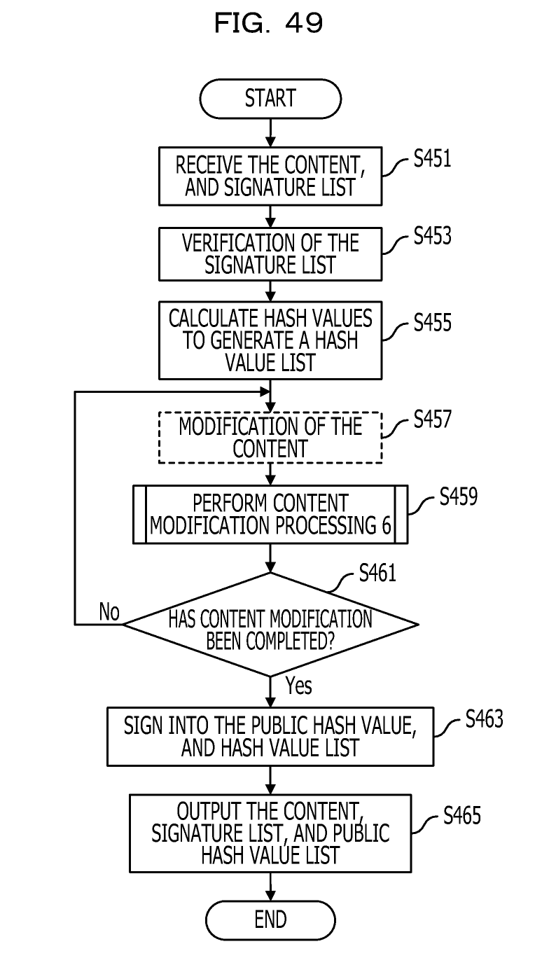

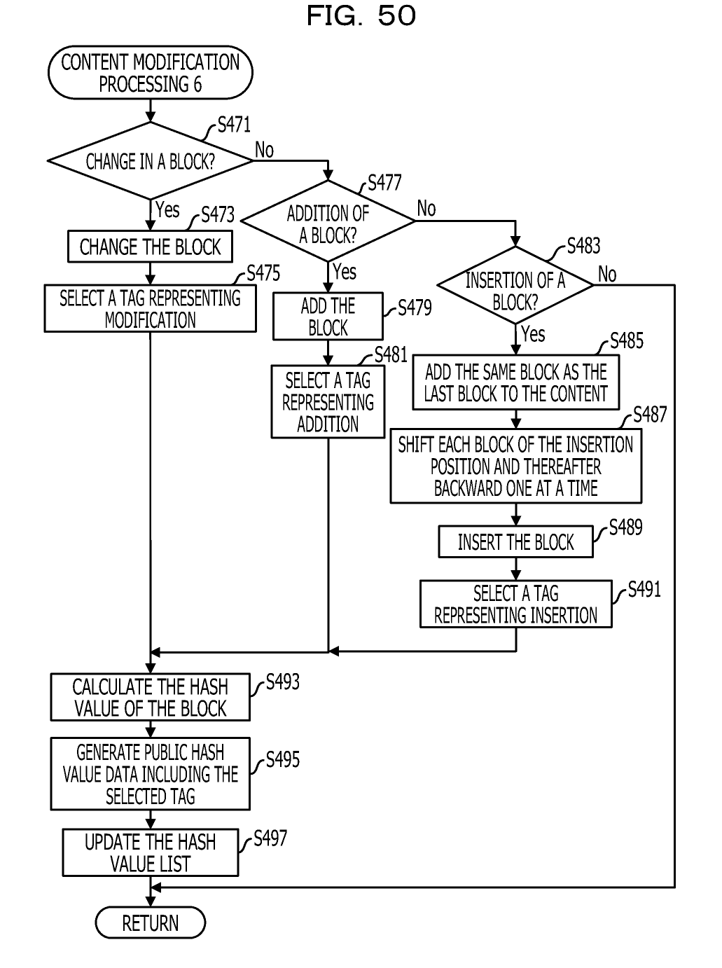

First, the processing of the modifier terminal 5 according to an embodiment will be described with reference to FIG. 49 and FIG. 50. Here, description will be made regarding a case of the first modifier. First, the input unit 51 receives the content and the signature list Σ from the signer terminal 3 (S451 in FIG. 49). Subsequently, the input unit 51 stores the received content in the contents storage unit 532, and stores the signature list Σ in the digital signature storage unit 534. Subsequently, the input unit 51 outputs a digital signature verification request to the verifying unit 57, and outputs a hash value calculation request to the hash value calculating unit 55.

Subsequently, upon receiving the verification request from the input unit 51, the verifying unit 57 reads out the signature list Σ from the digital signature storage unit 534, and executes the verification processing of the digital signature σ₀ of the signer included in the signature list Σ (S453). Note that the processing itself for verifying the signature is the same with the related art, and accordingly, description thereof will be omitted.

Also, upon receiving the hash value calculation request from the input unit 51, the hash value calculating unit 55 reads out the content from the contents storage unit 532, and calculates a hash value as to each block included in the content to generate a hash value list Hₖ including the calculated hash values (S455). Note that the hash value list Hₖ is stored in the hash value storage unit 533.

Subsequently, the modifier operates the modifier terminal 5 to modify the content by performing change, addition, or insertion of a block (S457). Note that the present processing is the operation of the modifier, and accordingly, which is illustrated with a dotted line block in FIG. 49. Subsequently, the input unit 51 accepts input of a change block, additional block, or insertion block, and outputs a content updating request to the contents modifying unit 54. Note that the content updating request includes the data of an input block, operation type, block number, and so forth.

Subsequently, upon receiving the content updating request from the input unit 51, the contents modifying unit 54 executes content modification processing 6 in cooperation with the memory unit 53, hash value calculating unit 55, and tag setting unit 60 (S459). The content modification processing 6 will be described with reference to FIG. 50.

First, the contents modifying unit 54 determines whether or not the operation type is change in a block (S471 in FIG. 50). In the event that the operation type is change in a block (Yes route in S471), the contents modifying unit 54 updates the content stored in the contents storage unit 532 by changing a block (S473).

Subsequently, the tag setting unit 60 selects a tag “change” representing change in a block (S475), and outputs the selected tag information to the hash value calculating unit 55. Subsequently, the flow proceeds to processing in S493.

On the other hand, in the event that the operation type is not change in a block (No route in S471), the contents modifying unit 54 determines whether or not the operation type is addition of a block (S477). In the event that the operation type is addition of a block (Yes route in S477), the contents modifying unit 54 updates the content stored in the contents storage unit 532 by adding an additional block to the end of the content (S479).

Subsequently, the tag setting unit 60 selects a tag “append” representing addition of a block (S481), and outputs the selected tag information to the hash value calculating unit 55. Subsequently, the flow proceeds to processing in S493.

On the other hand, in the event that the operation type is not addition of a block (No route in S477), the contents modifying unit 54 determines whether or not the operation type is insertion of a block (S483). In the event that the operation type is insertion of a block (Yes route in S483), the contents modifying unit 54 adds the same block as the final block to the end of the content (S485). Subsequently, the contents modifying unit 54 shifts each block of the insertion position and thereafter backward one at a time (S487). Subsequently, the contents modifying unit 54 inserts the block into the insertion position (S489).

Subsequently, the tag setting unit 60 selects a tag “insert” representing insertion of a block (S491), and outputs the selected tag information to the hash value calculating unit 55. Subsequently, the flow proceeds to processing in S493.

On the other hand, in the event that determination is made in S483 that the operation type is not insertion of a block (No route in S483), the flow skips the subsequent processing to end the present processing. Subsequently, the flow returns to the original processing.

Subsequently, upon receiving the tag information from the tag setting unit 60, the hash value calculating unit 55 calculates the hash value of the block changed, added, or inserted (S493). Subsequently, the hash value calculating unit 55 generates the public hash values v including the identifier of the modifier stored in the management data storage unit 531, block number, tag representing change, addition, or insertion, and calculated hash value, and stores these in the hash value storage unit 533 (S495). Also, the hash value calculating unit 55 uses the hash value calculated in S493 to update the hash value list Hₖ stored in the hash value storage unit 533 (S497). Note that the present processing is the same processing as with the above described embodiment, and accordingly, detailed description will be omitted. Subsequently, the present processing ends, and the flow returns to the original processing.

Description will return to FIG. 49, after the content modification processing 6 (S459) is executed, the input unit 51 determines whether or not modification of the content has been completed (S461). For example, in the event of having accepted the next operation (change, addition, or insertion of a block) from the modifier, determination is made that modification of the content has not been completed (No route in S461), the flow returns to the processing in S457, where the above described processing is repeated.

On the other hand, in the event that modification completion has been instructed from the modifier, determination is made that modification of the content has been completed (Yes route in S461), and the flow proceeds to processing in S463. At this time, the input unit 51 outputs a signature request including specification of the hash value list Hₖ and public hash values Vₖ, serving as a signature object to the signature unit 56.

Subsequently, upon receiving the signature request from the input unit 51, the signature unit 56 reads out the private key of the modifier k from the management data storage unit 531, and reads out hash value list Hₖ and public hash values Vₖ from the hash value storage unit 533. Subsequently, the signature unit 56 uses the private key of the modifier k to generate a digital signature σₖ as to the readout hash value list Hₖ and public hash values Vₖ (S463). Subsequently, the signature unit 56 adds the generated digital signature σₖ to the signature list Σ of the digital signature storage unit 534. For example, in FIG. 48, a digital signature σ₁ is generated, and the signature list Σ is updated to the digital signature list Σ={σ₀, σ₁}.

Subsequently, the output unit 52 reads out the inserted content from the contents storage unit 532, reads out the public hash values Vₖ from the hash value storage unit 533, and reads out the signature list Σ from the digital signature storage unit 534. Subsequently, the output unit 52 adds the public hash values Vₖ to the public hash value list V. Subsequently, the output unit 52 outputs the inserted content, signature list Σ, and public hash value list V to another modifier terminal 5 or the modifier terminal 7 (S465). Subsequently, the present processing ends.

Note that description has been made above regarding a case of the first modifier, but basic processing is the same regarding a case of the second modifier and thereafter. However, in the case of the second modifier and thereafter, in S451 the input unit 51 receives the inserted content, signature list Σ, and public hash value list V from the modifier terminal 5 which the former modifier operates. In this case, an arrangement should be made wherein the input unit 51 stores the inserted content in the contents storage unit 532, stores the public hash value list V in the hash value storage unit 533, and stores the signature list Σ in the digital signature storage unit 534.

Also, in S465 the output unit 52 should add the public hash values Vₖ to the received public hash value list V.

According to execution of the above processing, even in the case of the RCS-type PIAT, the public hash values including a tag representing change, addition, or insertion of a block may be generated.

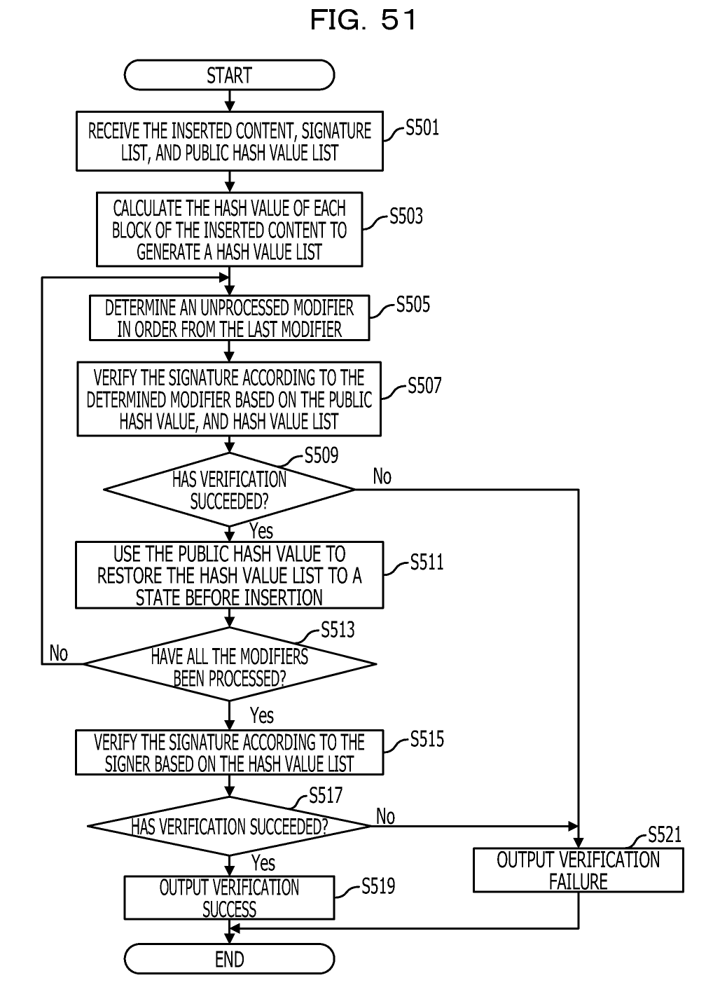

Next, processing of the verifier terminal 7 according to an embodiment will be described with reference to FIG. 51. Here, description will be made regarding processing in the event of verifying the inserted content. First, the input unit 71 receives the inserted content, signature list Σ, and public hash value list V from the modifier terminal 5 (S501 in FIG. 51). Subsequently, the input unit 71 stores the received inserted content in the contents storage unit 732, stores the public hash value list V in the hash value storage unit 733, and stores the signature list Σ in the digital signature storage unit 734. Subsequently, the input unit 71 outputs a hash value calculation request to the hash value calculating unit 74. Note that the hash value calculation request includes the file name of the inserted content, and so forth.

Subsequently, upon receiving the hash value calculation request from the input unit 71, the hash value calculating unit 74 reads out the inserted content according to the hash value calculation request from the contents storage unit 732. Subsequently, the hash value calculating unit 74 calculates a hash value as to each block included in the readout inserted content to generate a hash value list H (S503). Note that the hash value list H is stored in the hash value storage unit 733. Subsequently, the hash value calculating unit 74 outputs a verification request to the signature verifying unit 76.

Subsequently, upon receiving the verification request from the hash value calculating unit 74, the signature verifying unit 76 determines an unprocessed modifier k in order from the last modifier (S505). Subsequently, the signature verifying unit 76 reads out data according to the determined modifier k from the public key storage unit 731, hash value storage unit 733, and digital signature storage unit 734. That is to say, the signature verifying unit 76 reads out the public key of the modifier k from the public key storage unit 731, reads out the public hash values Vₖ from the hash value storage unit 733, and reads out the digital signature σₖ according to the modifier k from the digital signature storage unit 734. Also, the signature verifying unit 76 reads out the hash value list H generated in S503 from the hash value storage unit 533. Subsequently, the signature verifying unit 76 executes verification processing of the digital signature σₖ according to the modifier k based on the public key, hash value list H, and public hash values Vₖ (S507). Note that the verification processing of the digital signature is the same as with the related art, and accordingly, description thereof will be omitted.

Subsequently, in the event that the signature verifying unit 76 has succeeded in verification in S507 (Yes route in S509), the signature verifying unit 76 instructs the hash value verifying unit 75 to verify the hash value list H. At this time, the signature verifying unit 76 notifies the hash value verifying unit 75 of the public hash values Vₖ along with the instruction. Note that success in verification in S507 means that the validity of the insertion block inserted by the modifier k has been confirmed.

Subsequently, the hash value verifying unit 75 receives the public hash values Vₖ along with the instruction from the signature verifying unit 76. Subsequently, the hash value verifying unit 75 restores the hash value list H to a state before insertion by removing the hash values as to the insertion blocks from the hash value list H based on the public hash values Vₖ (S511). Note that the public hash values Vₖ include the public hash values v of which the number is equivalent to the number of blocks inserted by the modifier k, and the public hash values v are arrayed in the insertion order. Accordingly, with the present processing, the public hash values v including the tag “insert” representing insertion are determined in the backward order, and the insertion block of a block number included in the public hash values v thereof is removed. For example, in FIG. 48, the third hash value h₆ is removed, and the hash value list H becomes the hash value list H={h₁, h₂, h₃, h₄, h₅}. Subsequently, the hash value verifying unit 75 notifies the signature verifying unit 76 of that the processing regarding the determined modifier k has been completed.

Subsequently, upon receiving the completion notice from the hash value verifying unit 75, the signature verifying unit 76 determines whether or not the processing regarding all of the modifiers has been completed (S513). In the event that the processing regarding all of the modifiers has not been completed (No route in S513), the flow returns to S505, where the above processing is repeated. That is to say, processing such as described above is repeated in order from the last modifier to the modifier who has performed content modification first. Note that processing such as described above is executed regarding all of the modifiers, and thus, the hash values corresponding to all of the insertion blocks are removed from the hash value list H, and the hash value list H returns to the state of the original content.

On the other hand, in the event that the processing regarding all of the modifiers has been completed (Yes route in S513), the signature verifying unit 76 reads out the public key of the signer from the public key storage unit 731, and reads out a digital signature σ₀ according to the signer from the digital signature storage unit 734. Subsequently, the signature verifying unit 76 executes the verification processing of the digital signature σ₀ according to the signer based on the public key of the signer, and the restored hash value list H (S515). Note that the verification processing of the digital signature is the same as with the related art, and accordingly, description thereof will be omitted.

Subsequently, in the event that the signature verifying unit 76 has succeeded verification in S515 (Yes route in S517), the signature verifying unit 76 notifies the output unit 72 of that the verification has succeeded. Subsequently, the output unit 72 outputs success in verification to the display device or the like (S519). Subsequently, the processing ends.

On the other hand, in the event that the signature verifying unit 76 has failed in verification in S507 (No route in S509), or has failed in verification in S515 (No route in S517), the output unit 72 outputs failure in verification to the display device or the like (S521). Note that which verification has failed may be displayed together. Subsequently, the processing ends.

Such as described above, the RCS-type PIAT is transshaped, whereby partial integrity assurance at the time of block insertion may be realized with smaller data amount than that of an embodiment.

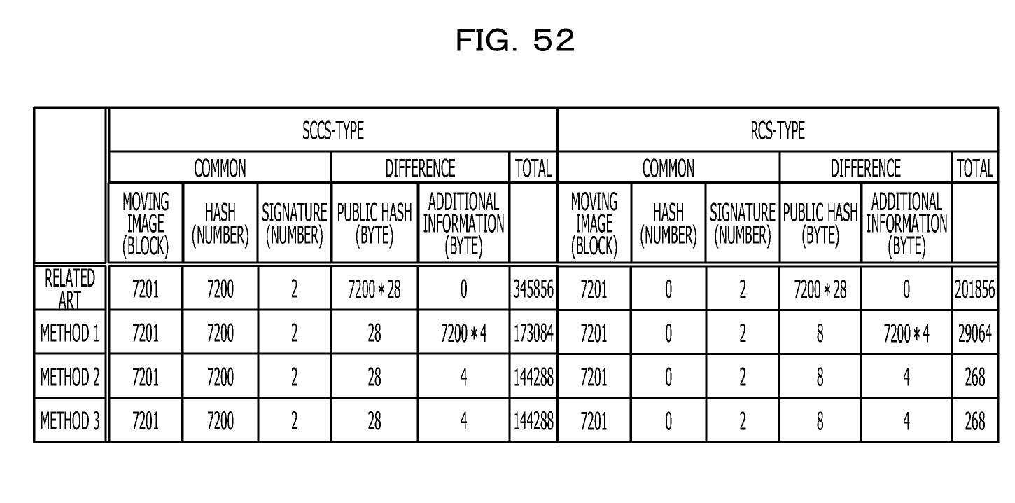

FIG. 52 illustrates a comparative example of public data amount of a method employing the link table (method 1), a method employing the insertion table (method 2), a method employing the tags (method 3), and conventional PIAT. Now, let us assume a scene wherein one block is inserted at the first block of a one-hour moving image (32 frames/second, 1GOP: 16 frames, 1GOP: one block). Also, let us say that a signature is 1024 bits, a hash value is 160 bits, and ID additional information (insertion position number, block number, tag, and so forth) each of which is 32 bits. For example, in the event of employing the method 3 of SCCS-type PIAT, the public data amount may be reduced to around 42% (1/2.3) as compared to the conventional SCCS-type PIAT. Also, for example, in the event of employing the method 3 of the RCS-type PIAT, the public data amount may be reduced to around 1/753 as compared to the conventional RCS-type PIAT.

Embodiments of the present technology have been described so far, but the present technology is not restricted to these. For example, the above described functional block diagrams of the signer terminal 3, modifier terminal 5, and verifier terminal 7 do not necessarily correspond to the actual program module configurations. The functions of each terminal may be mounted on a single computer.

Also, with processing flows, processing sequence may be replaced as long as the processing results are not changed. Also, the processing sequence may be executed in parallel.

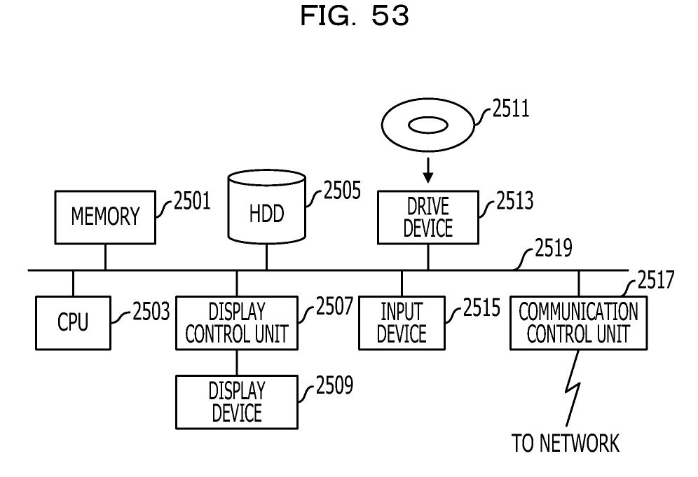

Note that the above-mentioned signer terminal 3, modifier terminal 5, and verifier terminal 7 are computer devices, and such as illustrated in FIG. 53, memory 2501, CPU 2503, a hard disk drive (HDD) 2505, a display control unit 2507 to be connected to a display device 2509, a drive device 2519 for removable disc 2511, an input device 2515, and a communication control unit 2517 for connecting to a network are connected by a bus 2519. An operating system (OS: Operating System) and an application program for executing processing in the present embodiment are stored in the HDD 2505, and are read out from the HDD 2505 to the memory 2501 at the time of being executed by the CPU 2503. The CPU 2503 controls the display control unit 2507, communication control unit 2517, and drive device 2513 to perform necessary operation as necessary. Also, data being processed is stored in the memory 2501, and is stored in the HDD 2505 as necessary. With an embodiment of the present technology, an application program for executing the above-mentioned processing is stored in the computer-readable removable disc 2511, distributed, and installed from the drive device 2513 to the HDD 2505. This may be installed in the HDD 2505 via a network such as the Internet, and the communication control unit 2517. With such a computer device, various types of functions such as described above are realized by hardware such as the above-mentioned CPU 2503, memory 2501, and so forth, an OS, and a necessary application program being organically cooperated.

The above-mentioned embodiments of the present technology will be summarized as follows.

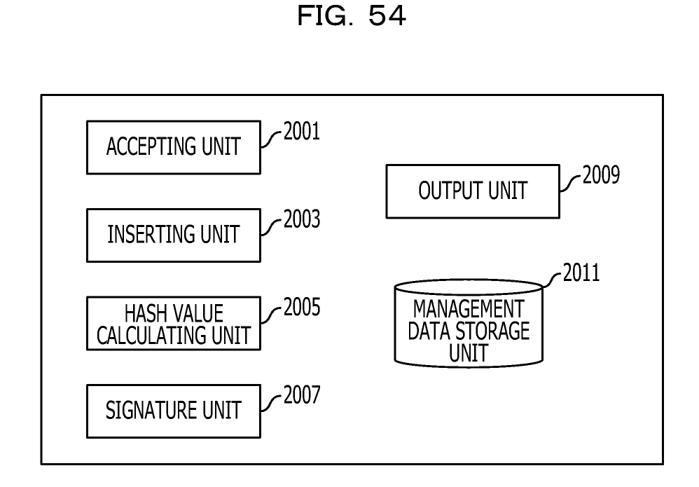

A contents processing device according to a first mode includes (z) a management data storage unit for storing an updater identifier and a private key in a correlated manner (management data storage unit 2011 in FIG. 54), (a) accepting means for accepting a content which is divided into two or more blocks, an updating type indicating the type of updating as to this content, an updated block to be updated in this content, and an updated position (accepting unit 2001 in FIG. 54), (b) inserting means for generating an updated content by inserting the updated block into the updated position of the content in the event that the updating type is insertion (inserting unit 2003 in FIG. 54), (c) first hash value calculating means for calculating a hash value as to the updated block (hash value calculating unit 2005 in FIG. 54), (d) signature means for reading out the updater identifier and the private key from the management data storage unit to generate a digital signature using the private key as to updating record information including this updater identifier, updated position, a hash value as to the updated block, and the updating type (signature unit 2007 in FIG. 54), and (e) output means for outputting the updated content, updating record information, and digital signature (output unit 2009 in FIG. 54).

In this way, updating record information including the updater identifier, updated position, a hash value as to the updated block, and the updating type (insertion) is generated, and thus, at the time of verification, it may be recognized that a block has been inserted, and an insertion position may be recognized. That is to say, each block backward the inserted block may be handled as having not been changed. Also, updating record information is generated regarding the inserted block alone, and accordingly, data amount necessary for content partial integrity assurance may be suppressed. Note that a digital signature as to the updating record information is generated and output, and accordingly, partial integrity assurance may be realized by SCCS-type PIAT.

Also, the contents processing device according to the first mode may further include (f) receiving means for receiving the updated content, updating record information, and digital signature corresponding to this updated content from another contents processing device, (g) second hash value calculating means for calculating a hash value as to each block included in the received updated content, (h) key obtaining means for obtaining the public key corresponding to the updater identifier included in the received updating record information, (i) signature verifying means for verifying the received digital signature using the received updating record information and public key, and (j) insertion operation verifying means for comparing the hash value as to the block on the updated position included in the received updating record information of calculated hash values, and a hash value included in this updating record information, in the event that the updating type included in the received updating record information is insertion, to confirm the validity of the block on this updated position. Thus, the digital signature is verified, and the validity of the block on the updated position is confirmed, and accordingly, a block updater may be assured, and also it may be proved that the inserted block thereof has not been tampered.

Further, with the first mode, the above-mentioned receiving means may further receive a hash value list before updating including a hash value corresponding to each of two or more blocks included in a content before block updating, and a digital signature before updating generated by the private key of the creator of this content as to this hash value list before updating. Subsequently, the above-mentioned signature verifying means may verify the received digital signature before updating using the received hash value list before updating, and the public key of the creator. Also, the above-mentioned insertion operation verifying means may confirm the validity of a block other than the updated block by comparing, regarding each block other than the updated block included in the updated content, the hash value of this block calculated by the second hash value calculating means, and a hash value included in the hash value list before updating and corresponding to this block. Thus, the validity of a block other than the inserted block is confirmed, and accordingly, a block other than the inserted block may be assured to have been succeeded from the original content.

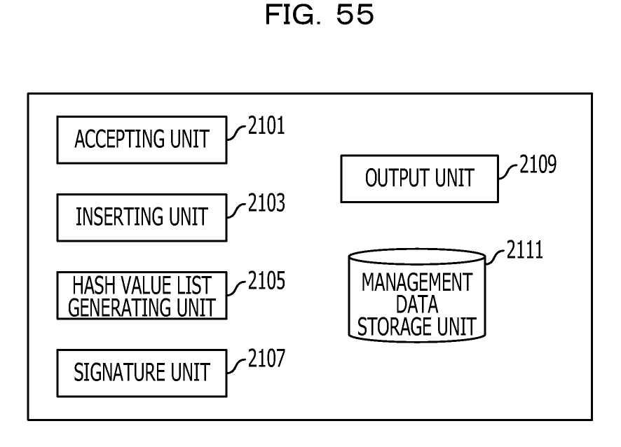

A contents processing device according to a second mode includes (Z) a management data storage unit for storing an updater identifier and a private key in a correlated manner (management data storage unit 2111 in FIG. 55), (A) accepting means for accepting a content which is divided into two or more blocks, an updating type indicating the type of updating as to this content, an updated block to be updated in this content, and an updated position (accepting unit 2101 in FIG. 55), (B) inserting means for generating an updated content by inserting the updated block into the updated position of the content in the event that the updating type is insertion (inserting unit 2103 in FIG. 55), (C) first hash value list generating means for calculating a hash value as to each block included in the generated updated content to generate a hash value list including the hash value of each block (hash value list generating unit 2105 in FIG. 55), (D) signature means for reading out the updater identifier and the private key from the management data storage unit to generate a digital signature using the private key as to updating record information including this updater identifier, updated position, updating type, and the hash value list (signature unit 2107 in FIG. 55), and (E) output mans for outputting the updated content, updating record information, and digital signature (output unit 2109 in FIG. 55).

In this way, updating record information including the updater identifier, updated position, and updating type (insertion) is generated, and thus, at the time of verification, it may be recognized that a block has been inserted, and its insertion position may be recognized. Note that a digital signature as to the hash value list and the updating record information is generated and output, and accordingly, partial integrity assurance may be realized by the RCS-type PIAT.

Also, the contents processing device according to the second mode may further include (F) receiving means for receiving the updated content, updating record information corresponding to this updated content, digital signature, and digital signature before updating generated by the private key of the creator of this content as to the hash value list before updating including the hash value corresponding to each of the two or more blocks included in the content before block updating, (G) key obtaining means for obtaining the public key corresponding to the updater identifier included in the received updating record information, (H) second hash value list generating means for calculating the hash value of each block included in the received updated content to generate a hash value list including the hash value of each block, and (I) signature verifying means for verifying, in the event that the updating type included in the received updating record information is insertion, the received digital signature using the hash value list generated by the second hash value list generating means, this updating record information, and the public key, and also verifying the digital signature before updating using the hash value list wherein the hash value as to the updated block is removed from the hash value list generated by the second hash value list generating means, and the public key of the creator. Thus, the digital signature is verified using the hash value list, updating record information, and public key, and accordingly, the block updater may be assured, and also the inserted block thereof may be assured to have not been tampered. Also, the digital signature before updating is verified, and accordingly, a block other than the inserted block may be assured to have been succeeded from the original content.

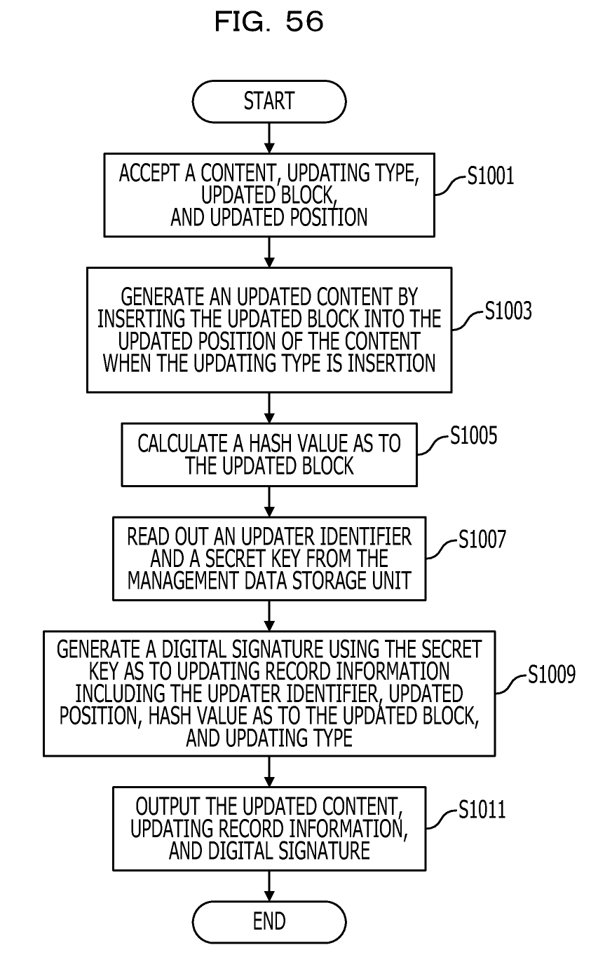

An information processing method according to a third mode is an information processing method for content partial integrity assurance. The present method includes (a) acceptance processing for accepting a content which is divided into two or more blocks, an updating type indicating the type of updating as to this content, an updated block to be updated in this content, and an updated position (S1001 in FIG. 56), (b) insertion processing for generating an updated content by inserting the updated block into the updated position of the content in the event that the updating type is insertion (S1003 in FIG. 56), (c) hash value calculation processing for calculating a hash value as to the updated block (S1005 in FIG. 56), (d) signature processing for reading out, from a management data storage unit (z) for storing an updater identifier and a private key in a correlated manner, the updater identifier and the private key to generate a digital signature using the private key as to updating record information including this updater identifier, the updated position, the hash value as to the updated block, and the updating type (S1007 and S1009 in FIG. 56), and (e) output processing for outputting the updated content, updating record information, and digital signature (S1011 in FIG. 56).

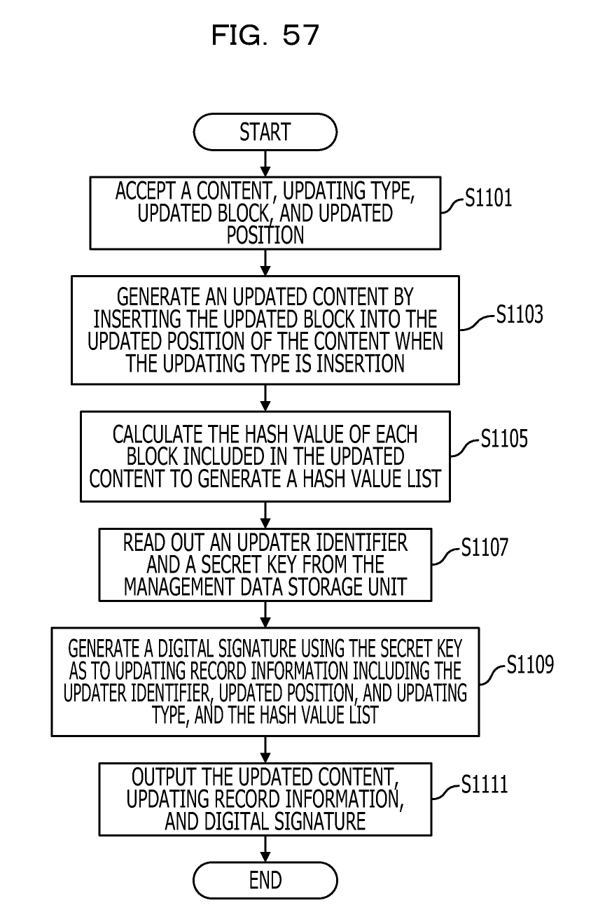

An information processing method according to a fourth mode is an information processing method for content partial integrity assurance. The present method includes (A) acceptance processing for accepting a content which is divided into two or more blocks, an updating type indicating the type of updating as to this content, an updated block to be updated in this content, and an updated position (S1101 in FIG. 57), (B) insertion processing for generating an updated content by inserting the updated block into the updated position of the content in the event that the updating type is insertion (S1103 in FIG. 57), (C) first hash value list generating processing for calculating the hash value of each block include in the generated updated content to generate a hash value list including the hash value of each block (S1105 in FIG. 57), (D) signature processing for reading out, from a management data storage unit (Z) for storing an updater identifier and a private key in a correlated manner, the updater identifier and the private key to generate a digital signature using the private key as to updating record information including this updater identifier, updated position, and updating type, and the hash value list (S1107 and S1109 in FIG. 57), and (E) output processing for outputting the updated content, updating record information, and digital signature (S1111 in FIG. 57).

Note that a program causing the signer terminal 3, modifier terminal 5, and verifier terminal 7 to processing such as described above may be created, and this program is stored in, for example, a computer-readable storage medium such as a flexible disk, CD-ROM, a magneto-optical disk, semiconductor memory, a hard disk, or the like, or a storage device. Note that the computer-readable storage medium or storage device mentioned here does not include something like a transitory propagation signal.

According to an embodiment, content processing method and system implements verification based on selectively updated verification information that is adjusted relative to a modified portion of a content that is to be verified. As such, a value is calculated for each block of the content and a digital signature is generated using the updated information relative to the modified portion.

Further, according to an aspect of the embodiments, any combinations of the described features, functions and/or operations can be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention, the scope of which is defined in the claims and their equivalents.

What is claimed is:

1. A contents processing device, comprising:
a management data storage unit configured to store an updater identifier and a private key in a correlated manner;
an accepting unit configured to accept a content which is divided into a plurality of blocks, an updating type indicating a type of updating as to the content, an updated block of the content, and an updated position;
an inserting unit configured to generate an updated content by inserting an updating block into the updated position of the content in an event that the updating type is an insertion;
a first hash value calculating unit configured to calculate a hash value as to the updated block;
a signature unit configured to read out the updater identifier and the private key from the management data storage unit to generate a digital signature using the private key as to updating record information including the updater identifier, the updated position, the hash value as to the updated block, and the updating type; and
an output unit configured to output the updated content, the updating record information, and the digital signature.

2. The contents processing device according to claim 1, comprising:
a receiving unit configured to receive the updated content, and the updating record information and the digital signature corresponding to the updated content from another contents processing device;
a second hash value calculating unit configured to calculate a hash value as to each block included in the received updated content;
a key obtaining unit configured to obtain a public key corresponding to the updater identifier included in the received updating record information;
a signature verifying unit configured to verify the received digital signature using the received updating record information and the public key; and
an inserting operation verifying unit configured to confirm, in the event that the updating type included in the received updating record information is the insertion, by comparing the hash value as to the block of the updated position included in the updating record information of the calculated hash values, and the hash value included in the updating record information, a validity of the block of the updated position.

3. The contents processing device according to claim 2, wherein the receiving unit receives a hash value list before updating including the hash value corresponding to each of the plurality of blocks included in the content before block updating, and a digital signature before updating generated by the private key of a creator of the content as to the hash value list before updating; and
wherein the signature verifying unit uses the received hash value list before updating, and the public key of the creator to verify the received digital signature before updating; and
wherein the inserting operation verifying unit confirms a validity of a block other than the updated block by comparing, regarding each block other than the updated block, included in the updated content, the hash value of the block calculated by the second hash value calculating unit, and the hash value included in the hash value list before updating, and also corresponding to the block.

4. A contents processing device, comprising:
a management data storage unit configured to store an updater identifier and a private key in a correlated manner;
an accepting unit configured to accept a content which is divided into a plurality of blocks, an updating type indicating a type of updating as to the content, an updated block of the content, and an updated position;
an inserting unit configured to generate an updated content by inserting the updated block into the updated position of the content in an event that the updating type is an insertion;
a first hash value list calculating unit configured to calculate the hash value of each block included in the generated updated content to generate a hash value list including the hash value of each of the blocks;
a signature unit configured to read out the updater identifier and the private key from the management data storage unit to generate a digital signature using the private key as to updating record information including the updater identifier, the updated position, and the updating type, and the hash value list; and
an output unit configured to output the updated content, the updating record information, and the digital signature.

5. The contents processing device according to claim 4, comprising:
a receiving unit configured to receive the updated content, and the updating record information, the digital signature corresponding to the updated content, the digital signature, and a digital signature before updating generated by the private key of a creator of the content as to a hash value list including the hash value corresponding to each of the plurality of blocks included in the content before block updating, from another contents processing device;
a key obtaining unit configured to obtain a public key corresponding to the updater identifier included in the received updating record information;
a second hash value list generating unit configured to calculate the hash value of each block included in the received updated content to generate a hash value list including the hash value of each of the blocks; and
a signature verifying unit configured to verify, in the event that the updating type included in the received updating record information is the insertion, the received digital signature using the hash value list generated by the second hash value list generating unit, the updating record information, and the public key, and also to verify the digital signature before updating using a hash value list obtained by removing the hash value corresponding to the updated block from the hash value list generated by the second hash value generating unit, and the public key of the creator.

6. An information processing method of partial integrity assurance of contents, comprising:
accepting a content which is divided into a plurality of blocks, an updating type indicating the type of updating as to the content, an updated block to be updated of the content, and an updated position;
generating an updated content by inserting the updated block into the updated position of the content in an event that the updating type is an insertion;
calculating a hash value for calculating a hash value as to the updated block;
reading out the updater identifier and the private key from the management data storage unit which stores an updater identifier and a private key in a correlated manner to generate a digital signature using the private key as to updating record information including the updater identifier, the updated position, the hash value as to the updated block, and the updating type; and
outputting the updated content, the updating record information, and the digital signature.

7. An information processing method of partial integrity assurance of contents, comprising:
accepting a content which is divided into a plurality of blocks, an updating type indicating the type of updating as to the content, an updated block to be updated of the content, and an updated position;
generating an updated content by inserting the updated block into the updated position of the content in an event that the updating type is an insertion;
generating a first hash value list for calculating the hash value of each block included in the generated updated content to generate a hash value list including the hash value of each of the blocks;
reading out the updater identifier and the private key from the management data storage unit which stores an updater identifier and a private key in a correlated manner to generate a digital signature using the private key as to updating record information including the updater identifier, the updated position, and the updating type, and the hash value list; and
outputting the updated content, the updating record information, and the digital signature.

8. A computer-readable recording medium which stores a program causing a computer to execute a process of partial integrity assurance of contents, the process comprising:
accepting a content which is divided into a plurality of blocks, an updating type indicating the type of updating as to the content, an updated block to be updated of the content, and an updated position;
generating an updated content by inserting the updated block into the updated position of the content in an event that the updating type is an insertion;
calculating a hash value for calculating a hash value as to the updated block;
reading out the updater identifier and the private key from the management data storage unit which stores an updater identifier and a private key in a correlated manner to generate a digital signature using the private key as to updating record information including the updater identifier, the updated position, the hash value as to the updated block, and the updating type; and
outputting the updated content, the updating record information, and the digital signature.

9. A computer-readable recording medium which stores a program causing a computer to execute a process of partial integrity assurance of contents, the process comprising:
accepting a content which is divided into a plurality of blocks, an updating type indicating the type of updating as to the content, an updated block to be updated of the content, and an updated position;
generating an updated content by inserting the updated block into the updated position of the content in an event that the updating type is an insertion;
generating a first hash value list for calculating the hash value of each block included in the generated updated content to generate a hash value list including the hash value of each of the blocks;
reading out the updater identifier and the private key from the management data storage unit which stores an updater identifier and a private key in a correlated manner to generate a digital signature using the private key as to updating record information including the updater identifier, the updated position, and the updating type, and the hash value list; and
outputting the updated content, the updating record information, and the digital signature.
